(19) United States
(12) Patent Application Publication
(10) Pub. No.: US 2018/0241988 A1
(43) Pub. Date: Aug. 23, 2018

(54) Multi-View Video Transmission Method and Apparatus

(71) Applicant: Huawei Technologies Co., Ltd., Shenzhen (CN)

(72) Inventors: Chao Zhou, Shenzhen (CN); Bo Liu, Beijing (CN); Wenhai Wu, Beijing (CN)

(21) Appl. No.: 15/962,775

(22) Filed: Apr. 25, 2018

Related U.S. Application Data
(63) Continuation of application No. PCT/CN2016/079873, filed on Apr. 21, 2016.

(30) Foreign Application Priority Data
Oct. 26, 2015 (CN) 201510701264.4

(51) Int. Cl. H04N 13/366; H04L 29/06; H04N 13/106; H04N 21/218; H04N 21/2662; H04N 21/81

(52) U.S. Cl. CPC H04N 13/366; H04L 65/80; H04N 13/158; H04N 2013/0096; H04N 21/2662; H04N 21/816; H04N 21/21805

(57) ABSTRACT

A method includes obtaining a location of a viewpoint video to which a user currently pays attention in a multi-view video, obtaining a speed at which the user viewpoint switches to the location of the viewpoint video to which attention is currently paid, determining a quantity of predictive viewpoint videos (NNV) that need to be downloaded before the user switches to another viewpoint, determining locations of the predictive viewpoint videos in the multi-view video according to a preset rule and according to the location of the viewpoint video to which the user currently pays attention, the first speed, and the NNV, downloading the predictive viewpoint videos corresponding to the locations of the predictive viewpoint videos from a server end, and transmitting the predictive viewpoint videos.

### CROSS-REFERENCE TO RELATED APPLICATIONS

This application is a continuation of International Patent Application No. PCT/CN2016/079873 filed on Apr. 21, 2016, which claims priority to Chinese Patent Application No. 201510701264.4 filed on Oct. 26, 2015. The disclosures of the aforementioned applications are hereby incorporated by reference in their entireties.

### TECHNICAL FIELD

The present disclosure relates to the field of image processing technologies, and in particular, to a multi-view video transmission method and apparatus.

### BACKGROUND

A multi-view video is a group of video signals obtained by shooting a same scene from different angles of view using multiple video cameras having different viewpoints and is provided to a user. Video signals having different viewpoints are dynamically presented to the user according to information about a head-mounted device, such as a gesture and a location, thereby providing experience such as multi-view or three-dimensional stereoscopic vision to the user.

Multi-view videos may be divided into a one-dimensional multi-view video and a two-dimensional multi-view video according to a viewpoint location distribution status. The one-dimensional multi-view video is a series of video sequences having different angles of view in a single dimension (for example, in a horizontal or vertical direction). The two-dimensional multi-view video is a series of video sequences having different angles of view in two dimensions, that is, in the horizontal direction and the vertical direction.

A user viewpoint switching and terminal display policy may be divided into two scenarios, a viewpoint switching independent display policy and a viewpoint switching fusion display policy. In the viewpoint switching independent display policy, a discrete viewpoint video is presented to a user, that is, when a user viewpoint changes, only a viewpoint video in a multi-view video sequence is presented to the user. However, in the viewpoint switching fusion display policy, a continuous viewpoint video is presented to a user, that is, when a user viewpoint changes, a viewpoint video in a multi-view video sequence or a new viewpoint video generated after fusion processing is performed on neighboring viewpoint videos may be presented to the user.

When a multi-view video is transmitted, a free-viewpoint video transmission method based on Dynamic Adaptive Stream over Hyper Text, Transfer Protocol (HTTP) (DASH) is used. The manner is as follows. A client determines a current angle of view of a user according to a gesture of the user or a location of an eye ball of the user, then selects two viewpoint videos closest to the angle of view of the user and downloads the two viewpoint videos using an HTTP request, and finally performs fusion processing on the two downloaded viewpoint videos to generate a new free-viewpoint video and presents the new free-viewpoint video to the user. However, when the angle of view of the user changes, viewpoint videos corresponding to an angle of view after switching need to be re-downloaded from a server end. Then, fusion processing is performed, and presentation to the user is performed. Such a method for performing re-downloading causes a long switching delay, affecting user experience.

To reduce the foregoing switching delay, a three-dimensional (3D) multi-view video transmission method based on DASH is put forward. The method is as follows. All viewpoint videos are downloaded from a client, then viewpoint videos closest to a current angle of view of a user are extracted according to a location of the current angle of view of the user and fused, and a viewpoint video generated after fusion is displayed to the user. Because all the viewpoint videos are transmitted, a time delay caused during switching of the angle of view can be avoided. However, because only videos corresponding to the current angle of view of the user are presented to the user, transmission of all the viewpoint videos causes a waste of bandwidths.

### SUMMARY

The present disclosure provides a multi-view video transmission method and apparatus in order to resolve a problem that a waste of bandwidths is caused when a time delay of switching of an angle of view is avoided.

According to a first aspect, an embodiment of the present disclosure provides a multi-view video transmission method, including obtaining a location of a viewpoint video to which a user currently pays attention in a multi-view video, obtaining a first speed at which a user viewpoint switches, where the first speed is a speed at which the user viewpoint switches to the location of the viewpoint video to which attention is currently paid, determining, according to the first speed and according to a preset algorithm, a quantity of predictive viewpoint videos (NNV) that need to be downloaded before the user switches to another viewpoint, determining locations of the predictive viewpoint videos in the multi-view video according to a preset rule and according to the location of the viewpoint video to which the user currently pays attention, the first speed, and the NNV, where the predictive viewpoint videos are viewpoint videos whose probability of becoming a next viewpoint video attention is to be paid satisfies a preset probability value, and downloading the predictive viewpoint videos corresponding to the locations of the predictive viewpoint videos from a server end and transmitting the predictive viewpoint videos.

With reference to the first aspect, in a first possible implementation of the first aspect, the obtaining a first speed at which a user viewpoint switches includes, in a predetermined period of time before the user viewpoint switches to the location of the viewpoint video to which attention is currently paid, calculating an average value of the instantaneous speeds at the multiple moments, and setting the average value as the first speed when instantaneous speeds of the user at multiple moments are collected.

With reference to the first aspect, in a second possible implementation of the first aspect, the obtaining a first speed at which a user viewpoint switches includes, in a predetermined period of time before the user viewpoint switches to the location of the viewpoint video to which attention is currently paid, when an instantaneous speed of the user at a moment and an acceleration corresponding to the instantaneous speed at the moment are collected, determining the first speed according to a first rule and based on the instantaneous speed at the moment and the acceleration corresponding to the instantaneous speed at the moment, in a predetermined period of time before the user viewpoint switches to the location of the viewpoint video to which attention is currently paid, when instantaneous speeds of the user at multiple moments and an acceleration corresponding to an instantaneous speed at each moment are collected, calculating an average value of the instantaneous speeds at the multiple moments, and an average value of the multiple accelerations corresponding to the instantaneous speeds at the multiple moments, and determining the first speed according to a second rule and based on the average value of the instantaneous speeds at the multiple moments and the average value of the multiple accelerations, or in a predetermined period of time before the user viewpoint switches to the location of the viewpoint video to which attention is currently paid, when instantaneous speeds of the user at multiple moments and an acceleration corresponding to an instantaneous speed at each moment are collected, calculating an average value of the instantaneous speeds at the multiple moments, selecting an acceleration corresponding to an instantaneous speed from the accelerations corresponding to the instantaneous speeds at the multiple moments, and determining the first speed according to a third rule and based on the average value of the instantaneous speeds at the multiple moments and the selected acceleration corresponding to the instantaneous speed.

With reference to the second possible implementation of the first aspect, in a third possible implementation of the first aspect, the first rule includes:

V=v(t)+1/2Ta(t),

where V represents the first speed, v(t) represents a collected instantaneous speed of the user at a moment t, T represents duration of each viewpoint video, and a(t) represents an acceleration corresponding to the instantaneous speed at the moment t the second rule includes:

$$V = \frac{1}{n} \sum v ( t ) + \frac{1}{2 n} T \sum a ( t ) ,$$

where n represents a quantity of instantaneous speeds at multiple moments, V represents the first speed, v(t) represents a collected instantaneous speed of the user at a moment t, T represents duration of each viewpoint video, and a(t) represents an acceleration corresponding to the instantaneous speed at the moment t or the third rule includes:

$$V = \frac{1}{n} \sum v ( t ) + \frac{1}{2} Ta ( t ) ,$$

where n represents a quantity of instantaneous speeds at multiple moments, V represents the first speed, v(t) represents a collected instantaneous speed of the user at a moment t, T represents duration of each viewpoint video, and a(t) represents an acceleration corresponding to the instantaneous speed at the moment t.

With reference to any one of the first aspect or the first to the third possible implementations of the first aspect, in a fourth possible implementation of the first aspect, for a one-dimensional viewpoint video, the preset algorithm includes:

$$NNV = N \frac{VT}{D} ,$$

where NNV represents the quantity of the predictive viewpoint videos, V represents the first speed, N represents a total quantity of viewpoint videos, D represents an angle covered by the N viewpoint videos, and T represents the duration of each viewpoint video.

With reference to any one of the first aspect or the first to the fourth possible implementations of the first aspect, in a fifth possible implementation of the first aspect, for a one-dimensional viewpoint video, determining locations of the predictive viewpoint videos in the multi-view video according to a preset rule and according to the location of the viewpoint video to which the user currently pays attention, the first speed, and the quantity NNV of the predictive viewpoint videos includes, when the first speed is less than a predetermined speed threshold, and the quantity NNV of the predictive viewpoint videos is an even number, allocating

$$\frac{NNV}{2}$$

viewpoint videos at each of two sides neighboring to the location of the viewpoint video to which attention is currently paid and using the NNV viewpoint videos as predictive viewpoint videos, and if a quantity of viewpoint videos at a side neighboring to the location of the viewpoint video to which attention is currently paid is less than the quantity of the allocated viewpoint videos, setting the quantity of all the viewpoint videos at the side neighboring to the location of the viewpoint video to which attention is currently paid as the quantity of the allocated viewpoint videos, when the first speed is less than the predetermined speed threshold, and the quantity NNV of the predictive viewpoint videos is an odd number, setting

$$\frac{NNV + 1}{2}$$

viewpoint videos neighboring to a first direction side of the location of the viewpoint video to which attention is currently paid, and

$$\frac{NNV - 1}{2}$$

viewpoint videos neighboring to a second direction side of the viewpoint video to which attention is currently paid as predictive viewpoint videos, where the first direction side is the same as a vector direction of the first speed, and the second direction side is opposite to the vector direction of the first speed, and if a quantity of viewpoint videos at a side neighboring to the location of the viewpoint video to which attention is currently paid is less than a quantity of allocated viewpoint videos, using the quantity of all the viewpoint videos at the side neighboring to the location of the viewpoint video to which attention is currently paid as the quantity of the allocated viewpoint videos, when the first speed is less than the predetermined speed threshold, and the quantity NNV of the predictive viewpoint videos is an odd number, setting

$$\frac{NNV - 1}{2}$$

viewpoint videos neighboring to a first direction side of the location of the viewpoint video to which attention is currently paid, and

$$\frac{NNV + 1}{2}$$

viewpoint videos neighboring to a second direction side of the location of the viewpoint video to which attention is currently paid as predictive viewpoint videos, and if a quantity of viewpoint videos at a side neighboring to the location of the viewpoint video to which attention is currently paid is less than a quantity of allocated viewpoint videos, setting the quantity of all the viewpoint videos at the side neighboring to the location of the viewpoint video to which attention is currently paid as the quantity of the allocated viewpoint videos, or when the user switching speed is not less than the predetermined speed threshold, setting NNV viewpoint videos neighboring to a first direction side of the location of the viewpoint video to which attention is currently paid as predictive viewpoint videos, and if a quantity of viewpoint videos at a side neighboring to the location of the viewpoint video to which attention is currently paid is less than a quantity of allocated viewpoint videos, setting the quantity of all the viewpoint videos at the side neighboring to the location of the viewpoint video to which attention is currently paid as the quantity of the allocated viewpoint videos.

With reference to any one of the first aspect or the first to the fifth possible implementations of the first aspect, in a sixth possible implementation of the first aspect, the viewpoint video to which attention is currently paid is a viewpoint video in the multi-view video, or is a viewpoint video obtained after two neighboring viewpoint videos in the multi-view video are fused.

With reference to any one of the first aspect or the first to the third possible implementations of the first aspect, in a seventh possible implementation of the first aspect, for a two-dimensional viewpoint video, determining, according to the first speed and according to a preset algorithm, a quantity NNV of predictive viewpoint videos that need to be downloaded before the user switches to another viewpoint includes decomposing the first speed into a second speed in a horizontal direction and a third speed in a vertical direction, predicting a horizontal quantity NNVₓ of predictive viewpoint videos in the horizontal direction based on the second speed and according to a first algorithm included in the preset algorithm, and predicting a vertical quantity NNV_{y} of predictive viewpoint videos in the vertical direction based on the third speed and according to the first algorithm, and determining the quantity of the predictive viewpoint videos based on a quantity of fused viewpoint videos, the horizontal quantity NNVₓ of the predictive viewpoint videos, and the vertical quantity NNV_{y} of the predictive viewpoint videos and according to a second algorithm included in the preset algorithm, where the fused viewpoint videos are viewpoint videos that are fused in the multi-view video to obtain the viewpoint video to which attention is currently paid.

With reference to the seventh possible implementation of the first aspect, in an eighth possible implementation of the first aspect, the first algorithm includes:

$${NNV}_{x} = {N}_{x} \frac{{V}_{x} T}{{D}_{x}} ,$$

where NNVₓ represents the horizontal quantity of the predictive viewpoint videos, Nₓ represents a total quantity of viewpoint videos in the horizontal direction, N_{y} represents a total quantity of viewpoint videos in the vertical direction, Dₓ represents an angle covered by the Nₓ viewpoint videos in the horizontal direction, T represents the duration of each viewpoint video, and Vₓ represents the second speed, and

$${NNV}_{y} = {N}_{y} \frac{{V}_{y} T}{{D}_{y}} ,$$

where NNV_{y} represents the horizontal quantity of the predictive viewpoint videos, N_{y} represents a total quantity of viewpoint videos in the vertical direction, D_{y} represents an angle covered by the N_{y} viewpoint videos in the vertical direction, T represents the duration of each viewpoint video, and V_{y} represents the third speed.

With reference to the eighth possible implementation of the first aspect, in a ninth possible implementation of the first aspect, the determining the quantity of the predictive viewpoint videos based on a quantity of fused viewpoint videos, the horizontal quantity NNVₓ of the predictive viewpoint videos, and the vertical quantity NNV_{y} of the predictive viewpoint videos and according to a second algorithm included in the preset algorithm includes, if the quantity of the fused viewpoint videos is one, obtaining the NNV using the second algorithm satisfying a condition of the following formula:

NNV=(NNVₓ+1)*(NNV_{y}+1)−1,

if the quantity of the fused viewpoint videos is two and the fused viewpoint videos are distributed in the horizontal direction in the multi-view video, obtaining the quantity NNV of the predictive viewpoint videos using the second algorithm satisfying a condition of the following formula:

NNV=(NNVₓ+2)*(NNV_{y}+1)−2,

if the quantity of the fused viewpoint videos is two and the fused viewpoint videos are distributed in the vertical direction in the multi-view video, obtaining the quantity NNV of the predictive viewpoint videos using the second algorithm satisfying a condition of the following formula:

NNV=(NNVₓ+1)*(NNV_{y}+2)−2, or

if the quantity of the fused viewpoint videos is four and two viewpoint videos are distributed in each of the horizontal direction and the vertical direction in the multi-view video, obtaining the quantity NNV of the predictive viewpoint videos using the second algorithm satisfying a condition of the following formula:

NNV=(NNVₓ+2)*(NNV_{y}30 2)−4.

With reference to any one of the seventh to the ninth possible implementations of the first aspect, in a tenth possible implementation of the first aspect, for a two-dimensional viewpoint video, determining locations of the predictive viewpoint videos in the multi-view video according to a preset rule and according to the location of the viewpoint video to which the user currently pays attention, the first speed, and the NNV includes, when the second speed is less than a speed threshold in the horizontal direction, and the third speed is less than a speed threshold in the vertical direction, setting NNV viewpoint videos in a first rectangular area other than the fused viewpoint videos as predictive viewpoint videos, where the first rectangular area is a rectangular area formed by a first side length that is the horizontal quantity NNVₓ of the predictive viewpoint videos plus a quantity of fused viewpoint videos in the horizontal direction, and a second side length that is the vertical quantity NNV_{y} of the predictive viewpoint videos plus a quantity of fused viewpoint videos in the vertical direction, and a geometrical center of the first rectangular area is the viewpoint video to which attention is currently paid, and if a quantity of viewpoint videos included in the first rectangular area is less than the quantity of the predictive viewpoint videos, using all the viewpoint videos included in the first rectangular area as predictive viewpoint videos, when the second speed is less than a speed threshold in the horizontal direction, and the third speed is not less than a speed threshold in the vertical direction, setting NNV viewpoint videos in a second rectangular area other than the fused viewpoint videos as predictive viewpoint videos, where the second rectangular area is a rectangular area formed by a first side length that is the horizontal quantity NNVₓ of the predictive viewpoint videos plus a quantity of fused viewpoint videos in the horizontal direction, and a second side length that is the vertical quantity NNV_{y} of the predictive viewpoint videos plus a quantity of fused viewpoint videos in the vertical direction, and the predictive viewpoint videos are uniformly distributed, in the horizontal direction, at the two sides neighboring to the location of the viewpoint video to which attention is currently paid, and distributed, in the vertical direction, at a location of a side that is neighboring to the viewpoint video to which attention is currently paid and that is the same as a vector direction of the third speed, and if a quantity of viewpoint videos included in the second rectangular area is less than the quantity of the predictive viewpoint videos, setting all the viewpoint videos included in the second rectangular area as predictive viewpoint videos, when the second speed is not less than a speed threshold in the horizontal direction, and the third speed is less than a speed threshold in the vertical direction, setting NNV viewpoint videos in a third rectangular area other than the fused viewpoint videos as predictive viewpoint videos, where the third rectangular area is a rectangular area formed by a first side length that is the horizontal quantity NNVₓ of the predictive viewpoint videos plus a quantity of fused viewpoint videos in the horizontal direction, and a second side length that is the vertical quantity NNV_{y} of the predictive viewpoint videos plus a quantity of fused viewpoint videos in the vertical direction, and the predictive viewpoint videos are uniformly distributed, in the vertical direction, at the two sides neighboring to the location of the viewpoint video to which attention is currently paid, and distributed, in the horizontal direction, at a location of a side that is neighboring to the viewpoint video to which attention is currently paid and that is the same as a vector direction of the second speed, and if a quantity of viewpoint videos included in the third rectangular area is less than the quantity of the predictive viewpoint videos, setting all the viewpoint videos included in the third rectangular area as predictive viewpoint videos, or when the second speed is not less than a speed threshold in the horizontal direction, and the third speed is not less than a speed threshold in the vertical direction, setting NNV viewpoint videos in a fourth rectangular area other than the fused viewpoint videos as predictive viewpoint videos, where the fourth rectangular area is a rectangular area formed by a first side length that is the horizontal quantity NNVₓ of the predictive viewpoint videos plus a quantity of fused viewpoint videos in the horizontal direction, and a second side length that is the vertical quantity NNV_{y} of the predictive viewpoint videos plus a quantity of fused viewpoint videos in the vertical direction, and the predictive viewpoint videos are distributed, in the vertical direction, at a location of a side that is neighboring to the viewpoint video to which attention is currently paid and that is the same as a vector direction of the third speed, and distributed, in the horizontal direction, at a location of a side that is neighboring to the viewpoint video to which attention is currently paid and that is the same as a vector direction of the second speed, and if a quantity of viewpoint videos included in the fourth rectangular area is less than the quantity of the predictive viewpoint videos, setting all the viewpoint videos included in the fourth rectangular area as predictive viewpoint videos.

With reference to any one of the first aspect or the first to the tenth possible implementations of the first aspect, in an eleventh possible implementation of the first aspect, each viewpoint video includes multiple bit rate versions, each bit rate version requires a different bandwidth, and downloading the predictive viewpoint videos corresponding to the locations of the predictive viewpoint videos from a server end and transmitting the predictive viewpoint videos includes determining, according to a total bandwidth value allocated for viewpoint video transmission, and a preset bandwidth allocation policy, a bit rate version of the viewpoint video to which attention is currently paid and bit rate versions of the predictive viewpoint videos, and downloading the predictive viewpoint videos from the server end according to the locations of the predictive viewpoint videos and the bit rate versions of the predictive viewpoint videos, and downloading the viewpoint video to which attention is currently paid from the server end according to the location of the viewpoint video to which attention is currently paid, and the bit rate version of the viewpoint video to which attention is currently paid.

With reference to the eleventh possible implementation of the first aspect, in a twelfth possible implementation of the first aspect, after it is determined that the viewpoint video to which attention is currently paid is completely transmitted, and the bit rate version of the completely transmitted viewpoint video to which attention is currently paid is determined, the determining, according to a total bandwidth value allocated for viewpoint video transmission, and a preset bandwidth allocation policy, a bit rate version of the viewpoint video to which attention is currently paid and bit rate versions of the predictive viewpoint videos includes sequentially allocating, based on an ascending order of distances between the predictive viewpoint videos and the viewpoint video to which attention is currently paid, a bandwidth value to a lowest bit rate for transmitting each viewpoint video of the predictive viewpoint videos, and raising, based on a difference between the total bandwidth value and the bandwidth value that is allocated to the lowest bit rate for transmitting the predictive viewpoint videos, the bit rate version of the viewpoint video to which attention is currently paid, until the bit rate version of the viewpoint video to which attention is currently paid is the highest or the total bandwidth value is exhausted in order to determine the bit rate version of the viewpoint video to which attention is currently paid and the bit rate versions of the predictive viewpoint videos.

With reference to the eleventh possible implementation of the first aspect, in a thirteenth possible implementation of the first aspect, when the viewpoint video to which attention is currently paid is incompletely transmitted, determining, according to a total bandwidth value allocated for viewpoint video transmission, and a preset bandwidth allocation policy, a bit rate version of the viewpoint video to which attention is currently paid and bit rate versions of the predictive viewpoint videos includes allocating, based on the total bandwidth value, a first bandwidth value to a lowest bit rate version of the incompletely transmitted viewpoint video to which attention is currently paid, sequentially allocating, based on a difference between the total bandwidth value and the first bandwidth value, and distances between the predictive viewpoint videos and the viewpoint video to which attention is currently paid, a second bandwidth value to a lowest bit rate for transmitting each viewpoint video of the predictive viewpoint videos, and raising, based on the difference between the total bandwidth value and the first bandwidth value and a difference between the total bandwidth value and the second bandwidth value, the bit rate version of the viewpoint video to which attention is currently paid, until the bit rate version of the viewpoint video to which attention is currently paid is the highest or the total bandwidth value is exhausted in order to determine the bit rate version of the viewpoint video to which attention is currently paid and the bit rate versions of the predictive viewpoint videos.

With reference to the twelfth or the thirteenth possible implementation of the first aspect, in a fourteenth possible implementation of the first aspect, the method further includes when the bit rate version of the viewpoint video to which attention is currently paid is the highest and the total bandwidth value is not exhausted, sequentially raising, based on the ascending order of the distances between the predictive viewpoint videos and the viewpoint video to which attention is currently paid, a bit rate version of each viewpoint video of the predictive viewpoint videos, until the bit rate version of each viewpoint video of the predictive viewpoint videos is the highest or the total bandwidth value is exhausted.

According to a second aspect, an embodiment of the present disclosure provides a multi-view video transmission apparatus, including a first obtaining unit configured to obtain a location of a viewpoint video to which a user currently pays attention in a multi-view video, a second obtaining unit configured to obtain a first speed at which a user viewpoint switches, where the first speed is a speed at which the user viewpoint switches to the location of the viewpoint video to which attention is currently paid, a first determining unit configured to determine, according to the first speed obtained by the second obtaining unit and according to a preset algorithm, an NNV that needs to be downloaded before the user switches to another viewpoint, a second determining unit configured to determine locations of the predictive viewpoint videos in the multi-view video according to a preset rule and according to the location that is obtained by the first obtaining unit and that is of the viewpoint video to which the user currently pays attention, the first speed obtained by the second obtaining unit, and the NNV that is determined by the first determining unit, where the predictive viewpoint videos are viewpoint videos whose probability of becoming a next viewpoint video attention is to be paid satisfies a preset probability value, and a download unit configured to download the predictive viewpoint videos corresponding to the locations of the predictive viewpoint videos from a server end and transmit the predictive viewpoint videos, where the locations are determined by the second determining unit.

With reference to the second aspect, in a first possible implementation of the second aspect, the second obtaining unit is further configured to, in a predetermined period of time before the user viewpoint switches to the location of the viewpoint video to which attention is currently paid, collect instantaneous speeds of the user at multiple moments, and calculate an average value of the collected instantaneous speeds at the multiple moments, and set the average value as the first speed.

With reference to the second aspect, in a second possible implementation of the second aspect, the second obtaining unit is further configured to, in a predetermined period of time before the user viewpoint switches to the location of the viewpoint video to which attention is currently paid, collect an instantaneous speed of the user at a moment and an acceleration corresponding to the instantaneous speed at the moment, and determine the first speed according to a first rule and based on the collected instantaneous speed at the moment and the collected acceleration corresponding to the instantaneous speed at the moment, the second obtaining unit is further configured to, in a predetermined period of time before the user viewpoint switches to the location of the viewpoint video to which attention is currently paid, collect instantaneous speeds of the user at multiple moments and an acceleration corresponding to an instantaneous speed at each moment, and calculate an average value of the collected instantaneous speeds at the multiple moments, calculate an average value of the multiple collected accelerations corresponding to the instantaneous speeds at the multiple moments, and determine the first speed according to a second rule and based on the average value of the instantaneous speeds at the multiple moments and the average value of the multiple accelerations, or the second obtaining unit is further configured to, in a predetermined period of time before the user viewpoint switches to the location of the viewpoint video to which attention is currently paid, collect instantaneous speeds of the user at multiple moments and an acceleration corresponding to an instantaneous speed at each moment, and calculate an average value of the instantaneous speeds at the multiple moments, and select an acceleration corresponding to an instantaneous speed from the accelerations corresponding to the instantaneous speeds at the multiple moments, and determine the first speed according to a third rule and based on the average value of the instantaneous speeds at the multiple moments and the selected acceleration corresponding to the instantaneous speed.

With reference to the second possible implementation of the second aspect, in a third possible implementation of the second aspect, the first rule includes:

V=v(t)+1/2Ta(t),

where V represents the first speed, v(t) represents a collected instantaneous speed of the user at a moment t, T represents duration of each viewpoint video, and a(t) represents an acceleration corresponding to the instantaneous speed at the moment t the second rule includes:

$$V = \frac{1}{n} \sum v ( t ) + \frac{1}{2 n} T \sum a ( t ) ,$$

where n represents a quantity of instantaneous speeds at multiple moments, v(t) represents a collected instantaneous speed of the user at a moment t, T represents duration of each viewpoint video, and a(t) represents an acceleration corresponding to the instantaneous speed at the moment t, or the third rule includes:

$$V = \frac{1}{n} \sum v ( t ) + \frac{1}{2} T \sum a ( t ) ,$$

where n represents a quantity of instantaneous speeds at multiple moments, v(t) represents a collected instantaneous speed of the user at a moment t, T represents duration of each viewpoint video, and a(t) represents an acceleration corresponding to the instantaneous speed at the moment t.

With reference to any one of the second aspect or the first to the third possible implementations of the second aspect, in a fourth possible implementation of the second aspect, for a one-dimensional viewpoint video, the preset algorithm includes:

$$NNV = N \frac{VT}{D} ,$$

where NNV represents the quantity of the predictive viewpoint videos, V represents the first speed, N represents a total quantity of viewpoint videos, D represents an angle covered by the N viewpoint videos, and T represents the duration of each viewpoint video.

With reference to any one of the second aspect or the first to the fourth possible implementations of the second aspect, in a fifth possible implementation of the second aspect, for a one-dimensional viewpoint video, the second determining unit is further configured to, when the first speed is less than a predetermined speed threshold, and the quantity NNV of the predictive viewpoint videos is an even number, allocate

$$\frac{NNV}{2}$$

viewpoint videos at each of two sides neighboring to the location of the viewpoint video to which attention is currently paid, and set the NNV viewpoint videos allocated at the two sides neighboring to the location of the viewpoint video to which attention is currently paid as predictive viewpoint videos, and if a quantity of viewpoint videos at a side neighboring to the location of the viewpoint video to which attention is currently paid is less than the quantity of the allocated viewpoint videos, set the quantity of the viewpoint videos at the side neighboring to the location of the viewpoint video to which attention is currently paid as the quantity of the allocated viewpoint videos, when the first speed is less than the predetermined speed threshold, and the quantity NNV of the predictive viewpoint videos is an odd number, set

$$\frac{NNV + 1}{2}$$

viewpoint videos neighboring to a first direction side of the viewpoint video to which attention is currently paid, and

$$\frac{NNV - 1}{2}$$

viewpoint videos neighboring to a second direction side of the viewpoint video to which attention is currently paid as predictive viewpoint videos, where the first direction side is the same as a vector direction of the first speed, and the second direction side is opposite to the vector direction of the first speed, and if a quantity of viewpoint videos at a side neighboring to the location of the viewpoint video to which attention is currently paid is less than a quantity of allocated viewpoint videos, set the quantity of the viewpoint videos at the side neighboring to the location of the viewpoint video to which attention is currently paid as the quantity of the allocated viewpoint videos, when the first speed is less than the predetermined speed threshold, and the quantity NNV of the predictive viewpoint videos is an odd number, set

$$\frac{NNV - 1}{2}$$

viewpoint videos neighboring to a first direction side of the viewpoint video to which attention is currently paid, and

$$\frac{NNV + 1}{2}$$

viewpoint videos neighboring to a second direction side of the viewpoint video to which attention is currently paid as predictive viewpoint videos, and if a quantity of viewpoint videos at a side neighboring to the location of the viewpoint video to which attention is currently paid is less than a quantity of allocated viewpoint videos, set the quantity of the viewpoint videos at the side neighboring to the location of the viewpoint video to which attention is currently paid as the quantity of the allocated viewpoint videos, or when the user switching speed is not less than the predetermined speed threshold, set NNV viewpoint videos neighboring to a first direction side of the viewpoint video to which attention is currently paid as predictive viewpoint videos, and if a quantity of viewpoint videos at a side neighboring to the location of the viewpoint video to which attention is currently paid is less than a quantity of allocated viewpoint videos, set the quantity of the viewpoint videos at the side neighboring to the location of the viewpoint video to which attention is currently paid as the quantity of the allocated viewpoint videos.

With reference to any one of the second aspect or the first to the fifth possible implementations of the second aspect, in a sixth possible implementation of the second aspect, the viewpoint video to which attention is currently paid is a viewpoint video in the multi-view video, or is a viewpoint video obtained after two neighboring viewpoint videos in the multi-view video are fused.

With reference to any one of the second aspect or the first to the third possible implementations of the second aspect, in a seventh possible implementation of the second aspect, for a two-dimensional viewpoint video, the first determining unit is further configured to decompose the first speed into a second speed in a horizontal direction and a third speed in a vertical direction, predict a horizontal quantity NNVₓ of predictive viewpoint videos in the horizontal direction based on the second speed and according to a first algorithm included in the preset algorithm, and predict a vertical quantity of predictive viewpoint videos in the vertical direction based on the third speed and according to the first algorithm, and determine the quantity of the predictive viewpoint videos based on a quantity of fused viewpoint videos, the horizontal quantity of the predictive viewpoint videos, and the vertical quantity NNV_{y} of the predictive viewpoint videos and according to a second algorithm included in the preset algorithm, where the fused viewpoint videos are viewpoint videos that are fused in the multi-view video to obtain the viewpoint video to which attention is currently paid.

With reference to the seventh possible implementation of the second aspect, in an eighth possible implementation of the second aspect, the first algorithm includes:

$${NNV}_{x} = {N}_{x} \frac{{V}_{x} T}{{D}_{x}} ,$$

where NNVₓ represents the horizontal quantity of the predictive viewpoint videos, Nₓ represents a total quantity of viewpoint videos in the horizontal direction, N_{y} represents a total quantity of viewpoint videos in the vertical direction, Dₓ represents an angle covered by the Nₓ viewpoint videos in the horizontal direction, T represents the duration of each viewpoint video, and Vₓ represents the second speed, and

$${NNV}_{y} = {N}_{y} \frac{{V}_{y} T}{{D}_{y}} ,$$

where NNV_{y} represents the horizontal quantity of the predictive viewpoint videos, N_{y} represents a total quantity of viewpoint videos in the vertical direction, D_{y} represents an angle covered by the N_{y} viewpoint videos in the vertical direction, T represents the duration of each viewpoint video, and V_{y} represents the third speed.

With reference to the eighth possible implementation of the second aspect, in a ninth possible implementation of the second aspect, when determining the quantity of the predictive viewpoint videos based on the quantity of the fused viewpoint videos, the horizontal quantity NNVₓ of the predictive viewpoint videos, and the vertical quantity NNV_{y} of the predictive viewpoint videos and according to the second algorithm included in the preset algorithm, the first determining unit is further configured to, if the quantity of the fused viewpoint videos is one, obtain the quantity NNV of the predictive viewpoint videos using the second algorithm satisfying a condition of the following formula:

NNV=(NNVₓ+1)*(NNV_{y}+1)−1,

if the quantity of the fused viewpoint videos is two and the fused viewpoint videos are distributed in the horizontal direction in the multi-view video, obtain the quantity NNV of the predictive viewpoint videos using the second algorithm satisfying a condition of the following formula:

NNV=(NNVₓ+2)*(NNV_{y}+1)−2,

if the quantity of the fused viewpoint videos is two and the fused viewpoint videos are distributed in the vertical direction in the multi-view video, obtain the quantity NNV of the predictive viewpoint videos using the second algorithm satisfying a condition of the following formula:

NNV=(NNVₓ+1)*(NNV_{y}+2)−2, or

if the quantity of the fused viewpoint videos is four and two viewpoint videos are distributed in each of the horizontal direction and the vertical direction in the multi-view video, obtain the quantity NNV of the predictive viewpoint videos using the second algorithm satisfying a condition of the following formula:

NNV=(NNVₓ+2)*(NNV_{y}+2)−4.

With reference to any one of the seventh to the ninth possible implementations of the second aspect, in a tenth possible implementation of the second aspect, for a two-dimensional viewpoint video, the second determining unit is further configured to, when the second speed is less than a speed threshold in the horizontal direction, and the third speed is less than a speed threshold in the vertical direction, set NNV viewpoint videos in a first rectangular area other than the fused viewpoint videos as predictive viewpoint videos, where the first rectangular area is a rectangular area formed by a first side length that is the horizontal quantity of the predictive viewpoint videos plus a quantity of fused viewpoint videos in the horizontal direction, and a second side length that is the vertical quantity of the predictive viewpoint videos plus a quantity of fused viewpoint videos in the vertical direction, and a geometrical center of the first rectangular area is the viewpoint video to which attention is currently paid, and if a quantity of viewpoint videos included in the first rectangular area is less than the quantity of the predictive viewpoint videos, set all the viewpoint videos included in the first rectangular area as predictive viewpoint videos, when the second speed is less than a speed threshold in the horizontal direction, and the third speed is not less than a speed threshold in the vertical direction, set NNV viewpoint videos in a second rectangular area other than the fused viewpoint videos as predictive viewpoint videos, where the second rectangular area is a rectangular area formed by a first side length that is the horizontal quantity of the predictive viewpoint videos plus a quantity of fused viewpoint videos in the horizontal direction, and a second side length that is the vertical quantity of the predictive viewpoint videos plus a quantity of fused viewpoint videos in the vertical direction, and the predictive viewpoint videos are uniformly distributed, in the horizontal direction, at the two sides neighboring to the location of the viewpoint video to which attention is currently paid, and distributed, in the vertical direction, at a location of a side that is neighboring to the viewpoint video to which attention is currently paid and that is the same as a vector direction of the third speed, and if a quantity of viewpoint videos included in the second rectangular area is less than the quantity of the predictive viewpoint videos, set all the viewpoint videos included in the second rectangular area as predictive viewpoint videos, when the second speed is not less than a speed threshold in the horizontal direction, and the third speed is less than a speed threshold in the vertical direction, set NNV viewpoint videos in a third rectangular area other than the fused viewpoint videos as predictive viewpoint videos, where the third rectangular area is a rectangular area formed by a first side length that is the horizontal quantity of the predictive viewpoint videos plus a quantity of fused viewpoint videos in the horizontal direction, and a second side length that is the vertical quantity of the predictive viewpoint videos plus a quantity of fused viewpoint videos in the vertical direction, and the predictive viewpoint videos are uniformly distributed, in the vertical direction, at the two sides neighboring to the location of the viewpoint video to which attention is currently paid, and distributed, in the horizontal direction, at a location of a side that is neighboring to the viewpoint video to which attention is currently paid and that is the same as a vector direction of the second speed, and if a quantity of viewpoint videos included in the third rectangular area is less than the quantity of the predictive viewpoint videos, set all the viewpoint videos included in the third rectangular area as predictive viewpoint videos, or when the second speed is not less than a speed threshold in the horizontal direction, and the third speed is not less than a speed threshold in the vertical direction, set NNV viewpoint videos in a fourth rectangular area other than the fused viewpoint videos as predictive viewpoint videos, where the fourth rectangular area is a rectangular area formed by a first side length that is the horizontal quantity of the predictive viewpoint videos plus a quantity of fused viewpoint videos in the horizontal direction, and a second side length that is the vertical quantity of the predictive viewpoint videos plus a quantity of fused viewpoint videos in the vertical direction, and the predictive viewpoint videos are distributed, in the vertical direction, at a location of a side that is neighboring to the viewpoint video to which attention is currently paid and that is the same as a vector direction of the third speed, and distributed, in the horizontal direction, at a location of a side that is neighboring to the viewpoint video to which attention is currently paid and that is the same as a vector direction of the second speed, and if a quantity of viewpoint videos included in the fourth rectangular area is less than the quantity of the predictive viewpoint videos, use all the viewpoint videos included in the fourth rectangular area as predictive viewpoint videos.

With reference to any one of the second aspect or the first to the tenth possible implementations of the second aspect, in an eleventh possible implementation of the second aspect, each viewpoint video includes multiple bit rate versions, each bit rate version requires a different bandwidth, and the download unit is further configured to determine, according to a total bandwidth value allocated for viewpoint video transmission, and a preset bandwidth allocation policy, a bit rate version of the viewpoint video to which attention is currently paid and bit rate versions of the predictive viewpoint videos, and download the predictive viewpoint videos from the server end according to the locations of the predictive viewpoint videos and the bit rate versions of the predictive viewpoint videos, and download the viewpoint video to which attention is currently paid from the server end according to the location of the viewpoint video to which attention is currently paid, and the bit rate version of the viewpoint video to which attention is currently paid.

With reference to the eleventh possible implementation of the second aspect, in a twelfth possible implementation of the second aspect, after it is determined that the viewpoint video to which attention is currently paid is completely transmitted, and the bit rate version of the completely transmitted viewpoint video to which attention is currently paid is determined, the download unit is further configured to sequentially allocate, based on an ascending order of distances between the predictive viewpoint videos and the viewpoint video to which attention is currently paid, a bandwidth value to a lowest bit rate for transmitting each viewpoint video of the predictive viewpoint videos, and raise, based on a difference between the total bandwidth value and the bandwidth value that is allocated to the lowest bit rate for transmitting the predictive viewpoint videos, the bit rate version of the viewpoint video to which attention is currently paid, until the bit rate version of the viewpoint video to which attention is currently paid is the highest or the total bandwidth value is exhausted in order to determine the bit rate version of the viewpoint video to which attention is currently paid and the bit rate versions of the predictive viewpoint videos.

With reference to the eleventh possible implementation of the second aspect, in a thirteenth possible implementation of the second aspect, when the viewpoint video to which attention is currently paid is incompletely transmitted, the download unit is further configured to allocate, based on the total bandwidth value, a first bandwidth value to a lowest bit rate version of the incompletely transmitted viewpoint video to which attention is currently paid, sequentially allocate, based on a difference between the total bandwidth value and the first bandwidth value, and distances between the predictive viewpoint videos and the viewpoint video to which attention is currently paid, a second bandwidth value to a lowest bit rate for transmitting each viewpoint video of the predictive viewpoint videos, and raise, based on the difference between the total bandwidth value and the first bandwidth value and a difference between the total bandwidth value and the second bandwidth value, the bit rate version of the viewpoint video to which attention is currently paid, until the bit rate version of the viewpoint video to which attention is currently paid is the highest or the total bandwidth value is exhausted in order to determine the bit rate version of the viewpoint video to which attention is currently paid and the bit rate versions of the predictive viewpoint videos.

With reference to the twelfth or the thirteenth possible implementation of the second aspect, in a fourteenth possible implementation of the second aspect, the download unit is further configured to when the bit rate version of the viewpoint video to which attention is currently paid is the highest and the total bandwidth value is not exhausted, sequentially raise, based on the ascending order of the distances between the predictive viewpoint videos and the viewpoint video to which attention is currently paid, a bit rate version of each viewpoint video of the predictive viewpoint videos, until the bit rate version of each viewpoint video of the predictive viewpoint videos is the highest or the total bandwidth value is exhausted.

According to a third aspect, an embodiment of the present disclosure provides a multi-view video transmission apparatus, including a memory, a communications interface, a processor, and a bus, where the memory, the communications interface, and the processor are separately connected to each other using the bus, the memory is configured to store program code, and the processor is configured to execute the program code stored in the memory, and is further configured to perform obtaining a location of a viewpoint video to which a user currently pays attention in a multi-view video, obtaining a first speed at which a user viewpoint switches, where the first speed is a speed at which the user viewpoint switches to the location of the viewpoint video to which attention is currently paid, determining, according to the first speed and according to a preset algorithm, a quantity NNV of predictive viewpoint videos that need to be downloaded before the user switches to another viewpoint, determining locations of the predictive viewpoint videos in the multi-view video according to a preset rule and according to the location of the viewpoint video to which the user currently pays attention, the first speed, and the quantity NNV of the predictive viewpoint videos, where the predictive viewpoint videos are viewpoint videos whose probability of becoming a next viewpoint video attention is to be paid satisfies a preset probability value, and downloading the predictive viewpoint videos corresponding to the locations of the predictive viewpoint videos from a server end using the communications interface and transmitting the predictive viewpoint videos.

With reference to the third aspect, in a first possible implementation of the third aspect, when obtaining the first speed at which the user viewpoint switches, the processor is further configured to, in a predetermined period of time before the user viewpoint switches to the location of the viewpoint video to which attention is currently paid, when instantaneous speeds of the user at multiple moments are collected, calculate an average value of the instantaneous speeds at the multiple moments, and use the average value as the first speed.

With reference to the third aspect, in a second possible implementation of the third aspect, when obtaining the first speed at which the user viewpoint switches, the processor is further configured to, in a predetermined period of time before the user viewpoint switches to the location of the viewpoint video to which attention is currently paid, when an instantaneous speed of the user at a moment and an acceleration corresponding to the instantaneous speed at the moment are collected, determine the first speed according to a first rule and based on the instantaneous speed at the moment and the acceleration corresponding to the instantaneous speed at the moment, in a predetermined period of time before the user viewpoint switches to the location of the viewpoint video to which attention is currently paid, when instantaneous speeds of the user at multiple moments and an acceleration corresponding to an instantaneous speed at each moment are collected, calculate an average value of the instantaneous speeds at the multiple moments, and an average value of the multiple accelerations corresponding to the instantaneous speeds at the multiple moments, and determine the first speed according to a second rule and based on the average value of the instantaneous speeds at the multiple moments and the average value of the multiple accelerations, or in a predetermined period of time before the user viewpoint switches to the location of the viewpoint video to which attention is currently paid, when instantaneous speeds of the user at multiple moments and an acceleration corresponding to an instantaneous speed at each moment are collected, calculate an average value of the instantaneous speeds at the multiple moments, select an acceleration corresponding to an instantaneous speed from the accelerations corresponding to the instantaneous speeds at the multiple moments, and determine the first speed according to a third rule and based on the average value of the instantaneous speeds at the multiple moments and the selected acceleration corresponding to the instantaneous speed.

With reference to any one of the third aspect or the first and the second possible implementations of the third aspect, in a third possible implementation of the third aspect, for a one-dimensional viewpoint video, when determining the locations of the predictive viewpoint videos in the multi-view video according to the preset rule and according to the location of the viewpoint video to which the user currently pays attention, the first speed, and the NNV, the processor is further configured to, when the first speed is less than a predetermined speed threshold, and the NNV is an even number, allocate

$$\frac{NNV}{2}$$

viewpoint videos at each of the two sides neighboring to the location of the viewpoint video to which attention is currently paid, and set the NNV viewpoint videos allocated at the two sides of the location neighboring to the viewpoint video to which attention is currently paid as predictive viewpoint videos, and if a quantity of viewpoint videos at a side neighboring to the location of the viewpoint video to which attention is currently paid is less than the quantity of the allocated viewpoint videos, set the quantity of the viewpoint videos at the side neighboring to the location of the viewpoint video to which attention is currently paid as the quantity of the allocated viewpoint videos, when the first speed is less than the predetermined speed threshold, and the quantity NNV of the predictive viewpoint videos is an odd number, set

$$\frac{NNV + 1}{2}$$

viewpoint videos neighboring to a first direction side of the viewpoint video to which attention is currently paid, and

$$\frac{NNV - 1}{2}$$

viewpoint videos neighboring to a second direction side of the viewpoint video to which attention is currently paid as predictive viewpoint videos, where the first direction side is the same as a vector direction of the first speed, and the second direction side is opposite to the vector direction of the first speed, and if a quantity of viewpoint videos at a side neighboring to the location of the viewpoint video to which attention is currently paid is less than a quantity of allocated viewpoint videos, set the quantity of the viewpoint videos at the side neighboring to the location of the viewpoint video to which attention is currently paid as the quantity of the allocated viewpoint videos, when the first speed is less than the predetermined speed threshold, and the quantity NNV of the predictive viewpoint videos is an odd number, set

$$\frac{NNV - 1}{2}$$

viewpoint videos neighboring to a first direction side of the viewpoint video to which attention is currently paid, and

$$\frac{NNV + 1}{2}$$

viewpoint videos neighboring to a second direction side of the viewpoint video to which attention is currently paid as predictive viewpoint videos, and if a quantity of viewpoint videos at a side neighboring to the location of the viewpoint video to which attention is currently paid is less than a quantity of allocated viewpoint videos, set the quantity of the viewpoint videos at the side neighboring to the location of the viewpoint video to which attention is currently paid as the quantity of the allocated viewpoint videos, or when the user switching speed is not less than the predetermined speed threshold, use NNV viewpoint videos neighboring to a first direction side of the viewpoint video to which attention is currently paid as predictive viewpoint videos, and if a quantity of viewpoint videos at a side neighboring to the location of the viewpoint video to which attention is currently paid is less than a quantity of allocated viewpoint videos, set the quantity of the viewpoint videos at the side neighboring to the location of the viewpoint video to which attention is currently paid as the quantity of the allocated viewpoint videos.

With reference to any one of the third aspect or the first and the second possible implementations of the third aspect, in a fourth possible implementation of the third aspect, for a two-dimensional viewpoint video, when determining, according to the first speed and according to the preset algorithm, the NNV that need to be downloaded before the user switches to the other viewpoint, the processor is further configured to decompose the first speed into a second speed in a horizontal direction and a third speed in a vertical direction, predict a horizontal quantity of predictive viewpoint videos in the horizontal direction based on the second speed and according to a first algorithm included in the preset algorithm, and predict a vertical quantity of predictive viewpoint videos in the vertical direction based on the third speed and according to the first algorithm, and determine the quantity of the predictive viewpoint videos based on a quantity of fused viewpoint videos, the horizontal quantity NNVₓ of the predictive viewpoint videos, and the vertical quantity NNV_{y} of the predictive viewpoint videos and according to a second algorithm included in the preset algorithm.

With reference to any one of the third aspect or the first to the fourth possible implementations of the third aspect, in a fifth possible implementation of the third aspect, each viewpoint video includes multiple bit rate versions, each bit rate version requires a different bandwidth, and when downloading the predictive viewpoint videos corresponding to the locations of the predictive viewpoint videos from the server end and transmitting the predictive viewpoint videos, the processor is further configured to determine, according to a total bandwidth value allocated for viewpoint video transmission, and a preset bandwidth allocation policy, a bit rate version of the viewpoint video to which attention is currently paid and bit rate versions of the predictive viewpoint videos, and download the predictive viewpoint videos from the server end according to the locations of the predictive viewpoint videos and the bit rate versions of the predictive viewpoint videos, and download the viewpoint video to which attention is currently paid from the server end according to the location of the viewpoint video to which attention is currently paid, and the bit rate version of the viewpoint video to which attention is currently paid.

With reference to the fifth possible implementation of the third aspect, in a sixth possible implementation of the third aspect, the processor is further configured to determine that the viewpoint video to which attention is currently paid is completely transmitted, and determine the bit rate version of the completely transmitted viewpoint video to which attention is currently paid, and then when determining, according to the total bandwidth value allocated for viewpoint video transmission, and the preset bandwidth allocation policy, the bit rate version of the viewpoint video to which attention is currently paid and the bit rate versions of the predictive viewpoint videos, the processor is further configured to sequentially allocate, based on an ascending order of distances between the predictive viewpoint videos and the viewpoint video to which attention is currently paid, a bandwidth value to a lowest bit rate for transmitting each viewpoint video of the predictive viewpoint videos, and raise, based on a difference between the total bandwidth value and the bandwidth value that is allocated to the lowest bit rate for transmitting the predictive viewpoint videos, the bit rate version of the viewpoint video to which attention is currently paid, until the bit rate version of the viewpoint video to which attention is currently paid is the highest or the total bandwidth value is exhausted in order to determine the bit rate version of the viewpoint video to which attention is currently paid and the bit rate versions of the predictive viewpoint videos.

With reference to the sixth possible implementation of the third aspect, in a seventh possible implementation of the third aspect, the processor is further configured to determine that the viewpoint video to which attention is currently paid is incompletely transmitted, and then when determining, according to the total bandwidth value allocated for viewpoint video transmission, and the preset bandwidth allocation policy, the bit rate version of the viewpoint video to which attention is currently paid and the bit rate versions of the predictive viewpoint videos, the processor is further configured to allocate, based on the total bandwidth value, a first bandwidth value to a lowest bit rate version of the incompletely transmitted viewpoint video to which attention is currently paid, sequentially allocate, based on a difference between the total bandwidth value and the first bandwidth value, and distances between the predictive viewpoint videos and the viewpoint video to which attention is currently paid, a second bandwidth value to a lowest bit rate for transmitting each viewpoint video of the predictive viewpoint videos, and raise, based on the difference between the total bandwidth value and the first bandwidth value and a difference between the total bandwidth value and the second bandwidth value, the bit rate version of the viewpoint video to which attention is currently paid, until the bit rate version of the viewpoint video to which attention is currently paid is the highest or the total bandwidth value is exhausted in order to determine the bit rate version of the viewpoint video to which attention is currently paid and the bit rate versions of the predictive viewpoint videos.

With reference to the sixth or the seventh possible implementation of the third aspect, in an eighth possible implementation of the third aspect, the processor is further configured to, when the bit rate version of the viewpoint video to which attention is currently paid is the highest and the total bandwidth value is not exhausted, sequentially raise, based on the ascending order of the distances between the predictive viewpoint videos and the viewpoint video to which attention is currently paid, a bit rate version of each viewpoint video of the predictive viewpoint videos, until the bit rate version of each viewpoint video of the predictive viewpoint videos is the highest or the total bandwidth value is exhausted.

The present disclosure has the following beneficial effects By means of the method provided in the embodiments of the present disclosure, information about a viewpoint video to which a user currently pays attention is obtained, where the information about the viewpoint video to which the user currently pays attention includes a location of the viewpoint video to which the user currently pays attention, and an instantaneous speed at which a user viewpoint switches, then, a user switching speed at which viewpoint switching is to be performed next time is predicted based on the instantaneous speed at which the user viewpoint switches, a quantity of predictive viewpoint videos that need to be downloaded is predicted based on the user switching speed, thereby, a location of a viewpoint video attention is currently paid is used as a reference point, viewpoint videos of the quantity of the predictive viewpoint videos in a direction determined according to the user switching speed are used as predictive viewpoint videos, and a location of each predictive viewpoint video is obtained, and each viewpoint video corresponding to the obtained location of each predictive viewpoint video is downloaded from a server end and transmitted. Therefore, when the user pays attention to a current viewpoint video, a viewpoint video neighboring to the current viewpoint video, that is, a predictive viewpoint video, is downloaded from the server end and transmitted. When the user performs switching next time, the predictive viewpoint video may be used as a viewpoint video attention is paid. This can avoid a time delay caused during switching of an angle of view. Moreover, not all viewpoint videos need to be transmitted, and therefore a waste of bandwidths is reduced.

### BRIEF DESCRIPTION OF DRAWINGS

FIG. 1A is a schematic distribution diagram of a one-dimensional multi-view video according to an embodiment of the present disclosure;

FIG. 1B is a schematic distribution diagram of a two-dimensional multi-view video according to an embodiment of the present disclosure;

FIG. 2A is a schematic diagram of independent display of viewpoint videos according to an embodiment of the present disclosure;

FIG. 2B is a schematic diagram of fusion display of viewpoint videos according to an embodiment of the present disclosure;

FIG. 3 is a schematic diagram of a DASH-based free-viewpoint video transmission system according to an embodiment of the present disclosure;

FIG. 4 is a schematic diagram of an entire architecture of a multi-view video service according to an embodiment of the present disclosure;

FIG. 5 is a schematic diagram of video transcoding and slicing of a client according to an embodiment of the present disclosure;

FIG. 6 is a flowchart of a multi-view video transmission method according to an embodiment of the present disclosure;

FIG. 7A is a schematic diagram of rightward switching of a user according to an embodiment of the present disclosure;

FIG. 7B is a schematic diagram of leftward switching of a user according to an embodiment of the present disclosure;

FIG. 8 is a schematic location diagram of predictive viewpoint videos when a left side reaches a boundary of an angle of view according to an embodiment of the present disclosure;

FIG. 9 is a schematic diagram of grouping one-dimensional viewpoint videos during fusion display according to an embodiment of the present disclosure;

FIG. 10 is a schematic diagram of grouping one-dimensional viewpoint videos during independent display according to an embodiment of the present disclosure;

FIG. 11A is a schematic diagram of a single viewpoint video to which attention is paid in a two-dimensional application scenario according to an embodiment of the present disclosure;

FIG. 11B is a schematic diagram of horizontal fusion of two viewpoint videos to which attention is paid in a two-dimensional application scenario according to an embodiment of the present disclosure;

FIG. 11C is a schematic diagram of vertical fusion of two viewpoint videos to which attention is paid in a two-dimensional application scenario according to an embodiment of the present disclosure;

FIG. 11D is a schematic diagram of four viewpoint videos to which attention is paid in a two-dimensional application scenario according to an embodiment of the present disclosure;

FIG. 12A is a first schematic location diagram of predictive viewpoint videos in a two-dimensional application scenario according to an embodiment of the present disclosure;

FIG. 12B is a second schematic location diagram of predictive viewpoint videos in a two-dimensional application scenario according to an embodiment of the present disclosure;

FIG. 12C is a third schematic location diagram of predictive viewpoint videos in a two-dimensional application scenario according to an embodiment of the present disclosure;

FIG. 12D is a fourth schematic location diagram of predictive viewpoint videos in a two-dimensional application scenario according to an embodiment of the present disclosure;

FIG. 13 is a schematic location diagram of predictive viewpoint videos when a left side reaches a boundary of an angle of view in a two-dimensional application scenario according to an embodiment of the present disclosure;

FIG. 14 is a schematic diagram of grouping two-dimensional viewpoint videos during fusion display according to an embodiment of the present disclosure;

FIG. 15 is a schematic diagram of grouping two-dimensional viewpoint videos during independent display according to an embodiment of the present disclosure;

FIG. 16 is a schematic diagram of a multi-view video transmission apparatus according to an embodiment of the present disclosure;

FIG. 17 is a schematic diagram of another multi-view video transmission apparatus according to an embodiment of the present disclosure; and

FIG. 18 is a schematic diagram of still another multi-view video transmission apparatus according to an embodiment of the present disclosure.

### DESCRIPTION OF EMBODIMENTS

To make the objectives, technical solutions, and advantages of the present disclosure clearer, the following further describes the present disclosure in detail with reference to the accompanying drawings. The described embodiments are merely a part rather than all of the embodiments of the present disclosure. All other embodiments obtained by persons of ordinary skill in the art based on the embodiments of the present disclosure without creative efforts shall fall within the protection scope of the present disclosure.

The embodiments of the present disclosure provide a multi-view video transmission method and apparatus. The method and the apparatus are based on a same inventive concept. Because principles of the method and the apparatus for resolving a problem are similar, cross reference may be made between implementation of the apparatus and implementation of the method, and repetitions are not described.

The embodiments of the present disclosure are applied to a head-mounted device such as 3D stereoscopic glasses or a free-viewpoint navigation device.

A multi-view video is a group of video signals obtained by collecting a same scene using multiple collection devices having different viewpoints from different angles of view. A multi-view video in the embodiments of the present disclosure may be a one-dimensional viewpoint video or a two-dimensional viewpoint video.

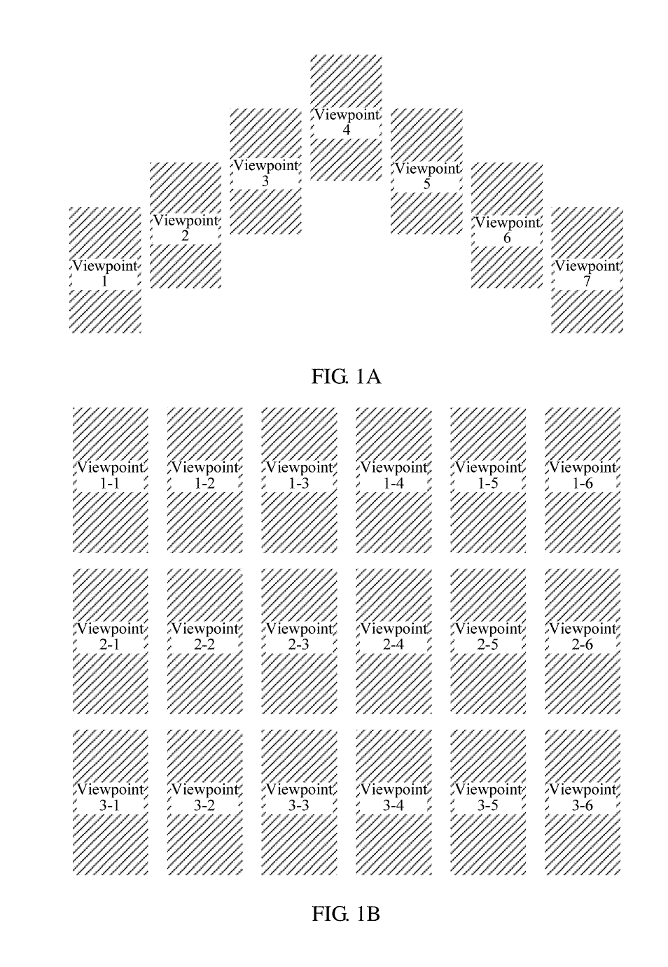

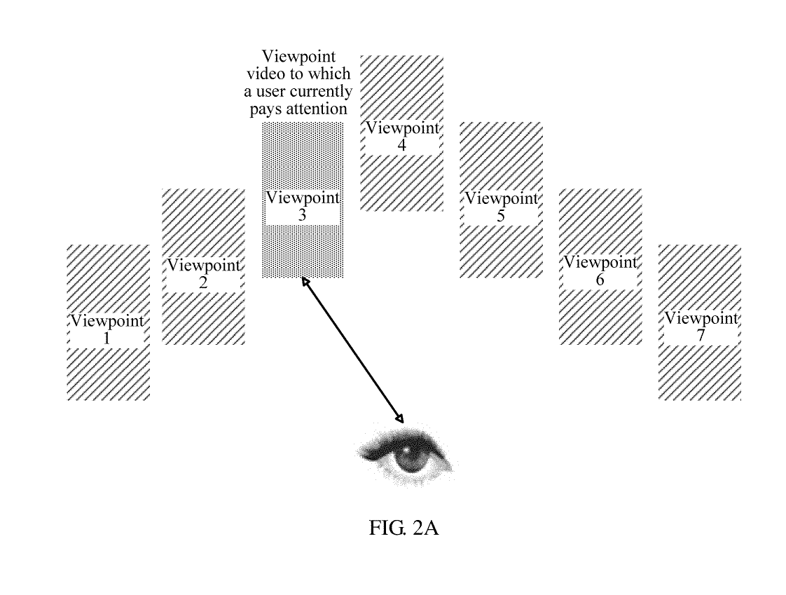

In a one-dimensional viewpoint video, shooting is performed using a parallel video camera array to obtain a series of video sequences having different angles of view in a single dimension, for example, in a horizontal direction or vertical direction. As shown in FIG. 1A, these viewpoint videos may be on a horizontal or vertical straight line, or may have a radian in a dimension, for example, a circular ring. For a two-dimensional multi-view video, a series of video sequences having different angles of view are obtained separately at horizontal and vertical dimensions using a two-dimensional video camera array, or a video having an extra-large resolution may be shot using a wide-angle camera, and then block partitioning processing is performed in both horizontal and vertical dimensions, where each sub-block may also be used as an independent viewpoint, as shown in FIG. 1B. Viewpoint videos corresponding to each dimension such as a row or a column in FIG. 1B may be arranged in a straight line, or may have a radian, for example, a two-dimensional plane, being arranged in a straight line in both horizontal and vertical directions, or a cylinder, having a radian in a horizontal or vertical direction, or a sphere, having a radian in both horizontal and vertical directions. A viewpoint switching independent display policy and a viewpoint switching fusion display policy are described in detail below.

In the viewpoint switching independent display policy, a discrete viewpoint video is presented to a user, that is, when a user viewpoint changes, only a viewpoint video in a multi-view video sequence is presented to the user. However, in the viewpoint switching fusion display policy, a continuous viewpoint video is presented to a user, that is, when a user viewpoint changes, a viewpoint video in a multi-view video sequence or a new viewpoint video generated after fusion processing is performed on neighboring viewpoint videos may be presented to the user.

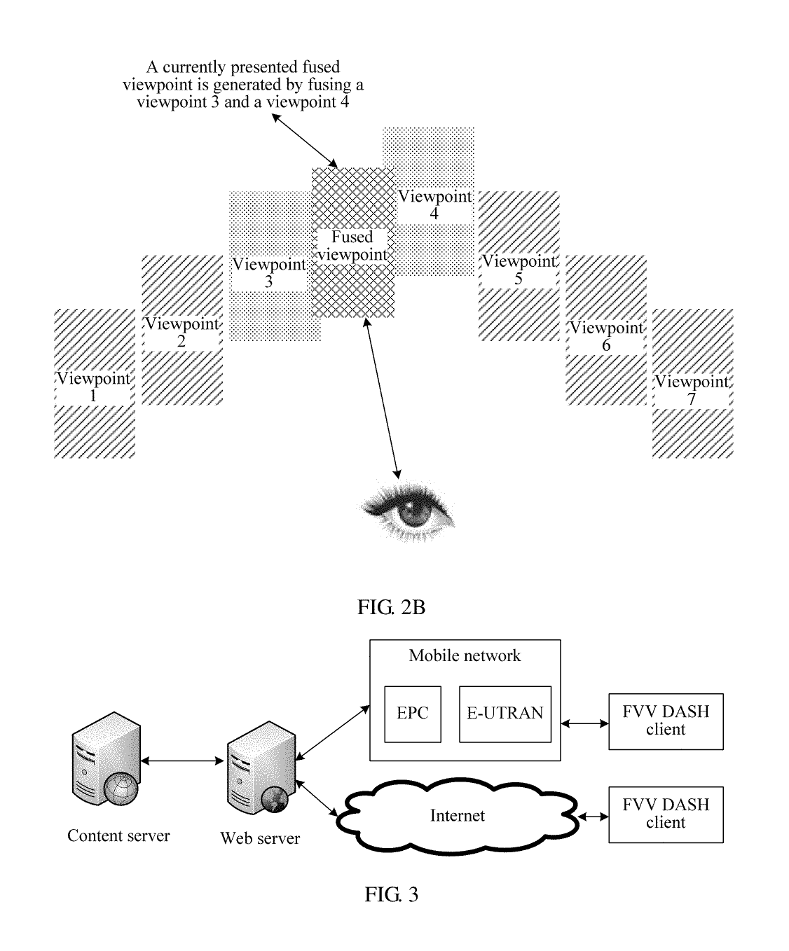

A largest difference between the viewpoint switching independent display policy and the viewpoint switching fusion display policy lies in that, in the viewpoint switching independent display policy, no new viewpoint video is generated. For example, in a one-dimensional viewpoint video, when a user viewpoint is between two viewpoint videos, a neighboring viewpoint video is selected and displayed, as shown in FIG. 2A. However, for the viewpoint switching fusion display policy, fusion processing may be performed on two neighboring viewpoint videos, a new viewpoint video is generated by means of viewpoint fusion and presented to a user, and seamless scene switching can be provided to the user. A typical application scenario is a free-viewpoint video service, as shown in FIG. 2B. In the embodiments of the present disclosure, for ease of description, multi-view videos are divided into three types, a viewpoint video to which attention is currently paid, a predictive viewpoint video, and a marginal viewpoint video. A viewpoint video to which attention is currently paid is a video that needs to be presented to a user, and for a one-dimensional application scenario, may be a single viewpoint video, or may be a viewpoint video obtained by fusing two neighboring viewpoint videos, as shown in FIG. 2A and FIG. 2B, or for a two-dimensional application scenario, may be a single viewpoint video, may be a viewpoint video obtained by fusing two neighboring viewpoint videos, or may be a viewpoint video obtained by fusing four neighboring viewpoint videos. A predictive viewpoint video is a viewpoint video that is predicted and may need to be presented to a user in future, and a viewpoint video whose probability of becoming a next viewpoint video attention is to be paid satisfies a preset probability value. Marginal viewpoint videos are all other viewpoint videos in a multi-view video than a viewpoint video to which attention is currently paid and a predictive viewpoint video, as shown in FIG. 2A and FIG. 2B.

Referring to FIG. 3, FIG. 3 shows a DASH-based free-viewpoint video transmission system according to an embodiment of the present disclosure. The system includes a free-viewpoint (FVV) client and servers, for example, a web server and a content server. A user stores each viewpoint video in the content server. The free-viewpoint client and the web server communicate with each other using the Internet or a mobile network. The client may be a head-mounted device such as 3D stereoscopic glasses or a free-viewpoint navigation device.

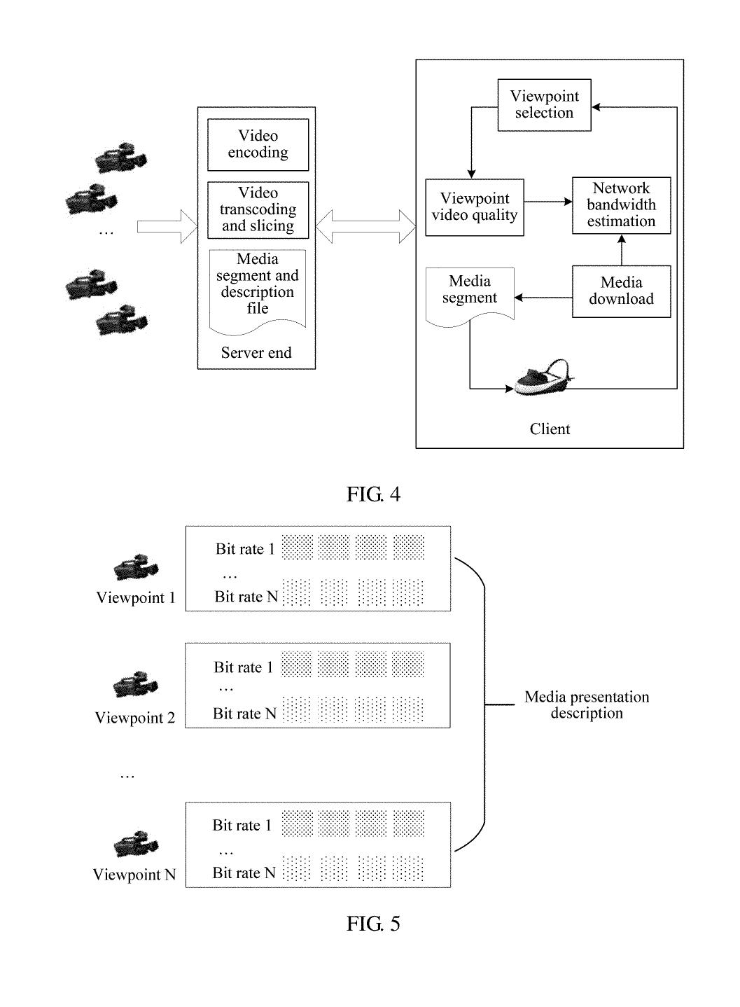

Referring to FIG. 4, FIG. 4 shows an entire architecture of a multi-view video service according to an embodiment of the present disclosure. At a server end, different viewpoint video streams are collected using an array of video cameras. These video cameras are arranged in a row in a horizontal direction or arranged to have a radian, and the multiple collected viewpoint video streams are an initial source of a video source. Then, using a video transcoding technology, the multiple collected viewpoint video streams are transcoded into different bit rate versions, and the different bit rate versions occupy different bandwidths during transmission. Each quality version of each viewpoint video stream is further split into video segments that have same duration, and finally these video segments after switching are organized and described using a media presentation description (MPD). Information about the organization and the description includes information such as an encoding manner, segment duration, a uniform resource locator (URL) address, a frame rate, a resolution, and a video bit rate. All video segments and MPD files are stored in the server end, as shown in FIG. 5. At a client, a user first downloads an MPD file and parses the MPD file to obtain server-end information. Then, an appropriate video segment is selected according to a bandwidth network status, a user gesture, and the like and downloaded. A DASH standard is used for an entire transmission process and a video organization manner of the server end.

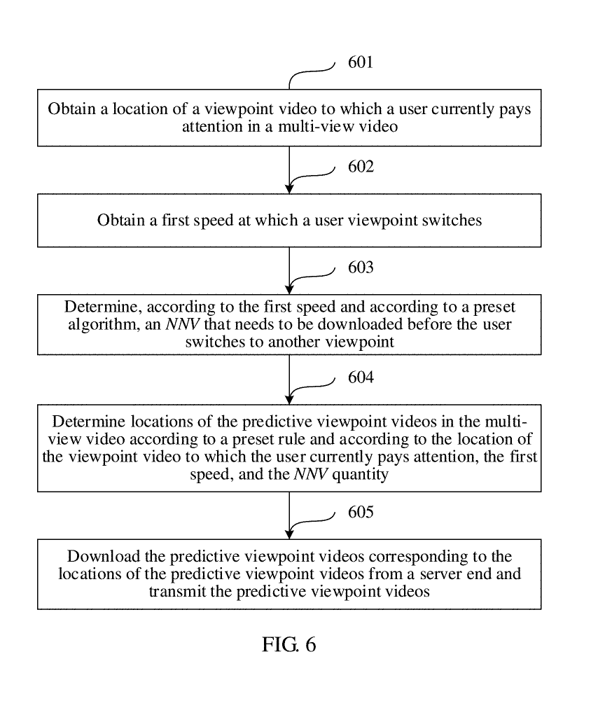

An embodiment of the present disclosure provides a multi-view video transmission method. As shown in FIG. 6, the method includes the following steps.

Step 601: Obtain a location of a viewpoint video to which a user currently pays attention in a multi-view video.

Information about a viewpoint video to which a user currently pays attention is obtained, where the information about the viewpoint video to which the user currently pays attention includes a location of the viewpoint video to which the user currently pays attention, and instantaneous speeds at which a user viewpoint switches. The instantaneous speeds at which the user viewpoint switches include collected instantaneous speeds at multiple moments during user viewpoint switching.

Step 602: Obtain a first speed at which a user viewpoint switches.

The first speed is a speed at which the user viewpoint switches to the location of the viewpoint video to which attention is currently paid.

When the user performs viewpoint switching, switching is performed from one viewpoint to another viewpoint, and the two viewpoints of switching may be or may not be neighboring to each other. Therefore, the obtained first speed at which the user viewpoint switches is obtained according to an instantaneous speed of the user during switching in a predetermined period of time before the user switches to the location of the viewpoint video to which attention is currently paid. The predetermined period of time may be a period of time in which switching to the location of the viewpoint video to which attention is currently paid is performed once, or may be a period of time in which switching to the location of the viewpoint video to which attention is currently paid is performed N times.

Optionally, the obtaining a first speed at which a user viewpoint switches may be implemented in the following manners but not merely limited to being implemented in the following manners.

First implementation: In a predetermined period of time before the user viewpoint switches to the location of the viewpoint video to which attention is currently paid, when instantaneous speeds of the user at multiple moments are collected, an average value of the instantaneous speeds at the multiple moments is calculated, and the average value is used as the first speed.

Second implementation: In a predetermined period of time before the user viewpoint switches to the location of the viewpoint video to which attention is currently paid, an instantaneous speed of the user at a moment is collected, and the instantaneous speed at the moment is used as the first speed.

Third implementation: In a predetermined period of time before the user viewpoint switches to the location of the viewpoint video to which attention is currently paid, instantaneous speeds of the user at multiple moments are collected, and an instantaneous speed may be selected from the instantaneous speeds at the multiple moments and used as the first speed.

One of instantaneous speeds at multiple moments collected when the user performs viewpoint switching is randomly selected, or instantaneous speeds at multiple moments may be sorted per magnitude, and an instantaneous speed located in the middle is selected. For example, five instantaneous speeds are included, and an instantaneous speed ranked the third after sorting is selected as a user switching speed. Alternatively, a largest instantaneous speed may be selected, and so on.

Optionally, a first acceleration at which a user viewpoint switches is obtained, where the first acceleration is an acceleration at which the user viewpoint switches to the location of the viewpoint video to which attention is currently paid. Therefore, the first speed at which the user viewpoint switches may be further obtained in the following manner.

Fourth implementation: In a predetermined period of time before the user viewpoint switches to the location of the viewpoint video to which attention is currently paid, an instantaneous speed of the user at a moment and an acceleration corresponding to the instantaneous speed at the moment are collected. Then, the first speed is determined according to a first rule and based on the instantaneous speed at the moment and the acceleration corresponding to the instantaneous speed at the moment.

Optionally, the first rule satisfies a condition of the following formula:

V=v(t)+1/2Ta(t),

where V represents the first speed, v(t) represents a collected instantaneous speed of the user at a moment t, T represents duration of each viewpoint video, and a(t) represents a viewpoint switching acceleration at the moment t.

Fifth implementation: In a predetermined period of time before the user viewpoint switches to the location of the viewpoint video to which attention is currently paid, when instantaneous speeds of the user at multiple moments and an acceleration corresponding to an instantaneous speed at each moment are collected, an average value of the instantaneous speeds at the multiple moments, and an average value of the multiple accelerations corresponding to the instantaneous speeds at the multiple moments are calculated, and the first speed is determined according to a second rule and based on the average value of the instantaneous speeds at the multiple moments and the average value of the multiple accelerations.

Optionally, the second rule satisfies a condition of the following formula:

$$V = \frac{1}{n} \sum v ( t ) + \frac{1}{2 n} T \sum a ( t ) ,$$

where n represents a quantity of instantaneous speeds at multiple moments.

Sixth implementation: In a predetermined period of time before the user viewpoint switches to the location of the viewpoint video to which attention is currently paid, instantaneous speeds of the user at multiple moments and an acceleration corresponding to an instantaneous speed at each moment are collected. Then, an average value of the instantaneous speeds at the multiple moments is calculated, an acceleration corresponding to an instantaneous speed is selected from the accelerations corresponding to the instantaneous speeds at the multiple moments, and the first speed is determined according to a third rule and based on the average value of the instantaneous speeds at the multiple moments and the selected acceleration corresponding to the instantaneous speed.

Optionally, the third rule satisfies a condition of the following formula:

$$V = \frac{1}{n} \sum v ( t ) + \frac{1}{2} T \sum a ( t ) .$$

Step 603: Determine, according to the first speed and according to a preset algorithm, an NNV that needs to be downloaded before the user switches to another viewpoint.

Optionally, the preset algorithm satisfies a condition of the following formula:

$$NNV = N \frac{VT}{D} ,$$

where NNV represents the quantity of the predictive viewpoint videos, V represents the first speed, N represents a total quantity of viewpoint videos, D represents an angle covered by the N viewpoint videos, and T represents the duration of each viewpoint video.

For example, for a panorama image, the angle covered by the N viewpoint videos is 360 degrees.

Step 604: Determine locations of the predictive viewpoint videos in the multi-view video according to a preset rule and according to the location of the viewpoint video to which the user currently pays attention, the first speed, and the NNV.

The predictive viewpoint videos are viewpoint videos whose probability of becoming a next viewpoint video attention is to be paid satisfies a preset probability value.

Step 605: Download the predictive viewpoint videos corresponding to the locations of the predictive viewpoint videos from a server end and transmit the predictive viewpoint videos.

By means of the method provided in this embodiment of the present disclosure, a location of a viewpoint video to which a user currently pays attention in a multi-view video is obtained, a first speed at which a user viewpoint switches is obtained, where the first speed is a speed at which the user viewpoint switches to the location of the viewpoint video to which attention is currently paid, an NNV that needs to be downloaded before the user switches to another viewpoint is determined according to the first speed and according to a preset algorithm, locations of the predictive viewpoint videos are determined in the multi-view video according to a preset rule and according to the location of the viewpoint video to which the user currently pays attention, the first speed, and the NNV, where the predictive viewpoint videos are viewpoint videos whose probability of becoming a next viewpoint video attention is to be paid satisfies a preset probability value, and the predictive viewpoint videos corresponding to the locations of the predictive viewpoint videos are downloaded from a server end and transmitted. Therefore, when the user pays attention to a current viewpoint video, a viewpoint video neighboring to the current viewpoint video, that is, a predictive viewpoint video, is downloaded from the server end and transmitted. When the user performs switching next time, the predictive viewpoint video may be used as a viewpoint video attention is paid. This can avoid a time delay caused during switching of an angle of view. Moreover, not all viewpoint videos need to be transmitted, and therefore a waste of bandwidths is reduced.

A one-dimensional multi-view video is used as an example below to perform description.

A1: Quantity of viewpoint videos.

(1) A quantity of fused viewpoint videos (also referred to as NCV).

Fused viewpoint videos are viewpoint videos that are fused to obtain a current viewpoint video.

A viewpoint video to which the user currently pays attention is video content that needs to be presented to the user. A location of an angle of view to which the user currently pays attention may be determined according to a location of an eye ball of the user, a user gesture, and the like. Further, an area to which the user currently pays attention may be estimated using information such as a current coordinate location of the user, a head declination, and a location of a distance to a video. A method for determining a viewpoint video to which a user currently pays attention is not limited in the present disclosure, and methods for determining a viewpoint video to which a user currently pays attention in the other approaches are all applicable to the present disclosure.

If a location of an angle of view to which a user currently pays attention is in the middle of a viewpoint video, the viewpoint video is a viewpoint video the user uniquely pays attention, that is, a quantity of viewpoint videos to which the user currently pays attention is one. If a location of an angle of view to which the user currently pays attention is not in the middle of a location of a viewpoint video, two viewpoint videos that are closest to the location of the angle of view of the user are fused, and then a viewpoint video obtained after fusion is used as a viewpoint video to which the user currently pays attention. In the present disclosure, viewpoint videos that are fused to obtain the viewpoint video to which the user currently pays attention are referred to as fused viewpoint videos. Therefore, the quantity of fused viewpoint videos may be one, that is, fusion is not needed, or the quantity of fused viewpoint videos may be two.

For a multi-view video service, viewpoints are independent of each other. When presentation is performed at a client, even if a viewpoint video the user pays attention is located in the middle of two viewpoint videos, fusion processing does not need to be performed, and the quantity of fused viewpoint videos is one.

(2) A quantity of predictive viewpoint videos is represented using NNV derived from Number of Near Views, that is, NNV viewpoint videos neighboring to a viewpoint video to which the user currently pays attention. The predictive viewpoint videos may be used in future as viewpoint videos to which attention is paid and presented to the user. The predictive viewpoint videos need to be transmitted. Therefore, during next user switching, attention may be paid to one or two viewpoint videos of the predictive viewpoint videos in order to reduce a viewpoint switching delay.

Further, a first speed at which a user viewpoint switches is first obtained, and then the NNV that needs to be downloaded before the user switches to another viewpoint may be determined according to the first speed and according to a preset algorithm. For a method for obtaining the first speed, refer to any one of the first to the sixth implementations described above.

In this embodiment of the present disclosure, an average speed based on a time sliding window may be further used as the first speed V, that is, an average speed in a period of past time is used as the first speed V:

$$V = \frac{1}{T} {\int }_{t - T}^{t} v ( τ ) d τ ,$$

where T is duration of each video segment obtained by performing video slicing at a server end, that is, is used as duration of each viewpoint video.

The NNV that needs to be downloaded before the user switches to another viewpoint is determined based on the first speed and according to the preset algorithm. The preset algorithm may satisfy a condition of the following formula:

$$NNV = N \frac{VT}{D} ,$$

where NNV represents the quantity of the predictive viewpoint videos, V represents the first speed, N represents a total quantity of viewpoint videos, D represents an angle covered by the N viewpoint videos, that is, an angle covered by the N viewpoint videos, for example, coverage of a panorama image is 360 degrees (°), and T represents the duration of each viewpoint video.

(3) A quantity of marginal viewpoint videos (also referred to as NMV)

All viewpoint videos other than the viewpoint video to which the user currently pays attention and the predictive viewpoint videos are marginal viewpoint videos. Therefore, the quantity of the marginal viewpoint videos is:

NMV=N−NCV−NNV.

A probability of converting marginal viewpoint videos into viewpoint videos to which attention is paid is relatively small, that is, a probability of presenting the marginal viewpoint videos to the user in a recent period of time is relatively small. Therefore, the marginal viewpoint videos may be not transmitted, thereby saving a transmission bandwidth.

A2: Determine a location of a viewpoint video.

(1) Location of a viewpoint video to which the user currently pays attention.

The location of the viewpoint video to which the user currently pays attention in a multi-view video is obtained. Further, a location of an angle of view to which the user currently pays attention may be determined according to a location of an eye ball of the user, a user gesture, and the like. This is not further limited in the present disclosure.

(2) Locations of the predictive viewpoint videos.

The locations of the predictive viewpoint videos in the multi-view video are determined according to a preset rule and according to the location of the viewpoint video to which the user currently pays attention, the first speed, and the NNV.

Further, the determining may be implemented in the following manner.

When the first speed is less than a predetermined speed threshold, and the NNV is an even number,

$$\frac{NNV}{2}$$

viewpoint videos are allocated at each of two sides neighboring to the location of the viewpoint video to which attention is currently paid, and the NNV viewpoint videos allocated at the two sides neighboring to the location of the viewpoint video to which attention is currently paid are used as predictive viewpoint videos.

When the first speed is less than the predetermined speed threshold, and the NNV is an odd number,

$$\frac{NNV + 1}{2}$$

viewpoint videos neighboring to a first direction side of the viewpoint video to which attention is currently paid, and

$$\frac{NNV - 1}{2}$$

viewpoint videos neighboring to a second direction side of the viewpoint video to which attention is currently paid are used as predictive viewpoint videos, where the first direction side is the same as a vector direction of the first speed, and the second direction side is opposite to the vector direction of the first speed.

When the first speed is less than the predetermined speed threshold, and the NNV is an odd number,

$$\frac{NNV - 1}{2}$$

viewpoint videos neighboring to the first direction side of the location of the viewpoint video to which attention is currently paid, and

$$\frac{NNV + 1}{2}$$

viewpoint videos neighboring to the second direction side of the location of the viewpoint video to which attention is currently paid are used as predictive viewpoint videos.

That is, when V<V₀, it indicates that user switching is slow, and it may be considered that a future switching direction of the user has a relatively large uncertainty. V₀ represents the predetermined speed threshold.

When the user switching speed is not less than the predetermined speed threshold, NNV viewpoint videos neighboring to the first direction side of the viewpoint video to which attention is currently paid are used as predictive viewpoint videos.

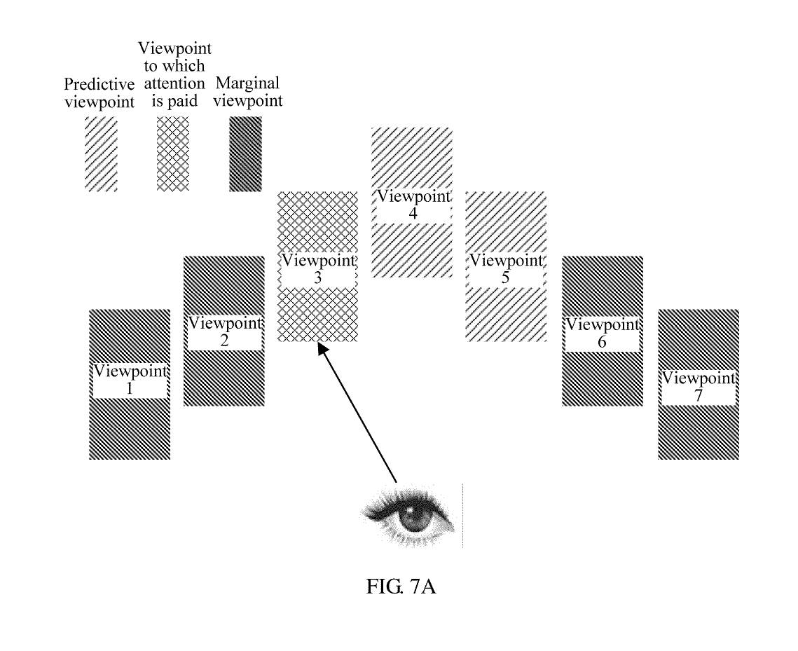

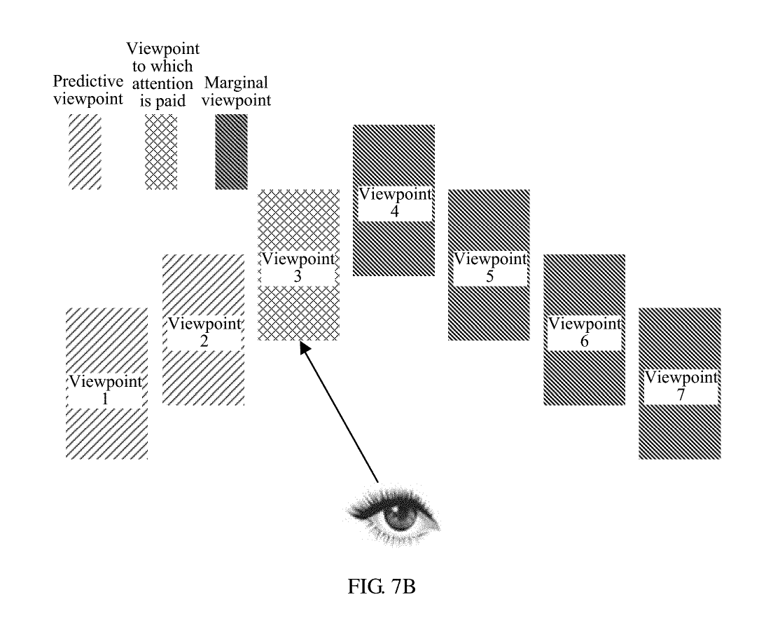

When the first speed V is not less than the predetermined speed threshold V₀, that is, when V≥V₀, it is considered that a future switching direction of the user has a relatively large certainty. Therefore, allocation of predictive viewpoint videos needs to consider a predicted direction of the first speed V, and NNV viewpoint videos at a user switching speed direction side of the viewpoint video to which attention is currently paid are used as predictive viewpoint videos, as shown in FIG. 7A and FIG. 7B.

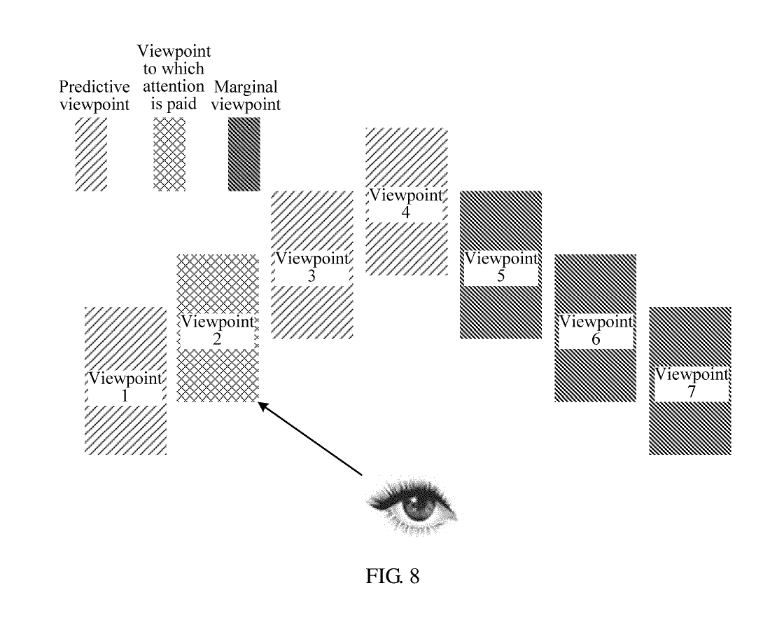

It should be noted that, when a quantity of viewpoint videos at a side of a location neighboring to the viewpoint video to which attention is currently paid is less than a quantity of allocated viewpoint videos, the quantity of all the viewpoint videos at the side of the location neighboring to the viewpoint video to which attention is currently paid is used as the quantity of the allocated viewpoint videos. Further, for allocation of a quantity of predictive viewpoint videos, when the viewpoint video to which attention is currently paid reaches a viewpoint boundary, allocation is stopped. For example, if V<V₀, when NNV=4 , respective two viewpoints at two sides of the viewpoint video to which attention is currently paid are theoretically all predictive viewpoint videos. Assuming that there is only one viewpoint at a left side of the viewpoint video to which attention is currently paid, and there are three viewpoints at a right side, one viewpoint video (reaching a viewpoint boundary) at the left side of the viewpoint video to which attention is currently paid, and two viewpoint videos at the right side are finally selected as predictive viewpoint videos, as shown in FIG. 8.

A3: Determine quality of a viewpoint video.

Each viewpoint video includes multiple bit rate versions, and each bit rate version requires a different bandwidth.

Each viewpoint video corresponding to the obtained location of each predictive viewpoint video may be downloaded from a server end and transmitted in the following manner.

(1) A bit rate version of the viewpoint video to which attention is currently paid and bit rate versions of the predictive viewpoint videos are determined according to a total bandwidth value allocated for viewpoint video transmission, and a preset bandwidth allocation policy.

Further, the preset bandwidth allocation policy includes determining, based on a delay and quality priority, a viewpoint type priority, and a predictive viewpoint video location priority and using the total bandwidth value allocated for viewpoint video transmission, the transmitted bit rate version of the viewpoint video to which attention is currently paid and the transmitted bit rate versions of the predictive viewpoint videos. Herein, the determining is preferably based on the delay and quality priority, then based on the viewpoint type priority, and then based on the predictive viewpoint video location priority. The transmitted bit rate version of the viewpoint video to which attention is currently paid and the transmitted bit rate versions of the predictive viewpoint videos are determined.

The delay and quality priority is used to ensure that lowest bit rate versions of the viewpoint video to which attention is currently paid and the predictive viewpoint videos are transmitted. The viewpoint type priority includes a priority of the viewpoint video to which attention is currently paid is higher than priorities of the predictive viewpoint videos, and therefore a bandwidth is preferably allocated to the viewpoint video to which attention is currently paid. The predictive viewpoint video location priority includes an ascending order of distances between locations of all of the predictive viewpoint videos and the location of the viewpoint video to which attention is currently paid is equal to a descending order of priorities of all of the predictive viewpoint videos, and therefore a bandwidth is preferably allocated to a viewpoint video whose predictive viewpoint video location priority is high.

The delay and quality priority is used to ensure that lowest bit rate versions of the viewpoint video to which attention is currently paid and the predictive viewpoint videos are transmitted because the viewpoint video to which the user currently pays attention and the predictive viewpoint videos are transmitted, a probability that the predictive viewpoint videos is used in future as viewpoint videos to which attention is paid is relatively large, and transmission of the predictive viewpoint videos may reduce a viewpoint switching delay. Therefore, bandwidths are allocated to the viewpoint video to which attention is currently paid and the predictive viewpoint videos, it is preferably ensured that all lowest bit rate versions of the viewpoint video to which attention is currently paid and the predictive viewpoint videos may be transmitted. If the bandwidths are sufficiently large, the bit rate version of the viewpoint video to which attention is currently paid may be improved, thereby improving viewpoint video transmission quality.

The viewpoint type priority is that when bandwidth resource allocation is performed, according to viewpoint types, a bandwidth is preferably allocated to the viewpoint video to which attention is currently paid, and then bandwidths are allocated to the predictive viewpoint videos.

The predictive viewpoint video location priority is for a predictive viewpoint video, and when a bandwidth resource is allocated to the predictive viewpoint video, the bandwidth resource is preferably allocated to a viewpoint video relatively close to the viewpoint video to which attention is currently paid.

(2) The predictive viewpoint videos are downloaded from the server end according to the locations of the predictive viewpoint videos and the bit rate versions of the predictive viewpoint videos, and the viewpoint video to which attention is currently paid is downloaded from the server end according to the location of the viewpoint video to which attention is currently paid, and the bit rate version of the viewpoint video to which attention is currently paid.

Before switching to the viewpoint video to which attention is currently paid is performed, a bandwidth may be already allocated to the viewpoint video to which the user currently pays attention, and the viewpoint video already begins to be transmitted, and may be already transmitted completely.

Therefore, if the viewpoint video to which the user currently pays attention is completely transmitted, the bit rate version of the completely transmitted viewpoint video to which attention is currently paid is determined. Determining, according to a total bandwidth value allocated for viewpoint video transmission, and a preset bandwidth allocation policy, a bit rate version of the viewpoint video to which attention is currently paid and bit rate versions of the predictive viewpoint videos is implemented in the following manner.

A bandwidth value is sequentially allocated, based on an ascending order of distances between the predictive viewpoint videos and the viewpoint video to which attention is currently paid, for a lowest bit rate for transmitting each viewpoint video of the predictive viewpoint videos, and the bit rate version of the viewpoint video to which attention is currently paid is raised based on a difference between the total bandwidth value and the bandwidth value that is allocated for the lowest bit rate for transmitting the predictive viewpoint videos, until the bit rate version of the viewpoint video to which attention is currently paid is the highest or the total bandwidth value is exhausted in order to determine the bit rate version of the viewpoint video to which attention is currently paid and the bit rate versions of the predictive viewpoint videos.

If the viewpoint video to which attention is currently paid is already transmitted but is not transmitted completely, a bandwidth is reallocated to the viewpoint video to which attention is currently paid and that is not transmitted completely. A first bandwidth value is allocated, based on the total bandwidth value, for a lowest bit rate version of the incompletely transmitted viewpoint video to which attention is currently paid, a second bandwidth value is sequentially allocated, based on a difference between the total bandwidth value and the first bandwidth value, and distances between the predictive viewpoint videos and the viewpoint video to which attention is currently paid, for a lowest bit rate for transmitting each viewpoint video of the predictive viewpoint videos, and the bit rate version of the viewpoint video to which attention is currently paid is raised based on the difference between the total bandwidth value and the first bandwidth value and a difference between the total bandwidth value and the second bandwidth value, until the bit rate version of the viewpoint video to which attention is currently paid is the highest or the total bandwidth value is exhausted in order to determine the bit rate version of the viewpoint video to which attention is currently paid and the bit rate versions of the predictive viewpoint videos.

When the bit rate version of the viewpoint video to which attention is currently paid is the highest and the total bandwidth value is not exhausted, a bit rate version of each viewpoint video of the predictive viewpoint videos is sequentially raised based on the ascending order of the distances between the predictive viewpoint videos and the viewpoint video to which attention is currently paid, until the bit rate version of each viewpoint video of the predictive viewpoint videos is the highest or the total bandwidth value is exhausted.

In this embodiment of the present disclosure, a bit rate version of each viewpoint video of the predictive viewpoint videos is sequentially raised based on the ascending order of the distances between the predictive viewpoint videos and the viewpoint video to which attention is currently paid, and a bit rate version may be preferably raised for a predictive viewpoint video closest to the viewpoint video to which attention is currently paid, until the bit rate version is the highest or the bandwidth is exhausted. If the bit rate version is the highest and the bandwidth is not exhausted, a bandwidth is allocated to a viewpoint video neighboring to the predictive viewpoint video closest to the viewpoint video to which attention is currently paid, and the rest can be deduced by analogy. Alternatively, bit rate versions may be separately and sequentially raised by one level based on the ascending order of the distances between the predictive viewpoint videos and the viewpoint video to which attention is currently paid. If the bandwidth is not exhausted, the bit rate versions are sequentially raised again by one level based on the ascending order of the distances between the predictive viewpoint videos and the viewpoint video to which attention is currently paid.

Further, during bandwidth allocation, grouping processing may be further performed on viewpoint videos.

(a) Divide all viewpoint videos into three groups, that is, an H (for High Priority) group, an M (for Medium Priority) group, and an L (for Low Priority) group.

For a case in which viewpoint video fusion may be performed.

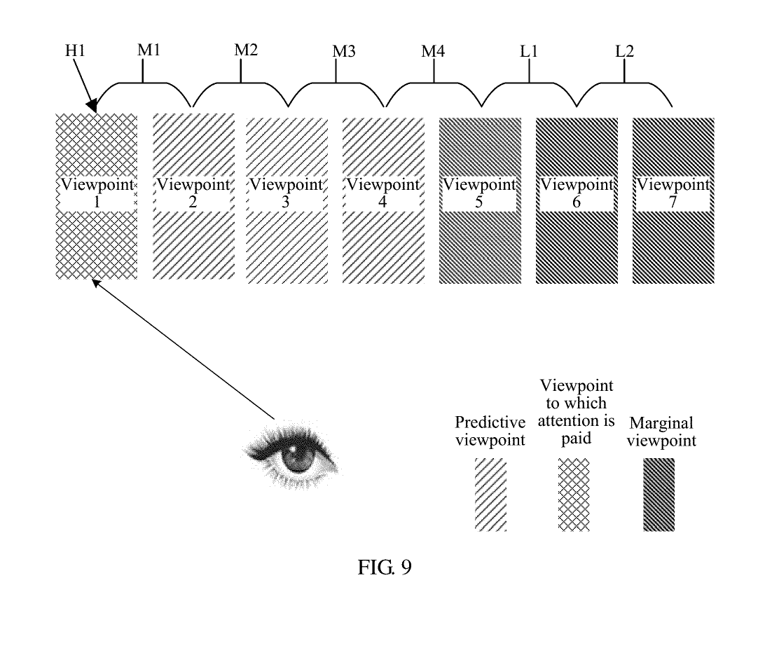

The H group represents a set of viewpoint videos to which attention is currently paid, and the set may include one viewpoint video, or may include two viewpoint videos. The M group includes one or more subgroups {M₁,M₂,L}, and each subgroup includes two viewpoint videos. It is considered that when a viewpoint video attention is currently paid switches to the middle between two viewpoints, viewpoint fusion needs to be performed on two neighboring viewpoint videos to generate a new viewpoint video. Therefore, the M group starts from a border between the viewpoint video to which attention is currently paid and a neighboring viewpoint video, and ends at a boundary between a predictive viewpoint video and a marginal viewpoint video or an available viewpoint boundary (reaches an available viewpoint margin), and subgroups overlap with each other. The L group includes one or more subgroups {L₁,L₂,L}, and each subgroup includes two viewpoint videos. It is considered that when a viewpoint video attention is currently paid switches to the middle between two viewpoints, viewpoint fusion needs to be performed on two neighboring viewpoint videos to generate a new viewpoint video. Therefore, the L group starts from a border between a predictive viewpoint video and a marginal viewpoint video, and ends at an available viewpoint boundary (reaches an available viewpoint margin), as shown in FIG. 9.

For a case in which no viewpoint video fusion needs to be performed.

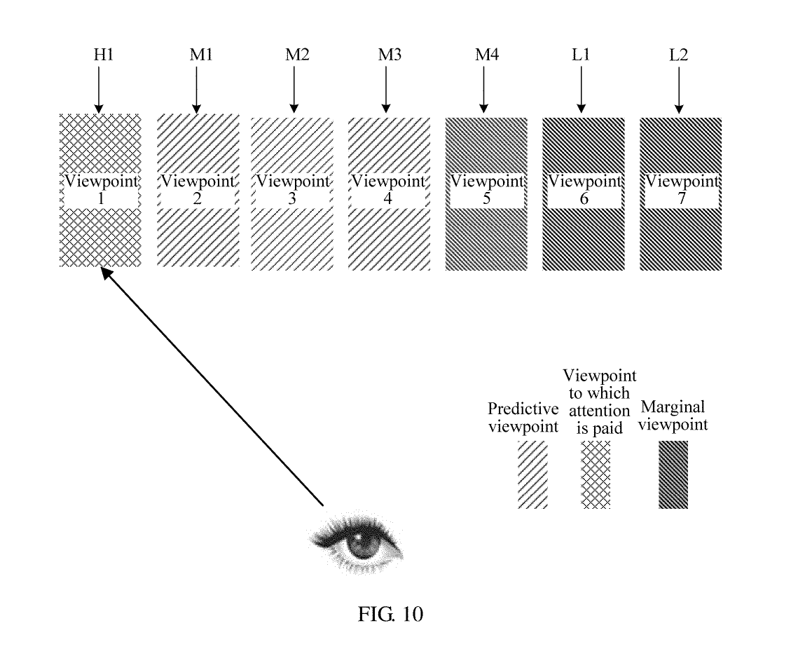

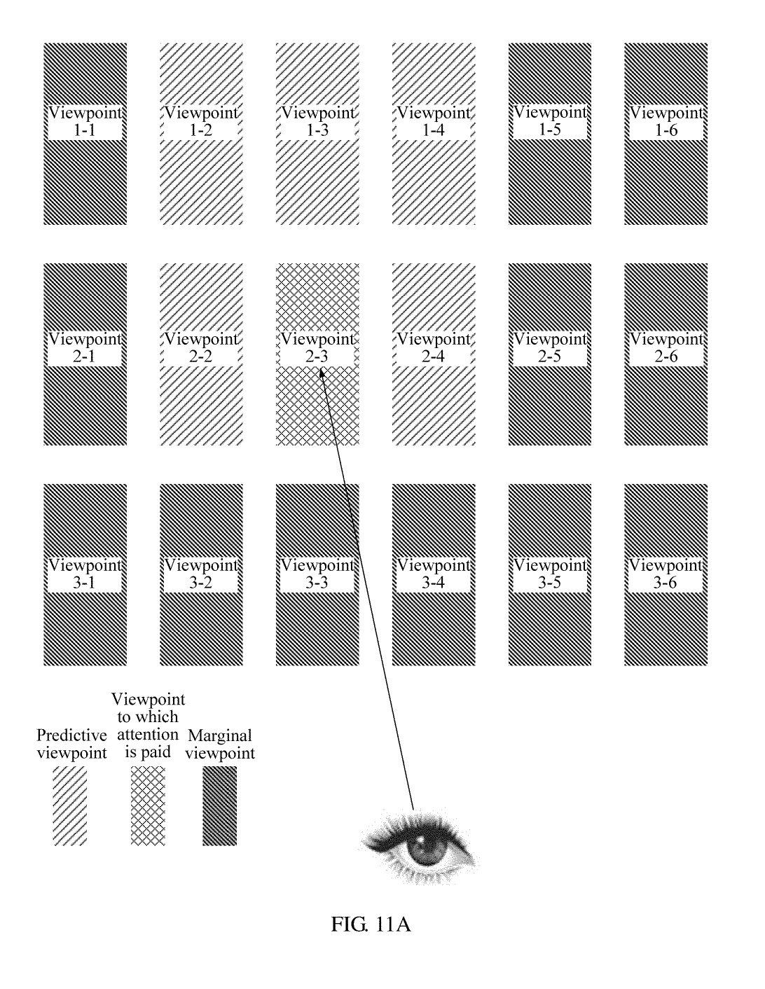

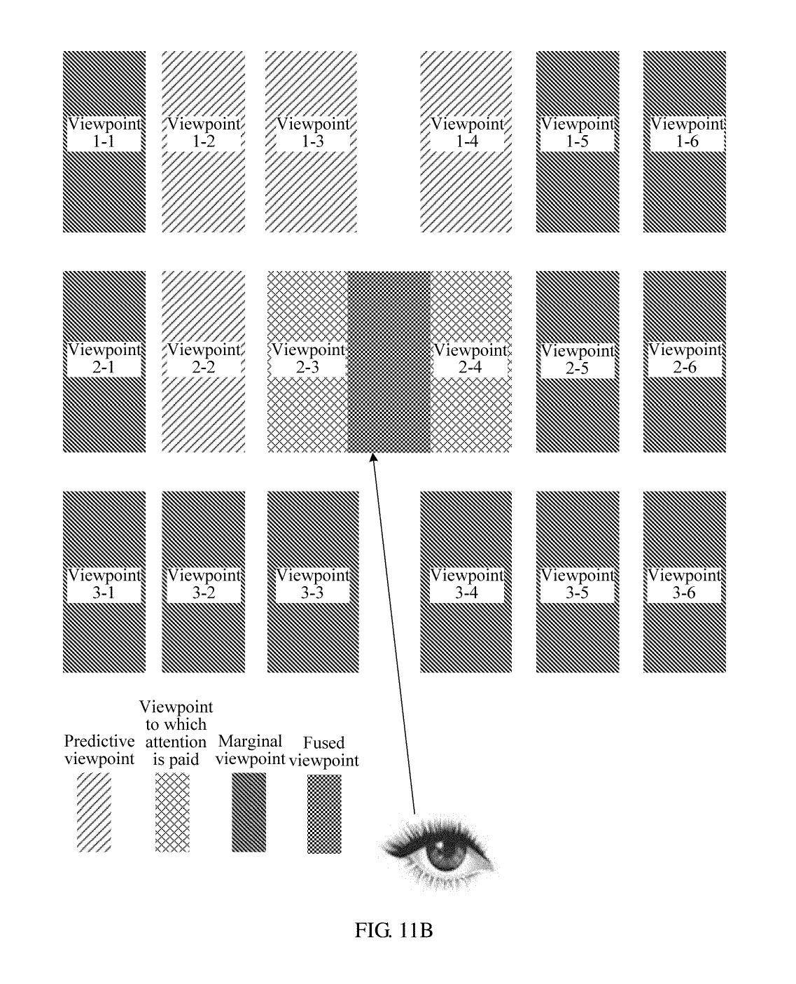

The H group represents a set of viewpoint videos to which attention is currently paid, and the set includes one viewpoint video. The M group includes one or more subgroups {M₁,M₂,L}, and each subgroup includes one viewpoint video. The M group starts from a border between the viewpoint video to which attention is currently paid and a neighboring viewpoint video, and ends at a boundary between a predictive viewpoint video and a marginal viewpoint video or an available viewpoint boundary, that is, reaches an available viewpoint margin. The L group includes one or more subgroups {L₁,L₂,L}, and each subgroup includes one viewpoint video. The L group starts from a border between a predictive viewpoint video and a marginal viewpoint video, and ends at an available viewpoint boundary, that is, reaches an available viewpoint margin, as shown in FIG. 10.

(b) Determine whether each viewpoint video in the H group is already transmitted, and determine whether each viewpoint video is transmitted completely. If each viewpoint video is transmitted completely, perform step (c), if each viewpoint video is not transmitted completely, perform step (d), or if each viewpoint video in the H group is not transmitted, perform step (e).

(c) Allocate bandwidth resources needed by lowest bit rates to subgroups in the M group based on an ascending order of distances to the H group. If the bandwidth is insufficient or the bandwidth is exhausted, perform the step (g). Otherwise, perform step (f).

One or more subgroups in the M group may be already transmitted in advance, or transmitted completely, and no bandwidth needs to be reallocated in this step.

(d) Allocate a bandwidth resource needed by a lowest bit rate version to a viewpoint video in the H group that is not transmitted completely. If the bandwidth is insufficient or the bandwidth is exhausted, perform step (g), otherwise, perform step (c).

(e) Allocate a bandwidth resource needed by a lowest bit rate version to a viewpoint video in the H group that is not transmitted. If the bandwidth is insufficient or the bandwidth is exhausted, perform step (g), otherwise, perform step (c).

(f) Raise a bit rate version of a viewpoint video in the H group level by level, and allocate a bandwidth resource needed by the raised bit rate version, until a maximum bit rate version is reached. If the bandwidth is insufficient or the bandwidth is exhausted, perform step (h), otherwise, perform step (g).

(g) For subgroups in the M group, sequentially and separately raise bit rate versions of viewpoint videos in the subgroups by one level according to the ascending order of the distances to the H group, and allocate bandwidth resources needed by the bit rate versions that are raised by one level. If the bandwidth is insufficient or the bandwidth is exhausted, perform step (h), otherwise, perform step (g) repetitively.

(h) Allocation ends.

After the foregoing bandwidth allocation is performed, bit rate versions of viewpoint videos in the H group and the M group can be determined.

It should be noted that when bandwidth resource allocation is performed, only intra-group update can be performed. For example, when a viewpoint belongs to two groups at the same time, if bit rates of the viewpoint video in the two groups are different, versions of two bit rates need to be reserved at the same time.

Assuming that groups are shown in FIG. 10, a total bandwidth is 11 megabits per second (Mbps), and each viewpoint video have three available bit rates that respectively need bandwidth values 1 Mbps, 2 Mbps, and 3 Mbps, an allocation process is as follows.

If a bandwidth (1 Mbps) needed by a bit rate of 1 Mbps is allocated to the H group, a remaining bandwidth is 10 Mbps, if a bandwidth needed by a bit rate of 1 Mbps is allocated sequentially to an M2 group, an M3 group, an M4 group, and an M5 group (bit rates of viewpoints 1, 2, 3, 4, and 5 are the same, and therefore only a version of 1 Mbps needs to be reserved), a remaining bandwidth is 6 Mbps, if a bit rate of the H group is raised level by level, until the bit rate reaches 3 Mbps (the viewpoint 1 belongs to both the H group and an M1 group, and therefore two bit rate versions of 1 Mbps and 3 Mbps of the viewpoint 1 need to be reserved), a remaining bandwidth is 3 Mbps, and if a bit rate of the M1 group is raised by one level, that is, raised from 1 Mbps to 2 Mbps (the bit rate of 1 Mbps of the viewpoint 1 is updated to 2 Mbps, a bandwidth of 1 Mbps is additionally consumed, and the viewpoint 2 belongs to both M1 and M2, therefore, two bit rate versions of 1 Mbps and 2 Mbps of the viewpoint 1 need to be reserved, and a bandwidth of 2 Mbps is additionally consumed), a remaining bandwidth is 0 Mbps, and the process quits.

A final bandwidth resource and quality result is a bandwidth of 5 Mbps is allocated to the viewpoint 1, and two quality versions of 2 Mbps and 3 Mbps are transmitted, a bandwidth of 3 Mbps is allocated to the viewpoint 2, and two quality versions of 1 Mbps and 2 Mbps are transmitted, a bandwidth of 1 Mbps is allocated to each of the viewpoint 3 to the viewpoint 5, and one quality version of 1 Mbps is transmitted, and no bandwidth resource is allocated to either a viewpoint 6 or a viewpoint 7, and no quality version is transmitted.

Each viewpoint video at the server end has multiple different bit rate versions, and all viewpoint videos need to be transmitted in the other approaches. Therefore, a bandwidth needs to be allocated to all the viewpoint videos, and an average allocation solution is usually used. Using the solution provided in this embodiment of the present disclosure, not all the viewpoint videos need to be transmitted, and therefore a bandwidth does not need to be allocated to all the viewpoint videos. Moreover, in this solution, a bandwidth is preferably allocated to a viewpoint video to which attention is currently paid, and transmission quality of the viewpoint video to which attention is currently paid is preferably considered based on a total bandwidth value. Therefore, a waste of bandwidths is reduced, and an instant experience of the user is improved.

A two-dimensional multi-view video is used as an example below to perform description.

In a multi-view video service, a type of common application is large-screen display. In an aspect, a series of video sequences having different angles of view may be obtained separately in horizontal and vertical dimensions using a two-dimensional video camera array, or a video having an extra-large resolution may be shot using a wide-angle camera, and then block partitioning processing is performed in horizontal and vertical dimensions, where each sub-block may also be used as an independent viewpoint, as shown in FIG. 1B. When presentation is performed at a client, an appropriate viewpoint video is selected according to an angle of view to which a user currently pays attention, and is partitioned and displayed, or fused and displayed.

B 1: Quantity of viewpoint videos.

The quantity of viewpoint videos includes three parts a quantity of viewpoint videos to which attention is currently paid, a quantity of predictive viewpoint videos, and a quantity of marginal viewpoint videos.

(1) Viewpoint video quantity NCV of viewpoint videos to which attention is currently paid and that are fused.

A viewpoint video to which attention is currently paid is video content that needs to be currently presented to the user. A location of an angle of view to which the user currently pays attention is determined according to a location of an eye ball of the user, a user gesture, and the like.

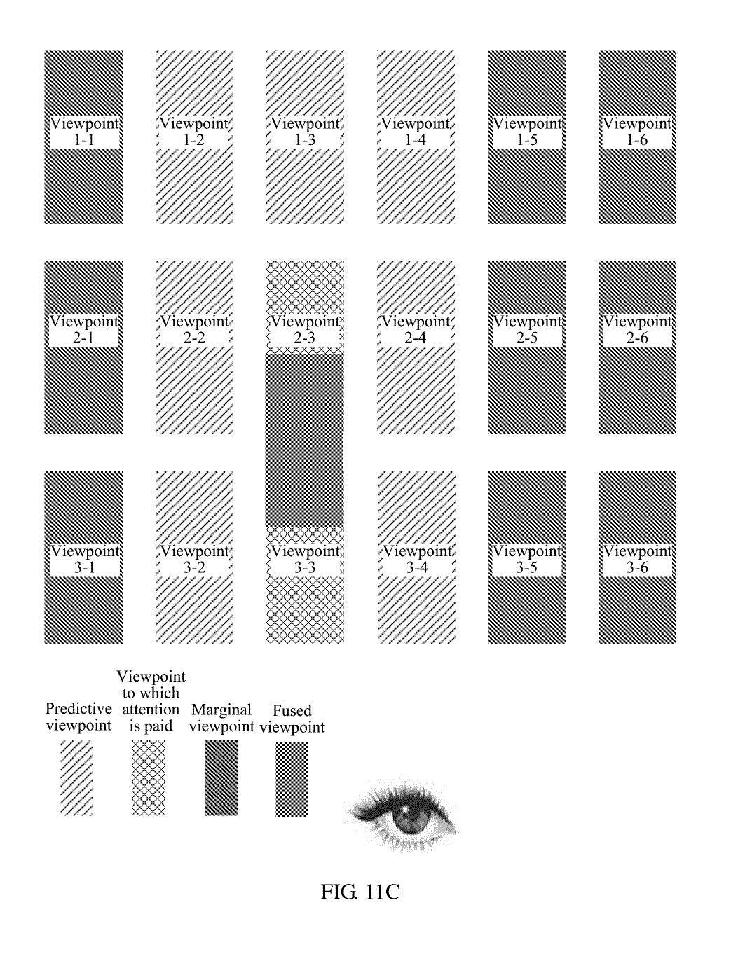

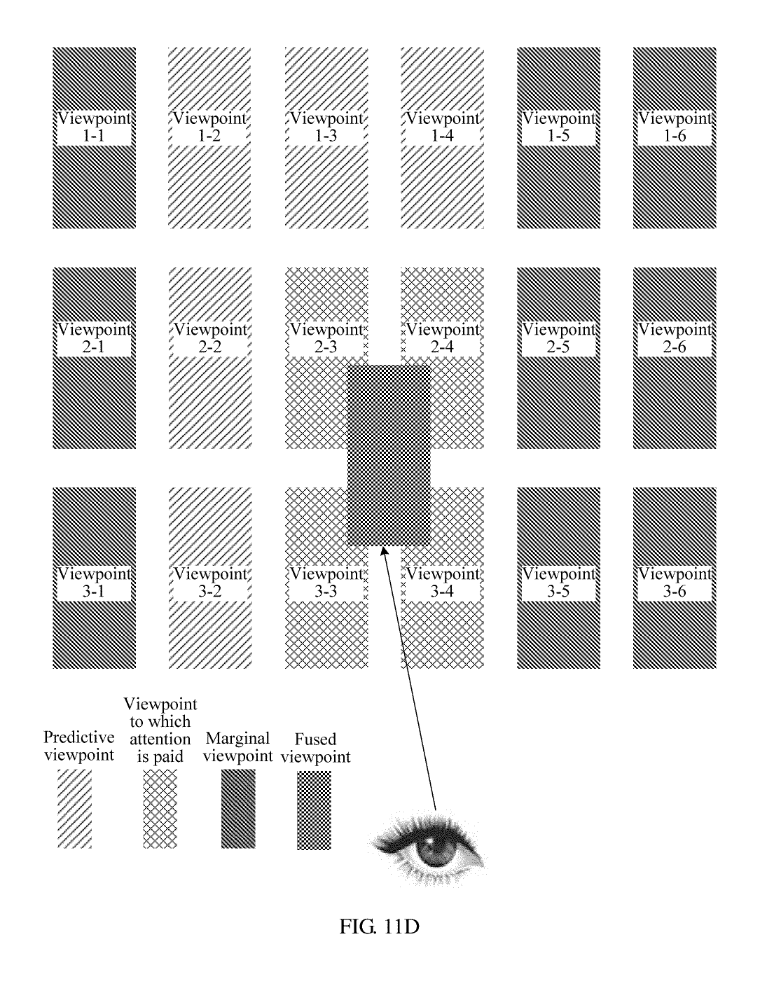

(i) If a location of an angle of view to which the user currently pays attention is in the middle of a viewpoint video, as shown in FIG. 11A, the viewpoint video is a viewpoint video attention is uniquely paid, and a quantity of viewpoint videos that are fused to obtain a viewpoint video to which attention is currently paid is one, that is, NCV=1.

(ii) If a location of an angle of view to which the user currently pays attention is in the middle of a vertical location of a viewpoint video, but is not in the middle of a horizontal location, as shown in FIG. 11B, or if a location of an angle of view to which the user currently pays attention is in the middle of a horizontal location of a viewpoint video, but is not in the middle of a vertical location, as shown in FIG. 11C, and two neighboring viewpoint videos are fused to obtain a viewpoint video to which attention is currently paid, a quantity of viewpoint videos that are fused to obtain the viewpoint video to which attention is currently paid is two, that is, NCV=2 .

(iii) If a location of an angle of view to which the user currently pays attention is neither in the middle of a horizontal location of a viewpoint video nor in the middle of a vertical location, as shown in FIG. 11D, and four neighboring viewpoint videos are fused to obtain a viewpoint video to which attention is currently paid, a quantity of viewpoint videos that are fused to obtain the viewpoint video to which attention is currently paid is four, that is, NCV=4 .

In a two-dimensional multi-view video service, viewpoints are independent of each other sometimes. When presentation is performed at a client, even if an angle of view to which the user pays attention is not in the middle of a viewpoint video, fusion processing is not required. Therefore, a quantity of viewpoint videos that are fused to obtain a viewpoint video to which attention is currently paid is one.

(2) A quantity of predictive viewpoint videos is represented using NNV. The predictive viewpoint videos are NNV viewpoint videos neighboring to a viewpoint video the user currently pays attention. The predictive viewpoint videos may be used in future as viewpoint videos to which attention is paid and presented to the user. The predictive viewpoint videos need to be transmitted. Therefore, during next user switching, attention may be paid to one or two viewpoint videos of the predictive viewpoint videos in order to reduce a viewpoint switching delay.

Further, a first speed at which a user viewpoint switches is first obtained, and then the quantity NNV of the predictive viewpoint videos that need to be downloaded before the user switches to another viewpoint may be determined based on the first speed according to the first speed and according to a preset algorithm. For a method for obtaining the first speed, refer to any one of the first to the sixth implementations described above.

This embodiment is specific to a one-dimensional scenario, and a direction of the first speed V is either horizontal or vertical. However, in a two-dimensional scenario, the direction of the first speed is random. If an angle between the direction of the first speed V and the horizontal direction and an angle between the direction of the first speed V and the vertical direction are respectively α and θ, a second speed in the horizontal direction and a third speed in the vertical direction that are obtained after the first speed is decomposed are respectively:

Vₓ=V cos α, and

V_{y}(t)=V sin α,

where Vₓ represents the second speed in the horizontal direction, and V_{y} represents the third speed in the vertical direction.

The second speed Vₓ and the third speed V_{y} may be further determined in the following manner.

This embodiment is specific to a one-dimensional scenario, an instantaneous speed at a moment t is v(t), and a direction of the instantaneous speed is either horizontal or vertical. However, in a two-dimensional scenario, the direction of the first speed is random. If an angle between the direction of the instantaneous speed v(t) and the horizontal direction and an angle between the direction of the instantaneous speed v(t) and the vertical direction are respectively α and θ, each instantaneous speed may be decomposed into a speed in the horizontal direction and a speed in the vertical direction that are respectively:

vₓ(t)=v(t)cos α, and

v_{y}(t)=v(t)sin α,

where vₓ(t) represents the speed in the horizontal direction, and v_{y} (t) represents the speed in the vertical direction.

Next, the second speed and the third speed are separately calculated in each of horizontal and vertical dimensions, and further an average value of speeds in the horizontal direction based on a time sliding window is used as the second speed Vₓ, and an average value of speeds in the vertical direction based on a time sliding window is used as the third speed V_{y}:

$${V}_{x} = \frac{1}{T} {\int }_{t - T}^{t} {v}_{x} ( τ ) d τ , and {V}_{y} = \frac{1}{T} {\int }_{t - T}^{t} {v}_{y} ( τ ) d τ ,$$

where T is duration of each video segment obtained by performing video slicing at the server end.

Further, accelerations at multiple moments may be further collected, using an acceleration sensor of a head-mounted device of the user, in a predetermined period of time before the user switches a viewpoint to the location of the viewpoint video to which attention is currently paid, and then the second speed Vₓ and the third speed V_{y} are determined using instantaneous speeds at the multiple moments and the accelerations.

In a two-dimensional scenario, a direction of a viewpoint switching acceleration is random. If an angle between a direction of an acceleration α(t) at the moment t and the horizontal direction and an angle between the direction of the acceleration α(t) at the moment t and the vertical direction are respectively α and θ, an acceleration αₓ(t) in the horizontal direction and an acceleration α_{y}(t) in the vertical direction are respectively:

αₓ(t)=α(t)cos α, and

α_{y}(t)=α(t)sin α,

therefore, when the user viewpoint switches to the location of the viewpoint video to which attention is currently paid, and an instantaneous speed of the user at a moment and an acceleration corresponding to the instantaneous speed at the moment are collected, the second speed Vₓ and the third speed V_{y} may be respectively represented using the following formulas:

Vₓ=vₓ(t)+1/2Tαₓ(t), and

V_{y}=v_{y}(t)+1/2Tα_{y}(t).

When the user viewpoint switches to the location of the viewpoint video to which attention is currently paid, and instantaneous speeds of the user at multiple moments and an acceleration corresponding to an instantaneous speed at each moment are collected, the second speed Vₓ and the third speed V_{y} may be respectively represented using the following formulas:

$${V}_{x} = \frac{1}{n} \sum {v}_{x} ( t ) + \frac{1}{2 n} T \sum {a}_{x} ( t ) , and$$

$${V}_{y} = \frac{1}{n} \sum {v}_{y} ( t ) + \frac{1}{2 n} T \sum {a}_{y} ( t ) ,$$

where n represents a quantity of instantaneous speeds at the multiple moments.

When the user viewpoint switches to the location of the viewpoint video to which attention is currently paid, and instantaneous speeds of the user at multiple moments and an acceleration corresponding to an instantaneous speed at each moment are collected, the second speed Vₓ and the third speed V_{y} may be further respectively represented using the following formulas:

$${V}_{x} = \frac{1}{n} \sum {v}_{x} ( t ) + \frac{1}{2} {Ta}_{x} ( t ) , and$$

$${V}_{y} = \frac{1}{n} \sum {v}_{y} ( t ) + \frac{1}{2} {Ta}_{y} ( t ) .$$

After the second speed Vₓ and the third speed V_{y} are obtained, a horizontal quantity NNVₓ of predictive viewpoint videos in the horizontal direction is predicted based on the second speed Vₓ and according to a first algorithm included in the preset algorithm, and a vertical quantity NNVₓ of predictive viewpoint videos in the vertical direction is predicted based on the third speed V_{y} and according to the first algorithm, and

$${NNV}_{x} = {N}_{x} \frac{{V}_{x} T}{{D}_{x}} , and {NNV}_{y} = {N}_{y} \frac{{V}_{y} T}{{D}_{y}} ,$$

where Nₓ represents a total quantity of viewpoint videos in the horizontal direction at the server end, N_{y} represents a total quantity of viewpoint videos in the vertical direction at the server end, Dₓ represents a range covered by the Nₓ viewpoint videos in the horizontal direction, D_{y} represents an angle covered by the N_{y} viewpoint videos in the vertical direction, and T is the duration of each video segment obtained by performing video slicing at the server end.

After NNVₓ and NNV_{y} are obtained, with reference to a quantity of and distribution of viewpoint videos to which attention is currently paid, a quantity of predictive viewpoint videos is divided into the following three cases.

(i) NCV=1, that is, there is a unique viewpoint video to which attention is currently paid, as shown in FIG. 11A, and all viewpoint videos included in a rectangle formed using NNVₓ+1 and NNV_{y}+1 as side lengths are a set of predictive viewpoint videos and the viewpoint video to which attention is currently paid, and therefore a quantity of the predictive viewpoint videos is:

NNV=(NNVₓ+1)*(NNV_{y}+1)−1.

(ii) NCV=2, that is, there are two fused viewpoint videos, as shown in FIG. 11B and FIG. 11C.

If horizontal fusion is performed on viewpoints, as shown in FIG. 11B, all viewpoint videos included in a rectangle formed using NNVₓ+2 and NNV_{y}+1 as side lengths are a set of predictive viewpoint videos and the viewpoint videos to which attention is currently paid, and in this case, a quantity of the predictive viewpoint videos is:

NNV=(NNVₓ+2)*(NNV_{y}+1)−2.

If vertical fusion is performed on viewpoints, as shown in FIG. 11C, all viewpoint videos included in a rectangle formed using NNVₓ+1 and NNV_{y}+2 as side lengths are a set of predictive viewpoint videos and the viewpoint videos to which attention is currently paid, and in this case, a quantity of the predictive viewpoint videos is:

NNV=(NNVₓ+1)*(NNV_{y}+2)−2.

(iii) NCV=4, that is, there are four fused viewpoint videos and two viewpoint videos are distributed in each of the horizontal direction and the vertical direction in the multi-view video, as shown in FIG. 11D.

Viewpoint videos need to be fused in both the horizontal direction and the vertical direction, and all viewpoint videos included in a rectangle formed using NNVₓ+2 and NNV_{y}+2 as side lengths are a set of predictive viewpoint videos and the viewpoint videos to which attention is currently paid, and in this case, a quantity of the predictive viewpoint videos is:

NNV=(NNVₓ+2)*(NNV_{y}+2)−4.

Additionally, in a two-dimensional multi-view video service, viewpoints are independent of each other sometimes. When presentation is performed at a client, even if an angle of view to which the user pays attention is not in the middle of a viewpoint video, fusion processing is not required. A quantity of fused viewpoint videos is one. Therefore, a quantity of predictive viewpoint videos is:

NNV=(NNVₓ+1)*(NNV_{y}+1)−1.

(3) Quantity NMV of marginal viewpoints.

All viewpoint videos other than the viewpoint video to which attention is currently paid and the predictive viewpoint videos are marginal viewpoint videos. Therefore, the quantity of the marginal viewpoint videos is:

NMV=N−NCV−NNV

where N represents a total quantity of all viewpoints, that is, N=Nₓ*N_{y}.

B2: Locations of viewpoint videos.

After respective quantities of three types of viewpoint videos are determined, locations of these viewpoint videos need to be determined next. Likewise, the three types of viewpoint videos are separately described below.

(1) Location of a viewpoint video to which attention is currently paid.

A location of an angle of view to which the user currently pays attention is determined according to a location of an eye ball of the user, a user gesture, and the like.

If the location of the angle of view to which the user currently pays attention is in the middle of a viewpoint video, as shown in FIG. 11A, the viewpoint video is a viewpoint video attention is uniquely paid, a quantity of viewpoints to which attention is paid is one, and a location of the viewpoint is also uniquely determined.

If the location of the angle of view to which the user currently pays attention is in the middle of a vertical location of a viewpoint video, but is not in the middle of a horizontal location, as shown in FIG. 11B, a viewpoint video to which attention is paid is a viewpoint video obtained by fusing two viewpoint videos in a horizontal direction that are closest to the current angle of view. Alternatively, if a location of an angle of view to which the user currently pays attention is in the middle of a horizontal location of a viewpoint video, but is not in the middle of a vertical location, as shown in FIG. 11C, a viewpoint video to which attention is currently paid is a viewpoint video obtained by fusing two viewpoint videos in a vertical direction that are closest to the current angle of view.

If the location of the angle of view to which the user currently pays attention is neither in the middle of a horizontal location of a viewpoint video nor in the middle of a vertical location, as shown in FIG. 11D, a viewpoint video to which attention is currently paid is a viewpoint video obtained by fusing four viewpoint videos that are closest to the current angle of view.

In a two-dimensional multi-view video service, viewpoints are independent of each other sometimes. When presentation is performed at a client, even if an angle of view to which the user pays attention is not in the middle of a viewpoint video, fusion processing is not required. A location of the viewpoint video is determined in the following manner selecting a viewpoint video closest to a current angle of view of the user as a viewpoint video attention is uniquely paid, and if distances between multiple viewpoint videos and the current angle of view of the user are equal and minimum, selecting any one of the multiple viewpoint videos at minimum distances to the current angle of view of the user as a viewpoint video to which attention is currently paid.

(2) Locations of predictive viewpoint videos.

To determine locations of predictive viewpoint videos, a magnitude and a direction of the second speed, and a magnitude and a direction of the third speed are all considered in the present disclosure.

When the second speed obtained by decomposing the first speed is less than a speed threshold in the horizontal direction, and the third speed obtained by decomposing the first speed is less than a speed threshold in the vertical direction, NNV viewpoint videos in a first rectangular area other than the fused viewpoint videos are used as predictive viewpoint videos, where the first rectangular area is a rectangular area formed by a first side length that is the horizontal quantity of the predictive viewpoint videos plus a quantity of fused viewpoint videos in the horizontal direction, and a second side length that is the vertical quantity of the predictive viewpoint videos plus a quantity of fused viewpoint videos in the vertical direction, and a geometrical center of the first rectangular area is the viewpoint video to which attention is currently paid.

When the second speed Vₓ is less than a speed threshold Vₓ₀ in the horizontal direction, that is, when Vₓ<Vₓ₀, it is considered that a future switching direction of a viewpoint has a relatively large uncertainty in the horizontal direction. Therefore, NNVₓ predictive viewpoint videos in the horizontal direction are averagely allocated at two sides of a horizontal location of the viewpoint video to which attention is currently paid.

Further, when NNVₓ is an even number,

$$\frac{{NNV}_{x}}{2}$$

viewpoint videos are allocated at each of two sides closely neighboring to the horizontal location of the viewpoint video to which attention is currently paid, or when NNVₓ is an odd number,

$$\frac{{NNV}_{x} \pm 1}{2}$$

viewpoint videos are allocated at each of two sides closely neighboring to the horizontal location of the viewpoint video attention is currently paid, or

$$\frac{{NNV}_{x} + 1}{2}$$

viewpoint videos are allocated at a side closely neighboring to the horizontal location of the viewpoint video to which attention is currently paid, and

$$\frac{{NNV}_{x} - 1}{2}$$

viewpoint videos are allocated at another side closely neighboring to the horizontal location of the viewpoint video to which attention is currently paid.

When the third speed V_{y} is less than a speed threshold V_{y0} in the vertical direction, that is, when V_{y}<V_{y0}, it is considered that a future switching direction of a viewpoint has a relatively large uncertainty in the vertical direction. Therefore, NNV_{y} viewpoint videos are averagely allocated at two sides closely neighboring to a vertical location of the viewpoint video to which attention is currently paid.

Further, when NNV_{y} is an even number,

$$\frac{{NNV}_{y}}{2}$$

viewpoint videos are allocated at each of two sides closely neighboring to the vertical location of the viewpoint video attention is currently paid, or when NNV_{y} is an odd number,

$$\frac{{NNV}_{y} \pm 1}{2}$$

viewpoint videos are allocated at each of two sides closely neighboring to the vertical location of the viewpoint video attention is currently paid, or

$$\frac{{NNV}_{y} + 1}{2}$$

viewpoint videos are allocated at a side closely neighboring to the vertical location of the viewpoint video to which attention is currently paid, and

$$\frac{{NNV}_{y} - 1}{2}$$

viewpoint videos are allocated at another side closely neighboring to the vertical location of the viewpoint video to which attention is currently paid.

By means of the foregoing allocation, the first side length of the first rectangular area in the horizontal direction is the horizontal quantity NNVₓ of the predictive viewpoint videos plus the quantity of the fused viewpoint videos in the horizontal direction, and the second side length of the first rectangular area in the vertical direction is the vertical quantity NNV_{y} of the predictive viewpoint videos plus the quantity of the fused viewpoint videos in the vertical direction.

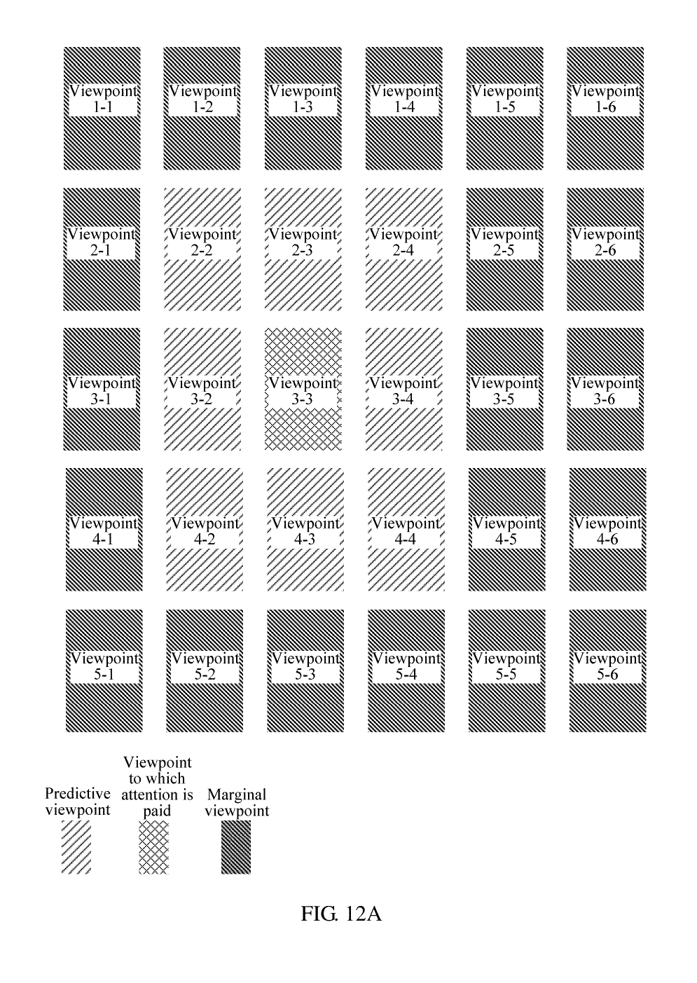

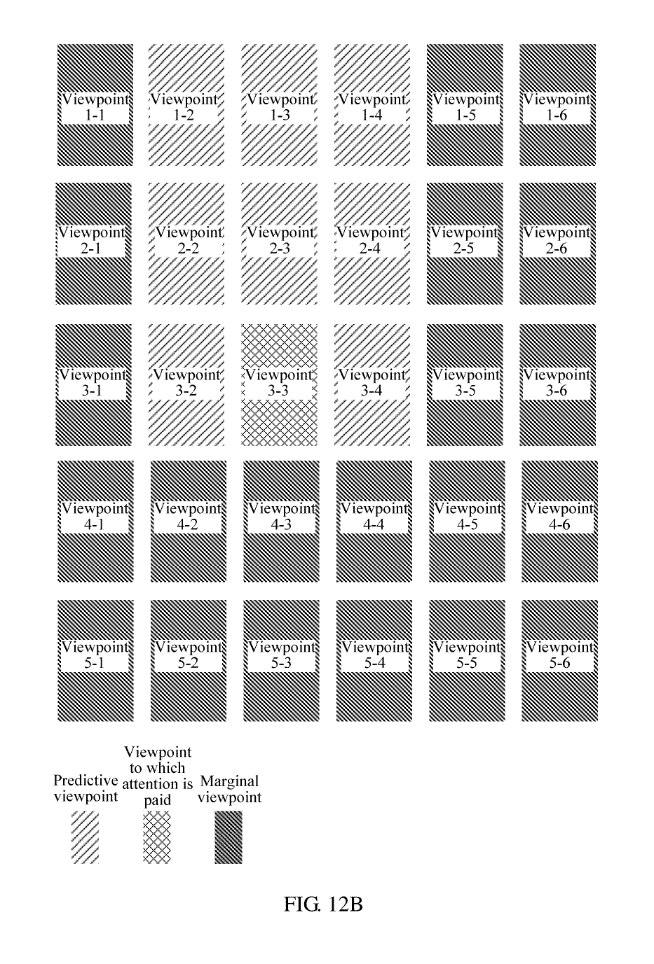

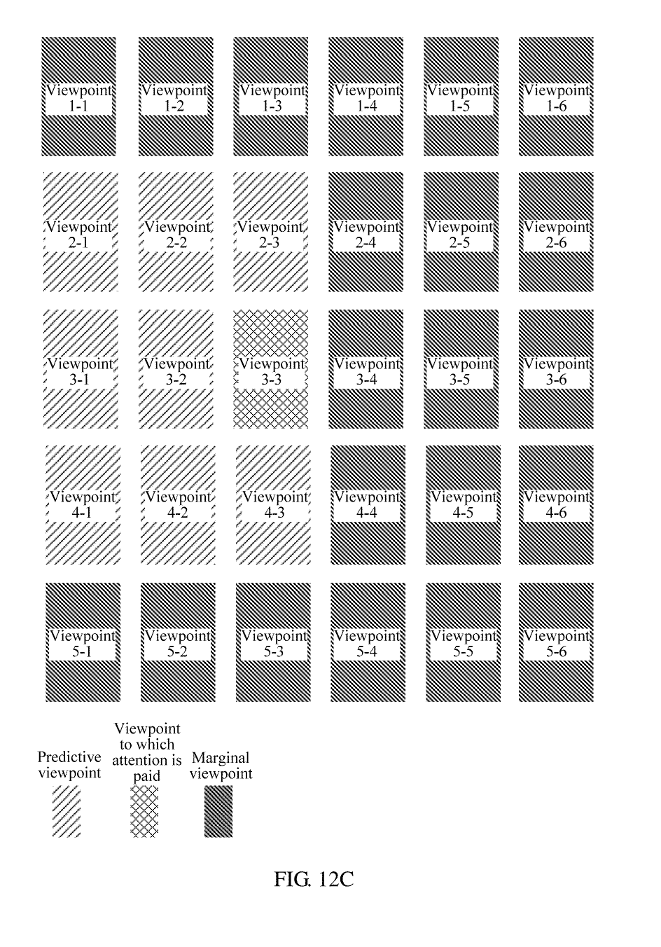

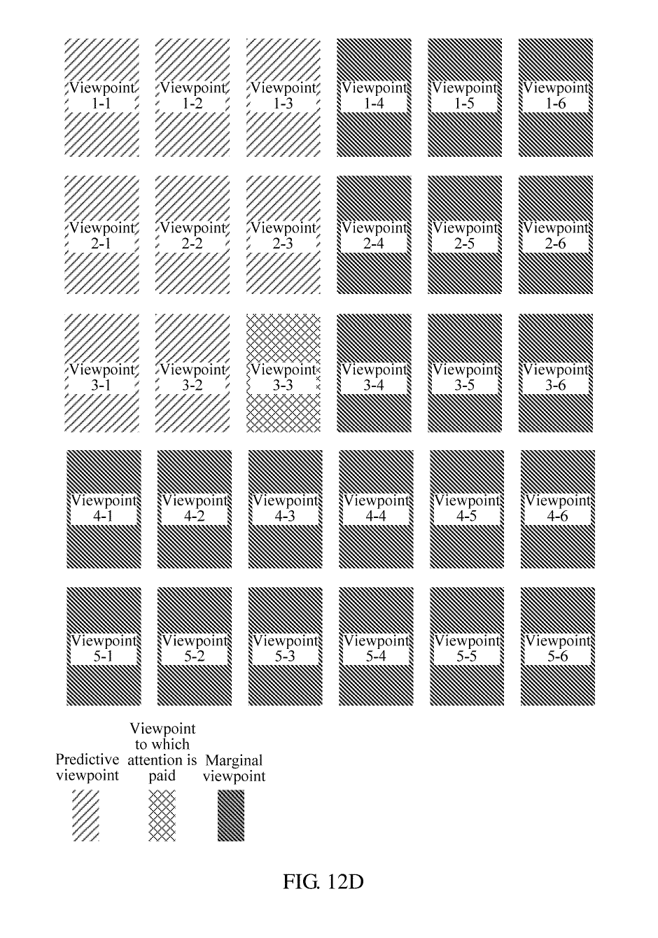

For example, a quantity of fused viewpoint videos is one, NNVₓ is 2, and NNV_{y} is 2. The predictive viewpoint videos in the first rectangular area are shown in FIG. 12A.

When the second speed is less than a speed threshold in the horizontal direction, and the third speed is not less than a speed threshold in the vertical direction, NNV viewpoint videos in a second rectangular area other than the fused viewpoint videos are used as predictive viewpoint videos, where the second rectangular area is a rectangular area formed by a first side length that is the horizontal quantity of the predictive viewpoint videos plus a quantity of fused viewpoint videos in the horizontal direction, and a second side length that is the vertical quantity of the predictive viewpoint videos plus a quantity of fused viewpoint videos in the vertical direction, and the predictive viewpoint videos are uniformly distributed, in the horizontal direction, at the two sides neighboring to the location of the viewpoint video to which attention is currently paid, and distributed, in the vertical direction, at a location of a side that is neighboring to the viewpoint video to which attention is currently paid and that is the same as a vector direction of the third speed.

When the third speed V_{y} in the vertical direction is not less than the speed threshold V_{y0} in the vertical direction, that is, when V_{y}≥V_{y0}, it is considered that a future switching direction of a viewpoint has a relatively large certainty in the vertical direction. Therefore, for allocation of predictive viewpoint videos, the direction of the third speed V_{y} needs to be considered, and the predictive viewpoint videos are distributed at a side the same as the vector direction of the third speed of the viewpoint video to which attention is currently paid.

For example, a quantity of fused viewpoint videos is one, NNVₓ is 2, and NNV_{y} is 2. The predictive viewpoint videos in the second rectangular area are shown in FIG. 12B.

When the second speed is not less than a speed threshold in the horizontal direction, and the third speed is less than a speed threshold in the vertical direction, NNV viewpoint videos in a third rectangular area other than the fused viewpoint videos are used as predictive viewpoint videos, where the third rectangular area is a rectangular area formed by a first side length that is the horizontal quantity of the predictive viewpoint videos plus a quantity of fused viewpoint videos in the horizontal direction, and a second side length that is the vertical quantity of the predictive viewpoint videos plus a quantity of fused viewpoint videos in the vertical direction, and the predictive viewpoint videos are uniformly distributed, in the vertical direction, at the two sides neighboring to the location of the viewpoint video to which attention is currently paid, and distributed, in the horizontal direction, at a location of a side that is neighboring to the viewpoint video to which attention is currently paid and that is the same as a vector direction of the second speed.

When the second speed Vₓ in the horizontal direction is not less than the speed threshold Vₓ₀ in the horizontal direction, that is, when Vₓ≥Vₓ₀, it is considered that a future switching direction of a viewpoint has a relatively large certainty in the horizontal direction. Therefore, for allocation of predictive viewpoint videos, the direction of the second speed Vₓ needs to be considered, and the predictive viewpoint videos are distributed at a side that is closely neighboring to the viewpoint video to which attention is currently paid and that is the same as the vector direction of the second speed.

For example, a quantity of fused viewpoint videos is one, NNVₓ is 2, and NNV_{y} is 2. The predictive viewpoint videos in the third rectangular area are shown in FIG. 12C.

When the second speed is not less than a speed threshold in the horizontal direction, and the third speed is not less than a speed threshold in the vertical direction, NNV viewpoint videos in a fourth rectangular area other than the fused viewpoint videos are used as predictive viewpoint videos, where the fourth rectangular area is a rectangular area formed by a first side length that is the horizontal quantity of the predictive viewpoint videos plus a quantity of fused viewpoint videos in the horizontal direction, and a second side length that is the vertical quantity of the predictive viewpoint videos plus a quantity of fused viewpoint videos in the vertical direction, and the predictive viewpoint videos are distributed, in the vertical direction, at a location of a side that is neighboring to the viewpoint video to which attention is currently paid and that is the same as the vector direction of the third speed, and distributed, in the horizontal direction, at a location of a side that is neighboring to the viewpoint video to which attention is currently paid and that is the same as the vector direction of the second speed.

For example, a quantity of fused viewpoint videos is one, NNVₓ is 2, and NNV_{y} is 2. The predictive viewpoint videos in the fourth rectangular area are shown in FIG. 12D.

In this embodiment, two-dimension is decomposed into horizontal and vertical dimensions, a location of a predictive viewpoint video is independently determined in each dimension, and a practice of the determining is the same as a practice in the embodiment corresponding to one-dimension.

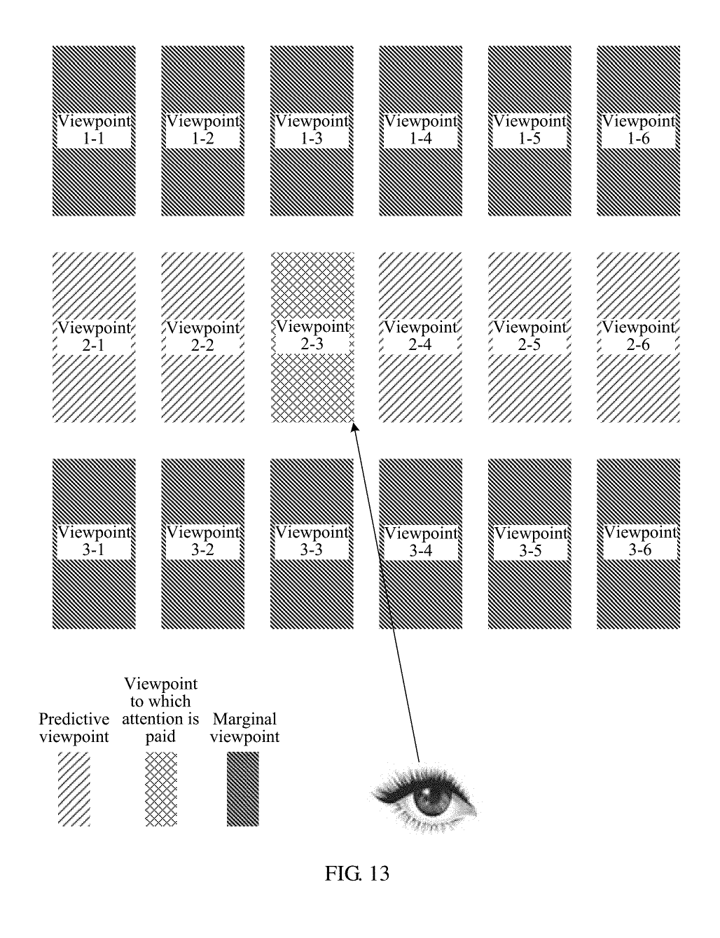

It should be noted that, during the foregoing location allocation of predictive viewpoint videos, when any side reaches a viewpoint boundary, allocation is stopped. For example, for a case in which Vₓ<Vₓ₀, when NNVₓ=6, three viewpoints are theoretically allocated at each of two sides of the horizontal location of the viewpoint video to which attention is currently paid. If there are only two viewpoints at a left side of the viewpoint video to which attention is currently paid, and there are three viewpoints at a right side, two viewpoint videos (reaching a viewpoint boundary) at the left side of the viewpoint video to which attention is currently paid, and three viewpoint videos at the right side are finally selected, as shown in FIG. 13. Further, when a quantity of viewpoint videos included in any one of the first rectangular area, the second rectangular area, the third rectangular area, or the fourth rectangular area is less than a quantity of predictive viewpoint videos, all viewpoint videos included in the any one rectangular area are used as predictive viewpoint videos.

(3) Locations of marginal viewpoint videos.

All viewpoint videos other than the viewpoint video to which attention is currently paid and the predictive viewpoint videos are marginal viewpoint videos. After quantities and locations of the viewpoint videos to which attention is currently paid and the predictive viewpoint videos are determined, the locations of the marginal viewpoint videos are also uniquely determined.

B3: Determine quality of a viewpoint video.

Each viewpoint video includes multiple bit rate versions, and each bit rate version requires a different bandwidth.

Each viewpoint video corresponding to the obtained location of each predictive viewpoint video may be downloaded from a server end and transmitted in the following manner.

(1) A bit rate version of the viewpoint video to which attention is currently paid and bit rate versions of the predictive viewpoint videos are determined according to a total bandwidth value allocated for viewpoint video transmission, and a preset bandwidth allocation policy.

Further, the preset bandwidth allocation policy includes determining, based on a delay and quality priority, a viewpoint type priority, and a predictive viewpoint video location priority and using the total bandwidth value allocated for viewpoint video transmission, the transmitted bit rate version of the viewpoint video to which attention is currently paid and the transmitted bit rate versions of the predictive viewpoint videos. Herein, the determining is preferably based on the delay and quality priority, then based on the viewpoint type priority, and then based on the predictive viewpoint video location priority. The transmitted bit rate version of the viewpoint video to which attention is currently paid and the transmitted bit rate versions of the predictive viewpoint videos are determined.

The delay and quality priority is used to ensure that lowest bit rate versions of the viewpoint video to which attention is currently paid and the predictive viewpoint videos are transmitted. The viewpoint type priority includes a priority of the viewpoint video to which attention is currently paid is higher than priorities of the predictive viewpoint videos, and therefore a bandwidth is preferably allocated to the viewpoint video to which attention is currently paid. The predictive viewpoint video location priority includes an ascending order of distances between locations of all of the predictive viewpoint videos and the location of the viewpoint video to which attention is currently paid is equal to a descending order of priorities of all of the predictive viewpoint videos, and therefore a bandwidth is preferably allocated to a viewpoint video whose predictive viewpoint video location priority is high.

The delay and quality priority is used to ensure that lowest bit rate versions of the viewpoint video to which attention is currently paid and the predictive viewpoint videos are transmitted because the viewpoint video to which the user currently pays attention and the predictive viewpoint videos are transmitted, a probability that the predictive viewpoint videos is used in future as viewpoint videos to which attention is paid is relatively large, and transmission of the predictive viewpoint videos may reduce a viewpoint switching delay. Therefore, bandwidths are allocated to the viewpoint video to which attention is currently paid and the predictive viewpoint videos, it is preferably ensured that all lowest bit rate versions of the viewpoint video to which attention is currently paid and the predictive viewpoint videos may be transmitted. If the bandwidths are sufficiently large, the bit rate version of the viewpoint video to which attention is currently paid may be improved, thereby improving viewpoint video transmission quality.

The viewpoint type priority is that when bandwidth resource allocation is performed, according to viewpoint types, a bandwidth is preferably allocated to the viewpoint video to which attention is currently paid, and then bandwidths are allocated to the predictive viewpoint videos.

The predictive viewpoint video location priority is for a predictive viewpoint video, and when a bandwidth resource is allocated to the predictive viewpoint video, a bandwidth resource is preferably allocated to a viewpoint video relatively close to the viewpoint video to which attention is currently paid.

(2) The predictive viewpoint videos are downloaded from the server end according to the locations of the predictive viewpoint videos and the bit rate versions of the predictive viewpoint videos, and the viewpoint video to which attention is currently paid is downloaded from the server end according to the location of the viewpoint video to which attention is currently paid, and the bit rate version of the viewpoint video to which attention is currently paid.

Before switching to the viewpoint video to which attention is currently paid is performed, a bandwidth may be already allocated to the viewpoint video to which the user currently pays attention, and the viewpoint video already begins to be transmitted, and may be already transmitted completely.

Therefore, if the viewpoint video to which the user currently pays attention is completely transmitted, the bit rate version of the completely transmitted viewpoint video to which attention is currently paid is determined. The determining, according to a total bandwidth value allocated for viewpoint video transmission, and a preset bandwidth allocation policy, a bit rate version of the viewpoint video to which attention is currently paid and bit rate versions of the predictive viewpoint videos is implemented in the following manner.

A bandwidth value is sequentially allocated, based on an ascending order of distances between the predictive viewpoint videos and the viewpoint video to which attention is currently paid, for a lowest bit rate for transmitting each viewpoint video of the predictive viewpoint videos, and the bit rate version of the viewpoint video to which attention is currently paid is raised based on a difference between the total bandwidth value and the bandwidth value that is allocated for the lowest bit rate for transmitting the predictive viewpoint videos, until the bit rate version of the viewpoint video to which attention is currently paid is the highest or the total bandwidth value is exhausted in order to determine the bit rate version of the viewpoint video to which attention is currently paid and the bit rate versions of the predictive viewpoint videos.

If the viewpoint video to which attention is currently paid is already transmitted but is not transmitted completely, a bandwidth is reallocated to the viewpoint video to which attention is currently paid and that is not transmitted. A first bandwidth value is allocated, based on the total bandwidth value, for a lowest bit rate version of the incompletely transmitted viewpoint video to which attention is currently paid, a second bandwidth value is sequentially allocated, based on a difference between the total bandwidth value and the first bandwidth value, and distances between the predictive viewpoint videos and the viewpoint video to which attention is currently paid, for a lowest bit rate for transmitting each viewpoint video of the predictive viewpoint videos, and the bit rate version of the viewpoint video to which attention is currently paid is raised based on the difference between the total bandwidth value and the first bandwidth value and a difference between the total bandwidth value and the second bandwidth value, until the bit rate version of the viewpoint video to which attention is currently paid is the highest or the total bandwidth value is exhausted in order to determine the bit rate version of the viewpoint video to which attention is currently paid and the bit rate versions of the predictive viewpoint videos.

When the bit rate version of the viewpoint video to which attention is currently paid is the highest and the total bandwidth value is not exhausted, a bit rate version of each viewpoint video of the predictive viewpoint videos is sequentially raised based on the ascending order of the distances between the predictive viewpoint videos and the viewpoint video to which attention is currently paid, until the bit rate version of each viewpoint video of the predictive viewpoint videos is the highest or the total bandwidth value is exhausted.

In this embodiment of the present disclosure, a bit rate version of each viewpoint video of the predictive viewpoint videos is sequentially raised based on the ascending order of the distances between the predictive viewpoint videos and the viewpoint video to which attention is currently paid, and a bit rate version may be preferably raised for a predictive viewpoint video closest to the viewpoint video to which attention is currently paid, until the bit rate version is the highest or the bandwidth is exhausted. If the bit rate version is the highest and the bandwidth is not exhausted, a bandwidth is allocated to a viewpoint video neighboring to the predictive viewpoint video closest to the viewpoint video to which attention is currently paid, and the rest can be deduced by analogy. Alternatively, bit rate versions may be separately and sequentially raised by one level based on the ascending order of the distances between the predictive viewpoint videos and the viewpoint video to which attention is currently paid. If the bandwidth is not exhausted, the bit rate versions are sequentially raised again by one level based on the ascending order of the distances between the predictive viewpoint videos and the viewpoint video to which attention is currently paid.

Further, during bandwidth allocation, grouping processing may be further performed on viewpoint videos.

(a) Divide all viewpoint videos into three groups, that is, an H group, an M group, and an L group.

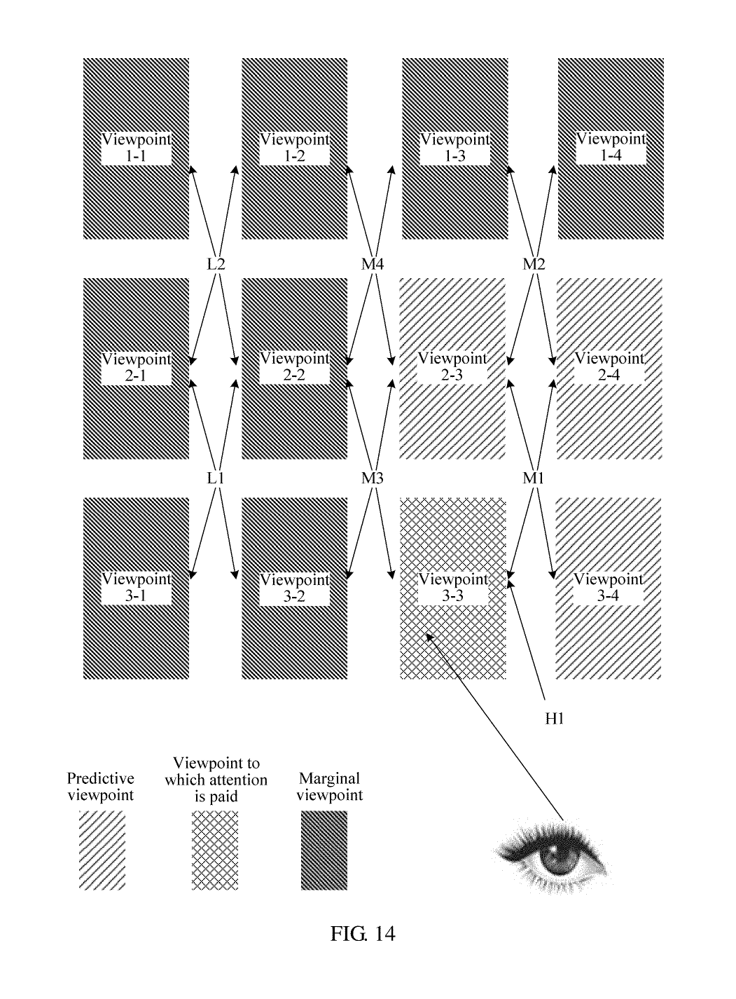

For a case in which viewpoint video fusion may be performed, as shown in FIG. 14.

The H group represents a set of viewpoint videos to which attention is currently paid, and the set may include one viewpoint video, may include two viewpoint videos, or may include four viewpoint videos. This depends on a quantity of viewpoint videos that are fused to obtain a viewpoint video to which attention is currently paid. The M group includes one or more subgroups {M₁,M₂,L}, each subgroup includes four viewpoint videos, and subgroups overlap with each other. It is considered that when a viewpoint video attention is paid switches to the middle between four viewpoints, that is, horizontal and vertical dimensions, as shown in FIG. 11D, viewpoint fusion needs to be performed on four neighboring viewpoint videos, to generate a new viewpoint video. Therefore, the M group starts from a border between the viewpoint video to which attention is currently paid and a predictive viewpoint video, and ends at a border between a predictive viewpoint video and a marginal viewpoint video or an available viewpoint boundary, that is, reaches an available viewpoint margin. The L group includes one or more subgroups {L₁, L₂,L}, each subgroup includes four viewpoint videos, and subgroups overlap with each other. The L group starts from a border between a predictive viewpoint video and a marginal viewpoint video, and ends at an available viewpoint boundary, that is, reaches an available viewpoint margin.

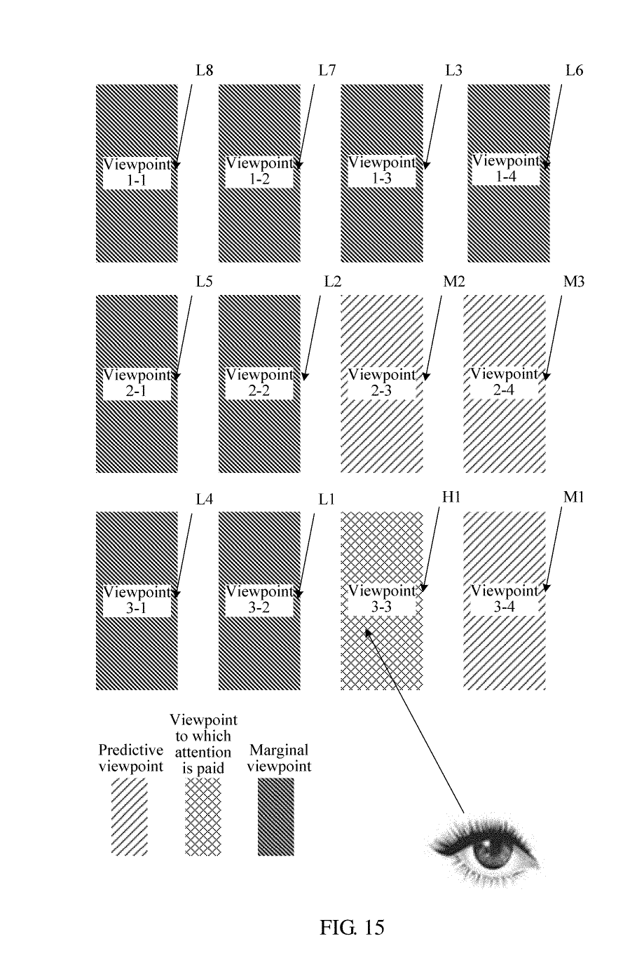

For a case in which viewpoint video fusion does not need to be performed, as shown in FIG. 15.

The H group represents a set of viewpoint videos to which attention is currently paid, and the set includes one viewpoint video. The M group includes one or more subgroups {M₁,M₂,L}, and each subgroup includes one viewpoint video. The M group starts from a border between the viewpoint video to which attention is currently paid and a neighboring viewpoint video, and ends at a boundary between a predictive viewpoint video and a marginal viewpoint video or an available viewpoint boundary, that is, reaches an available viewpoint margin. The L group includes one or more subgroups {L₁, L₂,L}, and each subgroup includes one viewpoint video. The L group starts from a border between a predictive viewpoint video and a marginal viewpoint video, and ends at an available viewpoint boundary, that is, reaches an available viewpoint margin.

(b) Determine whether each viewpoint video in the H group is already transmitted, and determine whether each viewpoint video is transmitted completely. If each viewpoint video is transmitted completely, perform step (c), if each viewpoint video is not transmitted completely, perform step (d), or if each viewpoint video in the H group is not transmitted, perform step (e).

(c) Allocate bandwidth resources needed by lowest bit rates to subgroups in the M group based on an ascending order of distances to the H group. If the bandwidth is insufficient or the bandwidth is exhausted, perform the step (g). Otherwise, perform step (f).

One or more subgroups in the M group may be already transmitted in advance, or transmitted completely, and no bandwidth needs to be reallocated in this step.

(d) Allocate a bandwidth resource needed by a lowest bit rate version to a viewpoint video in the H group that is not transmitted completely. If the bandwidth is insufficient or the bandwidth is exhausted, perform step (g), otherwise, perform step (c).

(e) Allocate a bandwidth resource needed by a lowest bit rate version to a viewpoint video in the H group that is not transmitted. If the bandwidth is insufficient or the bandwidth is exhausted, perform step (g), otherwise, perform step (c).

(f) Raise a bit rate version of a viewpoint video in the H group level by level, and allocate a bandwidth resource needed by the raised bit rate version, until a maximum bit rate version is reached. If the bandwidth is insufficient or the bandwidth is exhausted, perform step (h), otherwise, perform step (g).

(g) For subgroups in the M group, sequentially and separately raise bit rate versions of viewpoint videos in the subgroups by one level according to the ascending order of the distances to the H group, and allocate bandwidth resources needed by the bit rate versions that are raised by one level. If the bandwidth is insufficient or the bandwidth is exhausted, perform step h), otherwise, perform step (g) repetitively.

(h) Allocation ends.

After the foregoing bandwidth allocation is performed, bit rate versions of viewpoint videos in the H group and the M group can be determined.

It should be noted that when bandwidth resource allocation is performed, only intra-group update can be performed. For example, when a viewpoint belongs to two subgroups at the same time, if bit rates of the viewpoint video in the two subgroups are different, versions of two bit rates need to be reserved at the same time.

Each viewpoint video at the server end has multiple different bit rate versions, and all viewpoint videos need to be transmitted in the other approaches. Therefore, a bandwidth needs to be allocated to all the viewpoint videos, and an average allocation solution is usually used. Using the solution provided in this embodiment of the present disclosure, not all the viewpoint videos need to be transmitted, and therefore a bandwidth does not need to be allocated to all the viewpoint videos. Moreover, in this solution, a bandwidth is preferably allocated to a viewpoint video to which attention is currently paid, and transmission quality of the viewpoint video to which attention is currently paid is preferably considered based on a total bandwidth value. Therefore, a waste of bandwidths is reduced, and an instant experience of the user is improved.

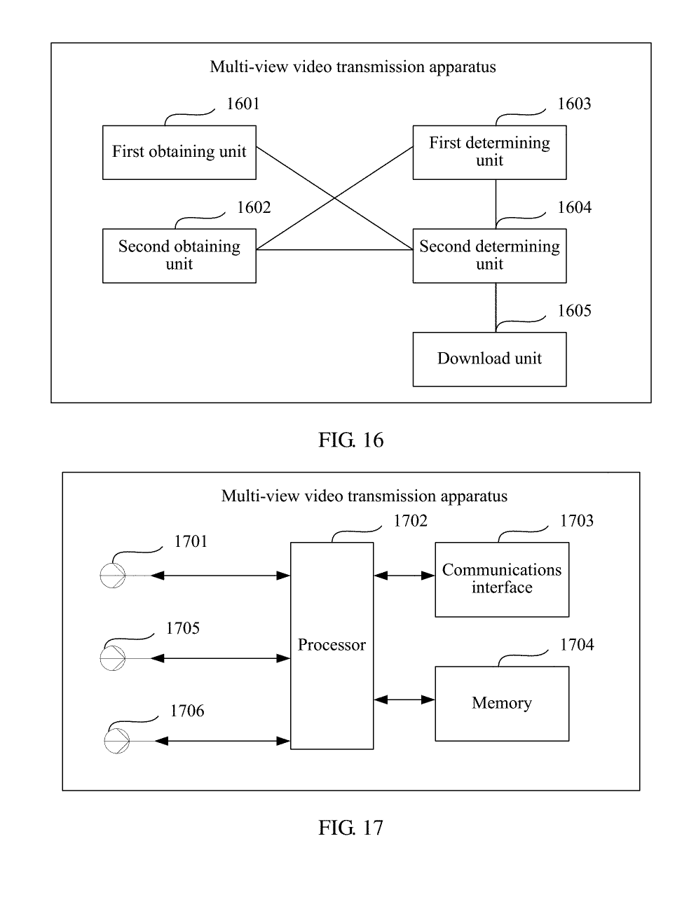

Based on an inventive concept the same as that of the embodiment of the multi-view video transmission method, an embodiment of the present disclosure further provides a multi-view video transmission apparatus. As shown in FIG. 16, the apparatus includes a first obtaining unit 1601 configured to obtain a location of a viewpoint video to which a user currently pays attention in a multi-view video, a second obtaining unit 1602 configured to obtain a first speed at which a user viewpoint switches, where the first speed is a speed at which the user viewpoint switches to the location of the viewpoint video to which attention is currently paid, a first determining unit 1603 configured to determine, according to the first speed obtained by the second obtaining unit 1602 and according to a preset algorithm, an NNV that need to be downloaded before the user switches to another viewpoint, a second determining unit 1604 configured to determine locations of the predictive viewpoint videos in the multi-view video according to a preset rule and according to the location that is obtained by the first obtaining unit 1601 and that is of the viewpoint video to which the user currently pays attention, the first speed obtained by the second obtaining unit 1602, and the NNV that is determined by the first determining unit 1603, where the predictive viewpoint videos are viewpoint videos whose probability of becoming a next viewpoint video attention is to be paid satisfies a preset probability value, and a download unit 1605 configured to download the predictive viewpoint videos corresponding to the locations of the predictive viewpoint videos from a server end and transmit the predictive viewpoint videos, where the locations are determined by the second determining unit 1604.

The viewpoint video to which attention is currently paid is a viewpoint video in the multi-view video, or a viewpoint video obtained after two neighboring viewpoint videos in the multi-view video are fused.

Optionally, when obtaining the first speed at which the user viewpoint switches, the second obtaining unit 1602 is further configured to, in a predetermined period of time before the user viewpoint switches to the location of the viewpoint video to which attention is currently paid, collect instantaneous speeds of the user at multiple moments, and calculate an average value of the collected instantaneous speeds at the multiple moments, and use the average value as the first speed.

Optionally, the second obtaining unit 1602 is further configured to, in a predetermined period of time before the user viewpoint switches to the location of the viewpoint video to which attention is currently paid, collect an instantaneous speed of the user at a moment and an acceleration corresponding to the instantaneous speed at the moment, and determine the first speed according to a first rule and based on the collected instantaneous speed at the moment and the collected acceleration corresponding to the instantaneous speed at the moment, the second obtaining unit 1602 is further configured to, in a predetermined period of time before the user viewpoint switches to the location of the viewpoint video to which attention is currently paid, collect instantaneous speeds of the user at multiple moments and an acceleration corresponding to an instantaneous speed at each moment, and calculate an average value of the collected instantaneous speeds at the multiple moments, calculate an average value of the multiple collected accelerations corresponding to the instantaneous speeds at the multiple moments, and determine the first speed according to a second rule and based on the average value of the instantaneous speeds at the multiple moments and the average value of the multiple accelerations, or the second obtaining unit 1602 is further configured to, in a predetermined period of time before the user viewpoint switches to the location of the viewpoint video to which attention is currently paid, collect instantaneous speeds of the user at multiple moments and an acceleration corresponding to an instantaneous speed at each moment, and calculate an average value of the instantaneous speeds at the multiple moments, and select an acceleration corresponding to an instantaneous speed from the accelerations corresponding to the instantaneous speeds at the multiple moments, and determine the first speed according to a third rule and based on the average value of the instantaneous speeds at the multiple moments and the selected acceleration corresponding to the instantaneous speed.

Optionally, the first rule may include:

V=v(t)+1/2Ta(t),

where V represents the first speed, v(t) represents a collected instantaneous speed of the user at a moment t, T represents duration of each viewpoint video, and a(t) represents an acceleration corresponding to the instantaneous speed at the moment t, the second rule may include:

$$V = \frac{1}{n} \sum v ( t ) + \frac{1}{2 n} T \sum a ( t ) ,$$

where n represents a quantity of instantaneous speeds at multiple moments, or the third rule may include:

$$V = \frac{1}{n} \sum v ( t ) + \frac{1}{2} T \sum a ( t ) .$$

Optionally, for a one-dimensional viewpoint video, the preset algorithm may include:

$$NNV = N \frac{VT}{D} ,$$

where NNV represents the quantity of the predictive viewpoint videos, V represents the first speed, N represents a total quantity of viewpoint videos, D represents an angle covered by the N viewpoint videos, and T represents the duration of each viewpoint video.

Optionally, the second determining unit 1604 is further configured to, when the first speed is less than a predetermined speed threshold, and the quantity NNV of the predictive viewpoint videos is an even number, allocate

$$\frac{NNV}{2}$$

viewpoint videos at each of two sides neighboring to the location of the viewpoint video to which attention is currently paid, and use the NNV viewpoint videos allocated at the two sides neighboring to the location of the viewpoint video to which attention is currently paid as predictive viewpoint videos, when the first speed is less than the predetermined speed threshold, and the quantity NNV of the predictive viewpoint videos is an odd number, set

$$\frac{NNV + 1}{2}$$

viewpoint videos neighboring to a first direction side of the location of the viewpoint video to which attention is currently paid, and

$$\frac{NNV - 1}{2}$$

viewpoint videos neighboring to a second direction side of the location of the viewpoint video to which attention is currently paid as predictive viewpoint videos, where the first direction side is the same as a vector direction of the first speed, and the second direction side is opposite to the vector direction of the first speed, when the first speed is less than the predetermined speed threshold, and the quantity NNV of the predictive viewpoint videos is an odd number, use

$$\frac{NNV - 1}{2}$$

viewpoint videos neighboring to the first direction side of the location of the viewpoint video to which attention is currently paid, and

$$\frac{NNV + 1}{2}$$

viewpoint videos neighboring to the second direction side of the location of the viewpoint video to which attention is currently paid as predictive viewpoint videos, or when the user switching speed is not less than the predetermined speed threshold, use NNV viewpoint videos neighboring to the first direction side of the location of the viewpoint video to which attention is currently paid as predictive viewpoint videos.

The second determining unit 1604 may be further configured to, when a quantity of viewpoint videos at a side neighboring to the location of the viewpoint video to which attention is currently paid is less than a quantity of allocated viewpoint videos, set the quantity of the viewpoint videos at the side neighboring to the location of the viewpoint video to which attention is currently paid as the quantity of the allocated viewpoint videos.

Optionally, for a two-dimensional viewpoint video, the first determining unit 1603 is further configured to decompose the first speed into a second speed in a horizontal direction and a third speed in a vertical direction, predict a horizontal quantity of predictive viewpoint videos in the horizontal direction based on the second speed and according to a first algorithm included in the preset algorithm, and predict a vertical quantity of predictive viewpoint videos in the vertical direction based on the third speed and according to the first algorithm, and determine the quantity of the predictive viewpoint videos based on a quantity of fused viewpoint videos, the horizontal quantity of the predictive viewpoint videos, and the vertical quantity of the predictive viewpoint videos and according to a second algorithm included in the preset algorithm.

The first algorithm includes:

$$\frac{NNV + 1}{2}$$

where NNVₓ represents the horizontal quantity of the predictive viewpoint videos, Nₓ represents a total quantity of viewpoint videos in the horizontal direction, N_{y} represents a total quantity of viewpoint videos in the vertical direction, Dₓ represents an angle covered by the Nₓ viewpoint videos in the horizontal direction, T represents the duration of each viewpoint video, and Vₓ represents the second speed, and

$${NNV}_{x} = {N}_{x} \frac{{V}_{x} T}{{D}_{x}} ,$$

where NNV_{y} represents the horizontal quantity of the predictive viewpoint videos, N_{y} represents a total quantity of viewpoint videos in the vertical direction, D_{y} represents an angle covered by the N_{y} viewpoint videos in the vertical direction, T represents the duration of each viewpoint video, and V_{y} represents the third speed.

When determining the quantity of the predictive viewpoint videos based on the quantity of the fused viewpoint videos, the horizontal quantity of the predictive viewpoint videos, and the vertical quantity of the predictive viewpoint videos and according to the second algorithm included in the preset algorithm, the first determining unit 1603 is further configured to if the quantity of the fused viewpoint videos is one, obtain the quantity NNV of the predictive viewpoint videos using the second algorithm satisfying a condition of the following formula:

NNV=(NNVₓ+1)*(NNV_{y}+1)−1,

if the quantity of the fused viewpoint videos is two and the fused viewpoint videos are distributed in the horizontal direction, obtain the quantity NNV of the predictive viewpoint videos using the second algorithm satisfying a condition of the following formula:

NNV=(NNVₓ+2)*(NNV_{y}+1)−2,

if the quantity of the fused viewpoint videos is two and the fused viewpoint videos are distributed in the vertical direction, obtain the quantity NNV of the predictive viewpoint videos using the second algorithm satisfying a condition of the following formula:

NNV=(NNVₓ+1)*(NNV_{y}+2)−2, or

if the quantity of the fused viewpoint videos is four, obtain the quantity NNV of the predictive viewpoint videos using the second algorithm satisfying a condition of the following formula:

NNV=(NNVₓ+2)*(NNV_{y}+2)−4.

For a two-dimensional viewpoint video, the second determining unit 1604 is further configured to, when the second speed obtained by decomposing the first speed is less than a speed threshold in the horizontal direction, and the third speed obtained by decomposing the first speed is less than a speed threshold in the vertical direction, set NNV viewpoint videos in a first rectangular area other than the fused viewpoint videos as predictive viewpoint videos, where the first rectangular area is a rectangular area formed by a first side length that is the horizontal quantity of the predictive viewpoint videos plus a quantity of fused viewpoint videos in the horizontal direction, and a second side length that is the vertical quantity of the predictive viewpoint videos plus a quantity of fused viewpoint videos in the vertical direction, and a geometrical center of the first rectangular area is the viewpoint video to which attention is currently paid, when the second speed is less than a speed threshold in the horizontal direction, and the third speed is not less than a speed threshold in the vertical direction, set NNV viewpoint videos in a second rectangular area other than the fused viewpoint videos as predictive viewpoint videos, where the second rectangular area is a rectangular area formed by a first side length that is the horizontal quantity of the predictive viewpoint videos plus a quantity of fused viewpoint videos in the horizontal direction, and a second side length that is the vertical quantity of the predictive viewpoint videos plus a quantity of fused viewpoint videos in the vertical direction, and the predictive viewpoint videos are uniformly distributed, in the horizontal direction, at the two sides neighboring to the location of the viewpoint video to which attention is currently paid, and distributed, in the vertical direction, at a location of a side that is neighboring to the viewpoint video to which attention is currently paid and that is the same as a vector direction of the third speed, when the second speed is not less than a speed threshold in the horizontal direction, and the third speed is less than a speed threshold in the vertical direction, use NNV viewpoint videos in a third rectangular area other than the fused viewpoint videos as predictive viewpoint videos, where the third rectangular area is a rectangular area formed by a first side length that is the horizontal quantity of the predictive viewpoint videos plus a quantity of fused viewpoint videos in the horizontal direction, and a second side length that is the vertical quantity of the predictive viewpoint videos plus a quantity of fused viewpoint videos in the vertical direction, and the predictive viewpoint videos are uniformly distributed, in the vertical direction, at the two sides neighboring to the location of the viewpoint video to which attention is currently paid, and distributed, in the horizontal direction, at a location of a side that is neighboring to the viewpoint video to which attention is currently paid and that is the same as a vector direction of the second speed, or when the second speed is not less than a speed threshold in the horizontal direction, and the third speed is not less than a speed threshold in the vertical direction, use NNV viewpoint videos in a fourth rectangular area other than the fused viewpoint videos as predictive viewpoint videos, where the fourth rectangular area is a rectangular area formed by a first side length that is the horizontal quantity of the predictive viewpoint videos plus a quantity of fused viewpoint videos in the horizontal direction, and a second side length that is the vertical quantity of the predictive viewpoint videos plus a quantity of fused viewpoint videos in the vertical direction, and the predictive viewpoint videos are distributed, in the vertical direction, at a location of a side that is neighboring to the viewpoint video to which attention is currently paid and that is the same as a vector direction of the third speed, and distributed, in the horizontal direction, at a location of a side that is neighboring to the viewpoint video to which attention is currently paid and that is the same as a vector direction of the second speed.

The second determining unit 1604 is further configured to, when a quantity of viewpoint videos included in any one of the first rectangular area, the second rectangular area, the third rectangular area, or the fourth rectangular area is less than a quantity of predictive viewpoint videos, use all the viewpoint videos included in any one of the rectangular areas as predictive viewpoint videos.

Each viewpoint video includes multiple bit rate versions, each bit rate version requires a different bandwidth, and the download unit 1605 is further configured to determine, according to a total bandwidth value allocated for viewpoint video transmission, and a preset bandwidth allocation policy, a bit rate version of the viewpoint video to which attention is currently paid and bit rate versions of the predictive viewpoint videos, and download the predictive viewpoint videos from the server end according to the locations of the predictive viewpoint videos and the bit rate versions of the predictive viewpoint videos, and download the viewpoint video to which attention is currently paid from the server end according to the location of the viewpoint video to which attention is currently paid, and the bit rate version of the viewpoint video to which attention is currently paid.

After it is determined that the viewpoint video to which attention is currently paid is completely transmitted, and the bit rate version of the completely transmitted viewpoint video to which attention is currently paid is determined, the download unit 1605 is further configured to sequentially allocate, based on an ascending order of distances between the predictive viewpoint videos and the viewpoint video to which attention is currently paid, a bandwidth value to a lowest bit rate for transmitting each viewpoint video of the predictive viewpoint videos, and raise, based on a difference between the total bandwidth value and the bandwidth value that is allocated to the lowest bit rate for transmitting the predictive viewpoint videos, the bit rate version of the viewpoint video to which attention is currently paid, until the bit rate version of the viewpoint video to which attention is currently paid is the highest or the total bandwidth value is exhausted in order to determine the bit rate version of the viewpoint video to which attention is currently paid and the bit rate versions of the predictive viewpoint videos.

When the viewpoint video to which attention is currently paid is incompletely transmitted, the download unit 1605 is further configured to allocate, based on the total bandwidth value, a first bandwidth value to a lowest bit rate version of the incompletely transmitted viewpoint video to which attention is currently paid, sequentially allocate, based on a difference between the total bandwidth value and the first bandwidth value, and distances between the predictive viewpoint videos and the viewpoint video to which attention is currently paid, a second bandwidth value to a lowest bit rate for transmitting each viewpoint video of the predictive viewpoint videos, and raise, based on the difference between the total bandwidth value and the first bandwidth value and a difference between the total bandwidth value and the second bandwidth value, the bit rate version of the viewpoint video to which attention is currently paid, until the bit rate version of the viewpoint video to which attention is currently paid is the highest or the total bandwidth value is exhausted in order to determine the bit rate version of the viewpoint video to which attention is currently paid and the bit rate versions of the predictive viewpoint videos.

The download unit 1605 is further configured to, when the bit rate version of the viewpoint video to which attention is currently paid is the highest and the total bandwidth value is not exhausted, sequentially raise, based on the ascending order of the distances between the predictive viewpoint videos and the viewpoint video to which attention is currently paid, a bit rate version of each viewpoint video of the predictive viewpoint videos, until the bit rate version of each viewpoint video of the predictive viewpoint videos is the highest or the total bandwidth value is exhausted.

Both the first obtaining unit 1601 and the second obtaining unit 1602 in this embodiment of the present disclosure may be implemented using sensors. For example, the first obtaining unit 1601 may be implemented using a location sensor configured to obtain a location of a viewpoint video. The second obtaining unit 1602 may be implemented using a speed sensor configured to collect a speed at which a user performs viewpoint switching, or implemented by means of cooperation between a sensor and a processor, or the like. Each of the first determining unit 1603, the second determining unit 1604, and the download unit 1605 may be implemented using a processor. During specific implementation, for example, as shown in FIG. 17, the apparatus may include a location sensor 1701, a processor 1702, and a communications interface 1703. The location sensor 1701, the processor 1702, and the communications interface 1703 are connected to each other. This embodiment of the present disclosure further includes a memory 1704. The memory 1704 is separately connected to the location sensor 1701, the processor 1702, and the communications interface 1703. In this embodiment of the present disclosure, a specific connection medium between the foregoing components is not limited. Further, connection may be performed using a bus. The bus may be classified into an address bus, a data bus, a control bus, or the like.

The memory 1704 in this embodiment of the present disclosure is configured to store program code executed by the processor 1702. The memory 1704 may be a volatile memory, such as a random-access memory (RAM), the memory 1704 may be a non-volatile memory, such as a read-only memory (ROM), a flash memory, a hard disk drive (HDD), or a solid-state drive (SSD), or the memory 1704 is any other medium that can be used to carry or store expected program code in an instruction or data structure form and that can be accessed by a computer, but is not limited thereto. The memory 1704 may be a combination of the foregoing memories.

The processor 1702 in this embodiment of the present disclosure may be a central processing unit (CPU).

FIG. 17 is only an example, and does not limit structures and a quantity of devices in the multi-view video transmission apparatus.

The location sensor 1701 is configured to obtain a location of a viewpoint video to which a user currently pays attention in a multi-view video.

The processor 1702 is configured to obtain a first speed at which a user viewpoint switches, and configured to implement functions implemented by the first determining unit 1603, the second determining unit 1604, and the download unit 1605.

Optionally, in a first implementation, the apparatus may further include a speed sensor 1705 configured to, in a predetermined period of time before the user viewpoint switches to the location of the viewpoint video to which attention is currently paid, collect instantaneous speeds of the user at multiple moments, where when obtaining the first speed at which the user viewpoint switches, the processor 1702 is further configured to calculate an average value of the instantaneous speeds at the multiple moments, and use the average value as the first speed.

Optionally, in a second implementation, the apparatus may further include a speed sensor 1705 configured to, in a predetermined period of time before the user viewpoint switches to the location of the viewpoint video to which attention is currently paid, collect instantaneous speeds of the user at multiple moments, and an acceleration sensor 1706 configured to in the predetermined period of time before the user viewpoint switches to the location of the viewpoint video to which attention is currently paid, collect an acceleration corresponding to an instantaneous speed of the user at a moment, where when obtaining the first speed at which the user viewpoint switches, the processor 1702 is further configured to determine the first speed according to a first rule and based on an instantaneous speed at a moment collected by the speed sensor 1705 and an acceleration corresponding to the instantaneous speed at the moment collected by the acceleration sensor 1706.

Optionally, in a third implementation, the apparatus may further include a speed sensor 1705 configured to, in a predetermined period of time before the user viewpoint switches to the location of the viewpoint video to which attention is currently paid, collect instantaneous speeds of the user at multiple moments, and an acceleration sensor 1706 configured to, in the predetermined period of time before the user viewpoint switches to the location of the viewpoint video to which attention is currently paid, collect an acceleration corresponding to an instantaneous speed of the user at each moment, where when obtaining the first speed at which the user viewpoint switches, the processor 1702 is further configured to calculate an average value of the instantaneous speeds at the multiple moments collected by the speed sensor 1705, and an average value of the multiple accelerations corresponding to the instantaneous speeds at the multiple moments collected by the acceleration sensor 1706, and determine the first speed according to a second rule and based on the average value of the instantaneous speeds at the multiple moments and the average value of the multiple accelerations.

Optionally, in a fourth implementation, the apparatus may further include a speed sensor 1705 configured to, in a predetermined period of time before the user viewpoint switches to the location of the viewpoint video to which attention is currently paid, collect instantaneous speeds of the user at multiple moments, and an acceleration sensor 1706 configured to, in the predetermined period of time before the user viewpoint switches to the location of the viewpoint video to which attention is currently paid, collect an acceleration corresponding to an instantaneous speed of the user at each moment, where when obtaining the first speed at which the user viewpoint switches, the processor 1702 is further configured to calculate an average value of the instantaneous speeds at the multiple moments collected by the speed sensor 1705, select an acceleration corresponding to an instantaneous speed from the accelerations corresponding to the instantaneous speeds at the multiple moments collected by the acceleration sensor 1706, and determine the first speed according to a third rule and based on the average value of the instantaneous speeds at the multiple moments and the selected acceleration corresponding to the instantaneous speed.

The location sensor, the speed sensor, and the acceleration sensor in this embodiment of the present disclosure may be further implemented using one sensor, and the sensor not only may collect a viewpoint location and a user switching speed, but also may collect a user switching acceleration.

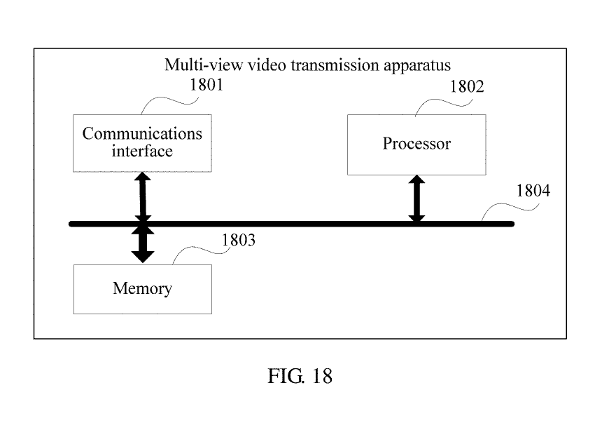

An embodiment of the present disclosure further provides another multi-view video transmission apparatus. As shown in FIG. 18, the apparatus includes a communications interface 1801, a processor 1802, and a memory 1803. The communications interface 1801, the processor 1802, and the memory 1803 are connected to each other. In this embodiment of the present disclosure, a specific connection medium between the foregoing components is not limited. In this embodiment of the present disclosure, in FIG. 18, the memory 1803, the processor 1802, and the communications interface 1801 are connected to each other using a bus 1804. The bus is represented using a bold line in FIG. 18. A manner of connection between other components is only schematically described, but is not used as a limitation. The bus may be classified into an address bus, a data bus, a control bus, or the like. For convenience of representation, the bus is represented only using one bold line in FIG. 18, but it does not mean that there is only one bus or one type of bus.

The memory 1803 in this embodiment of the present disclosure is configured to store program code executed by the processor 1802. The memory 1803 may be a volatile memory, such as a RAM, the memory 1803 may be a non-volatile memory, such as a ROM, a flash memory, an HDD, or an SSD, or the memory 1803 is any other medium that can be used to carry or store expected program code in an instruction or data structure form and that can be accessed by a computer, but is not limited thereto. The memory 1803 may be a combination of the foregoing memories.

The processor 1802 in this embodiment of the present disclosure may be a CPU.

The processor 1802 is configured to execute the program code stored in the memory 1803, and is further configured to perform the multi-view video transmission method described in the embodiment corresponding to FIG. 6. For details, refer to the embodiment corresponding to FIG. 6, and details are not described herein again.

By means of the solution provided in this embodiment of the present disclosure, a location of a viewpoint video to which a user currently pays attention in a multi-view video is obtained, a first speed at which a user viewpoint switches is obtained, where the first speed is a speed at which the user viewpoint switches to the location of the viewpoint video to which attention is currently paid, an NNV that need to be downloaded before the user switches to another viewpoint is determined according to the first speed and according to a preset algorithm, locations of the predictive viewpoint videos are determined in the multi-view video according to a preset rule and according to the location of the viewpoint video to which the user currently pays attention, the first speed, and the NNV, where the predictive viewpoint videos are viewpoint videos whose probability of becoming a next viewpoint video attention is to be paid satisfies a preset probability value, and the predictive viewpoint videos corresponding to the locations of the predictive viewpoint videos are downloaded from a server end and transmitted. Therefore, when the user pays attention to a current viewpoint video, a viewpoint video neighboring to the current viewpoint video, that is, a predictive viewpoint video, is downloaded from the server end and transmitted. When the user performs switching next time, the predictive viewpoint video may be used as a viewpoint video attention is paid. This can avoid a time delay caused during switching of an angle of view. Moreover, not all viewpoint videos need to be transmitted, and therefore a waste of bandwidths is reduced. Each viewpoint video at the server end has multiple different bit rate versions, and all viewpoint videos need to be transmitted in the other approaches. Therefore, a bandwidth needs to be allocated to all the viewpoint videos, and an average allocation solution is usually used. Using the solution provided in this embodiment of the present disclosure, not all the viewpoint videos need to be transmitted, and therefore a bandwidth does not need to be allocated to all the viewpoint videos. Moreover, in this solution, a bandwidth is preferably allocated to a viewpoint video to which attention is currently paid, and transmission quality of the viewpoint video to which attention is currently paid is preferably considered based on a total bandwidth value. Therefore, a waste of bandwidths is reduced, and an instant experience of the user is improved.

Persons skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a disk memory, a compact disc ROM (CD-ROM), an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine such that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner such that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device such that a series of operations and steps are performed on the computer or the other programmable device, thereby generating computer-implemented processing. Therefore, the instructions executed on the computer or the other programmable device provides steps for implementing a specific function in one or more processes in the flowcharts and/or in one or more blocks in the block diagrams.

Although embodiments of the present disclosure have been described, persons skilled in the art can make changes and modifications to these embodiments once they learn the basic inventive concept. Therefore, the following claims are intended to be construed as to cover the preferred embodiments and all changes and modifications falling within the scope of the present disclosure.

Obviously, persons skilled in the art can make various modifications and variations to the present disclosure without departing from the spirit and scope of the present disclosure. The present disclosure is intended to cover these modifications and variations provided that they fall within the scope defined by the following claims and their equivalent technologies.

1. A multi-view video transmission method, comprising:
obtaining a location of a viewpoint video to which a user currently pays attention in a multi-view video;
obtaining a first speed at which a user viewpoint switches, the first speed comprising a speed at which the user viewpoint switches to the location of the viewpoint video to which attention is currently paid;
determining, according to the first speed and according to a preset algorithm, a quantity of predictive viewpoint videos (NNV) that need to be downloaded before the user switches to another viewpoint;
determining locations of the predictive viewpoint videos in the multi-view video according to a preset rule and according to the location of the viewpoint video to which the user currently pays attention, the first speed, and the NNV, the predictive viewpoint videos comprising viewpoint videos whose probability of becoming a next viewpoint video attention is to be paid satisfies a preset probability value;
downloading the predictive viewpoint videos corresponding to the locations of the predictive viewpoint videos from a server end; and
transmitting the predictive viewpoint videos.

2. The method according to claim 1, wherein obtaining the first speed at which the user viewpoint switches comprises:
determining the first speed according to a first rule and based on an instantaneous speed of the user at a moment and an acceleration corresponding to the instantaneous speed at the moment when the instantaneous speed of the user at the moment and the acceleration corresponding to the instantaneous speed at the moment are collected in a predetermined period of time before the user viewpoint switches to the location of the viewpoint video to which attention is currently paid;
calculating an average value of instantaneous speeds of the user at a plurality of moments and an average value of a plurality of accelerations corresponding to the instantaneous speeds at the moments, and determining the first speed according to a second rule and based on the average value of the instantaneous speeds at the moments and the average value of the accelerations when the instantaneous speeds of the user at the moments and an acceleration corresponding to an instantaneous speed at each moment are collected in the predetermined period of time before the user viewpoint switches to the location of the viewpoint video to which attention is currently paid; and
calculating the average value of the instantaneous speeds of the user at the moments, selecting an acceleration corresponding to an instantaneous speed from the accelerations corresponding to the instantaneous speeds at the moments, and determining the first speed according to a third rule and based on the average value of the instantaneous speeds at the moments and the selected acceleration corresponding to the instantaneous speed when the instantaneous speeds of the user at the moments and the acceleration corresponding to the instantaneous speed at each moment are collected in the predetermined period of time before the user viewpoint switches to the location of the viewpoint video to which attention is currently paid.

3. The method according to claim 1, wherein for a one-dimensional viewpoint video, determining the locations of the predictive viewpoint videos in the multi-view video comprises:
allocating
$$\frac{NNV}{2}$$
viewpoint videos at each of two sides neighboring to the location of the viewpoint video to which attention is currently paid and setting NNV viewpoint videos as the predictive viewpoint videos when the first speed is less than a predetermined speed threshold, and the NNV comprises an even number;
setting
$$\frac{NNV + 1}{2}$$
viewpoint videos neighboring to a first direction side of the location of the viewpoint video to which attention is currently paid and
$$\frac{NNV - 1}{2}$$
viewpoint videos neighboring to a second direction side of the viewpoint video to which attention is currently paid as the predictive viewpoint videos when the first speed is less than the predetermined speed threshold and the NNV comprising an odd number, the first direction side being the same as a vector direction of the first speed, the second direction side being opposite to the vector direction of the first speed;
setting the
$$\frac{NNV - 1}{2}$$
viewpoint videos neighboring to the first direction side of the location of the viewpoint video to which attention is currently paid and the
$$\frac{NNV + 1}{2}$$
viewpoint videos neighboring to the second direction side of the location of the viewpoint video to which attention is currently paid as the predictive viewpoint videos when the first speed is less than the predetermined speed threshold and the NNV comprising an odd number;
setting the NNV viewpoint videos neighboring to the first direction side of the location of the viewpoint video to which attention is currently paid as the predictive viewpoint videos when the first speed is not less than the predetermined speed threshold; and
setting a quantity of all viewpoint videos at a side neighboring to the location of the viewpoint video to which attention is currently paid as a quantity of allocated viewpoint videos when the quantity of all the viewpoint videos at the side neighboring to the location of the viewpoint video to which attention is currently paid is less than the quantity of the allocated viewpoint videos.

4. The method according to claim 1, wherein for a two-dimensional viewpoint video, determining the NNV that need to be downloaded before the user switches to the other viewpoint comprises:
decomposing the first speed into a second speed (Vₓ) in a horizontal direction and a third speed (V_{y}) in a vertical direction;
predicting a horizontal quantity of predictive viewpoint videos (NNVₓ) in the horizontal direction based on the Vₓ and according to a first algorithm comprised in the preset algorithm;
predicting a vertical quantity of predictive viewpoint videos (NNV_{y}) in the vertical direction based on the V_{y} and according to the first algorithm; and
determining the NNV based on a quantity of fused viewpoint videos, the NNVₓ, and the NNV_{y} and according to a second algorithm comprised in the preset algorithm, the fused viewpoint videos comprising viewpoint videos fused in the multi-view video to obtain the viewpoint video to which attention is currently paid, the
$${NNV}_{x} = {N}_{x} \frac{{V}_{x} T}{{D}_{x}} ,$$
Nₓ comprising a total quantity of viewpoint videos in the horizontal direction, Dₓ comprising an angle covered by the Nₓ, T comprising duration of each viewpoint video, the
$${NNV}_{y} = {N}_{y} \frac{{V}_{y} T}{{D}_{y}} ,$$
N_{y} comprising a total quantity of viewpoint videos in the vertical direction, and D_{y} comprising an angle covered by the N_{y}.

5. The method according to claim 4, wherein determining the NNV comprises:
obtaining the NNV using the second algorithm satisfying a condition of a formula NNV=(NNVₓ+1)*(NNV_{y}+1)−1 when the quantity of the fused viewpoint videos comprises one;
obtaining the NNV using the second algorithm satisfying a condition of a formula NNV=(NNVₓ+2)*(NNV_{y}+1)−2 when the quantity of the fused viewpoint videos comprises two and the fused viewpoint videos are distributed in the horizontal direction in the multi-view video;
obtaining the NNV using the second algorithm satisfying a condition of a formula NNV=(NNVₓ+1)*(NNV_{y}+2)−2 when the quantity of the fused viewpoint videos comprises two and the fused viewpoint videos are distributed in the vertical direction in the multi-view video; and
obtaining the NNV using the second algorithm satisfying a condition of a formula NNV=(NNVₓ+2)*(NNV_{y}+2)−4 when the quantity of the fused viewpoint videos comprises four and two viewpoint videos are distributed in each of the horizontal direction and the vertical direction in the multi-view video.

6. The method according to claim 4, wherein for the two-dimensional viewpoint video, determining the locations of the predictive viewpoint videos in the multi-view video comprises:
setting NNV viewpoint videos in a first rectangular area other than the fused viewpoint videos as the predictive viewpoint videos when the Vₓ is less than a speed threshold in the horizontal direction and the V_{y} is less than a speed threshold in the vertical direction, the first rectangular being formed by a first side length comprising the NNVₓ plus a quantity of fused viewpoint videos in the horizontal direction and a second side length comprising the NNV_{y} plus a quantity of fused viewpoint videos in the vertical direction, and a geometrical center of the first rectangular area being the viewpoint video to which attention is currently paid, and setting all viewpoint videos comprised in the first rectangular area as the predictive viewpoint videos when a quantity of the viewpoint videos comprised in the first rectangular area is less than the NNV;
setting NNV viewpoint videos in a second rectangular area other than the fused viewpoint videos as the predictive viewpoint videos when the Vₓ is less than the speed threshold in the horizontal direction and the V_{y} is not less than the speed threshold in the vertical direction, the second rectangular area being formed by the first side length comprising the NNVₓ plus the quantity of fused viewpoint videos in the horizontal direction and the second side length comprising the NNV_{y} plus the quantity of fused viewpoint videos in the vertical direction, and the predictive viewpoint videos being uniformly distributed, in the horizontal direction, at two sides neighboring to the location of the viewpoint video to which attention is currently paid, and distributed, in the vertical direction, at a location of a side neighboring to the viewpoint video to which attention is currently paid and the same as a vector direction of the V_{y}, and setting all viewpoint videos comprised in the second rectangular area as the predictive viewpoint videos when a quantity of the viewpoint videos comprised in the second rectangular area is less than the NNV;
setting NNV viewpoint videos in a third rectangular area other than the fused viewpoint videos as the predictive viewpoint videos when the Vₓ is not less than the speed threshold in the horizontal direction and the V_{y} is less than the speed threshold in the vertical direction, the third rectangular area being formed by the first side length comprising the NNVₓ plus the quantity of fused viewpoint videos in the horizontal direction and the second side length comprising the NNV_{y} plus the quantity of fused viewpoint videos in the vertical direction, and the predictive viewpoint videos being uniformly distributed, in the vertical direction, at two sides neighboring to the location of the viewpoint video to which attention is currently paid, and distributed, in the horizontal direction, at a location of a side neighboring to the viewpoint video to which attention is currently paid and the same as a vector direction of the Vₓ, and setting all viewpoint videos comprised in the third rectangular area as the predictive viewpoint videos when a quantity of the viewpoint videos comprised in the third rectangular area is less than the NNV; and
setting NNV viewpoint videos in a fourth rectangular area other than the fused viewpoint videos as the predictive viewpoint videos when the Vₓ is not less than the speed threshold in the horizontal direction and the V_{y} is not less than the speed threshold in the vertical direction, the fourth rectangular area being formed by the first side length comprising the NNVₓ plus the quantity of fused viewpoint videos in the horizontal direction and the second side length comprising the NNV_{y} plus the quantity of fused viewpoint videos in the vertical direction, and the predictive viewpoint videos being distributed, in the vertical direction, at the location of the side neighboring to the viewpoint video to which attention is currently paid and the same as the vector direction of the V_{y} and distributed, in the horizontal direction, at the location of the side neighboring to the viewpoint video to which attention is currently paid and the same as the vector direction of the Vₓ, and setting all viewpoint videos comprised in the fourth rectangular area as the predictive viewpoint videos when a quantity of the viewpoint videos comprised in the fourth rectangular area is less than the NNV.

7. A multi-view video transmission apparatus, comprising:
a memory comprising instructions; and
a processor coupled to the memory, the instructions causing the processor to be configured to:
obtain a location of a viewpoint video to which a user currently pays attention in a multi-view video;
obtain a first speed at which a user viewpoint switches, the first speed comprising a speed at which the user viewpoint switches to the location of the viewpoint video to which attention is currently paid;
determine, according to the first speed and a preset algorithm, a quantity of predictive viewpoint videos (NNV) that need to be downloaded before the user switches to another viewpoint;
determine locations of the predictive viewpoint videos in the multi-view video according to a preset rule and according to the location of the viewpoint video to which the user currently pays attention, the first speed, and the NNV, the predictive viewpoint videos comprising viewpoint videos whose probability of becoming a next viewpoint video attention is to be paid satisfies a preset probability value;
download the predictive viewpoint videos corresponding to the locations of the predictive viewpoint videos from a server end; and
transmit the predictive viewpoint videos.

8. The apparatus according to claim 7, wherein the instructions further cause the processor to be configured to:
collect an instantaneous speed of the user at a moment and an acceleration corresponding to the instantaneous speed at the moment in a predetermined period of time before the user viewpoint switches to the location of the viewpoint video to which attention is currently paid; and
determine the first speed according to a first rule and based on the collected instantaneous speed at the moment and the collected acceleration corresponding to the instantaneous speed at the moment.

9. The apparatus according to claim 7, wherein the instructions further cause the processor to be configured to:
collect instantaneous speeds of the user at plurality of moments and an acceleration corresponding to an instantaneous speed at each moment in a predetermined period of time before the user viewpoint switches to the location of the viewpoint video to which attention is currently paid;
calculate an average value of the collected instantaneous speeds at the moments, calculate an average value of the collected accelerations corresponding to the instantaneous speeds at the moments; and
determine the first speed according to a second rule and based on the average value of the instantaneous speeds at the moments and the average value of the accelerations.

10. The apparatus according to claim 7, wherein the instructions further cause the processor to be configured to:
collect instantaneous speeds of the user at plurality of moments and an acceleration corresponding to an instantaneous speed at each moment in a predetermined period of time before the user viewpoint switches to the location of the viewpoint video to which attention is currently paid;
calculate an average value of the instantaneous speeds at the moments;
select an acceleration corresponding to an instantaneous speed from the accelerations corresponding to the instantaneous speeds at the moments; and
determine the first speed according to a third rule and based on the average value of the instantaneous speeds at the moments and the selected acceleration corresponding to the instantaneous speed.

11. The apparatus according to claim 7, wherein the instructions further cause the processor to be configured to:
allocate
$$\frac{NNV}{2}$$
viewpoint videos at each of two sides neighboring to the location of the viewpoint video to which attention is currently paid, set NNV viewpoint videos allocated at the two sides neighboring to the location of the viewpoint video to which attention is currently paid as the predictive viewpoint videos when the first speed is less than a predetermined speed threshold and the NNV comprising an even number;
set
$$\frac{NNV + 1}{2}$$
viewpoint videos neighboring to a first direction side of the location of the viewpoint video to which attention is currently paid and
$$\frac{NNV - 1}{2}$$
viewpoint videos neighboring to a second direction side of the location of the viewpoint video to which attention is currently paid as the predictive viewpoint videos when the first speed is less than the predetermined speed threshold and the NNV comprising an odd number, the first direction side being the same as a vector direction of the first speed and the second direction side being opposite to the vector direction of the first speed;
set
$$\frac{NNV - 1}{2}$$
viewpoint videos neighboring to the first direction side of the viewpoint video to which attention is currently paid and
$$\frac{NNV + 1}{2}$$
viewpoint videos neighboring to the second direction side of the viewpoint video to which attention is currently paid as the predictive viewpoint videos when the first speed is less than the predetermined speed threshold and the NNV comprising an odd number;
set the NNV viewpoint videos neighboring to the first direction side of the viewpoint video to which attention is currently paid as the predictive viewpoint videos when the user switching speed is not less than the predetermined speed threshold; and
set a quantity of all viewpoint videos at a side neighboring to the location of the viewpoint video to which attention is currently paid as a quantity of allocated viewpoint videos when the quantity of all the viewpoint videos at the side neighboring to the location of the viewpoint video to which attention is currently paid is less than the quantity of the allocated viewpoint videos.

12. The apparatus according to claim 7, wherein for a two-dimensional viewpoint video, the instructions further cause the processor to be configured to:
decompose the first speed into a second speed (Vₓ) in a horizontal direction and a third speed (V_{y}) in a vertical direction;
predict a horizontal quantity of predictive viewpoint videos (NNVₓ) in the horizontal direction based on the Vₓ and according to a first algorithm comprised in the preset algorithm;
predict a vertical quantity of predictive viewpoint videos (NNV_{y}) in the vertical direction based on the V_{y} and according to the first algorithm; and
determine the NNV based on a quantity of fused viewpoint videos, the NNVₓ, and the NNV_{y} and according to a second algorithm comprised in the preset algorithm, the fused viewpoint videos comprising viewpoint videos fused in the multi-view video to obtain the viewpoint video to which attention is currently paid, the
$${NNV}_{x} = {N}_{x} \frac{{V}_{x} T}{{D}_{x}} ,$$
Nₓ comprising a total quantity of viewpoint videos in the horizontal direction, N_{y} comprising a total quantity of viewpoint videos in the vertical direction, Dₓ comprising an angle covered by the Nₓ viewpoint videos in the horizontal direction, T comprising duration of each viewpoint video, the
$${NNV}_{y} = {N}_{y} \frac{{V}_{y} T}{{D}_{y}} ,$$
and D_{y} comprising an angle covered by the N_{y} viewpoint videos in the vertical direction.

13. The apparatus according to claim 12, wherein when determining the NNV, the instructions further cause the processor to be configured to:
obtain the NNV using the second algorithm satisfying a condition of a formula NNV=(NNVₓ+1)*(NNV_{y}+1)−1 when the quantity of the fused viewpoint videos comprises one;
obtain the NNV using the second algorithm satisfying a condition of a formula NNV=(NNVₓ+2)*(NNV_{y}+1)−2 when the quantity of the fused viewpoint videos comprises two and the fused viewpoint videos are distributed in the horizontal direction in the multi-view video;
obtain the NNV using the second algorithm satisfying a condition of a formula NNV=(NNVₓ+1)*(NNV_{y}+2)−2 when the quantity of the fused viewpoint videos comprises two and the fused viewpoint videos are distributed in the vertical direction in the multi-view video; and
obtain the NNV using the second algorithm satisfying a condition of a formula NNV=(NNVₓ+2)*(NNV_{y}+2)−4 when the quantity of the fused viewpoint videos comprises four and two viewpoint videos are distributed in each of the horizontal direction and the vertical direction in the multi-view video.

14. The apparatus according to claim 12, wherein for a two-dimensional viewpoint video, the instructions further cause the processor to be configured to:
set NNV viewpoint videos in a first rectangular area other than the fused viewpoint videos as the predictive viewpoint videos when the Vₓ is less than a speed threshold in the horizontal direction and the V_{y} is less than a speed threshold in the vertical direction, the first rectangular area being formed by a first side length comprising the NNVₓ plus a quantity of fused viewpoint videos in the horizontal direction and a second side length comprising the NNV_{y} plus a quantity of fused viewpoint videos in the vertical direction, and a geometrical center of the first rectangular area being the viewpoint video to which attention is currently paid, and set all viewpoint videos comprised in the first rectangular area as the predictive viewpoint videos when a quantity of the viewpoint videos comprised in the first rectangular area is less than the NNV;
set NNV viewpoint videos in a second rectangular area other than the fused viewpoint videos as the predictive viewpoint videos when the Vₓ is less than the speed threshold in the horizontal direction and the V_{y} is not less than the speed threshold in the vertical direction, the second rectangular area being formed by the first side length comprising the NNVₓ plus the quantity of fused viewpoint videos in the horizontal direction and the second side length comprising the NNV_{y} plus the quantity of fused viewpoint videos in the vertical direction, the predictive viewpoint videos being uniformly distributed, in the horizontal direction, at two sides neighboring to the location of the viewpoint video to which attention is currently paid, and distributed, in the vertical direction, at a location of a side neighboring to the viewpoint video to which attention is currently paid and the same as a vector direction of the V_{y}, and set all viewpoint videos comprised in the second rectangular area as the predictive viewpoint videos when a quantity of the viewpoint videos comprised in the second rectangular area is less than the NNV;
set NNV viewpoint videos in a third rectangular area other than the fused viewpoint videos as the predictive viewpoint videos when the Vₓ is not less than the speed threshold in the horizontal direction and the V_{y} is less than the speed threshold in the vertical direction, the third rectangular area being formed by the first side length comprising the NNVₓ plus the quantity of fused viewpoint videos in the horizontal direction and a second side length comprising the NNV_{y} plus the quantity of fused viewpoint videos in the vertical direction, and the predictive viewpoint videos being uniformly distributed, in the vertical direction, at two sides neighboring to the location of the viewpoint video to which attention is currently paid, and distributed, in the horizontal direction, at a location of a side neighboring to the viewpoint video to which attention is currently paid and the same as a vector direction of the Vₓ, and set all viewpoint videos comprised in the third rectangular area as the predictive viewpoint videos when a quantity of the viewpoint videos comprised in the third rectangular area is less than the NNV; and
set NNV viewpoint videos in a fourth rectangular area other than the fused viewpoint videos as the predictive viewpoint videos when the Vₓ is not less than the speed threshold in the horizontal direction and the V_{y} is not less than the speed threshold in the vertical direction, the fourth rectangular area being formed by the first side length comprising the NNVₓ plus the quantity of fused viewpoint videos in the horizontal direction and the second side length comprising the NNV_{y} plus the quantity of fused viewpoint videos in the vertical direction, and the predictive viewpoint videos being distributed, in the vertical direction, at the location of the side neighboring to the viewpoint video to which attention is currently paid and the same as the vector direction of the V_{y} and distributed, in the horizontal direction, at the location of the side neighboring to the viewpoint video to which attention is currently paid and the same as the vector direction of the Vₓ, and set all viewpoint videos comprised in the fourth rectangular area as the predictive viewpoint videos when a quantity of the viewpoint videos comprised in the fourth rectangular area is less than the NNV.

15. A multi-view video transmission apparatus, comprising:
a memory configured to store a program code;
a communications interface;
a processor, the memory, the communications interface, and the processor are separately coupled to each other using a bus,
the program code stored in the memory causing the processor to be configured to:
obtain a location of a viewpoint video to which a user currently pays attention in a multi-view video;
obtain a first speed at which a user viewpoint switches, the first speed comprising a speed at which the user viewpoint switches to the location of the viewpoint video to which attention is currently paid;
determining, according to the first speed and according to a preset algorithm, a quantity of predictive viewpoint videos (NNV) that need to be downloaded before the user switches to another viewpoint;
determining locations of the predictive viewpoint videos in the multi-view video according to a preset rule and according to the location of the viewpoint video to which the user currently pays attention, the first speed, and the NNV, the predictive viewpoint videos comprising viewpoint videos whose probability of becoming a next viewpoint video attention is to be paid satisfies a preset probability value;
downloading the predictive viewpoint videos corresponding to the locations of the predictive viewpoint videos from a server end using the communications interface; and
transmitting the predictive viewpoint videos.

16. The apparatus according to claim 15, wherein when obtaining the first speed at which the user viewpoint switches, the program code further causes the processor to be configured to:
calculate an average value of instantaneous speeds of the user at plurality of moments when the instantaneous speeds of the user at the moments are collected in a predetermined period of time before the user viewpoint switches to the location of the viewpoint video to which attention is currently paid; and
set the average value of the instantaneous speeds as the first speed.

17. The apparatus according to claim 15, wherein when obtaining the first speed at which the user viewpoint switches, the program code further causes the processor to be configured to:
determine the first speed according to a first rule and based on instantaneous speed at a moment and an acceleration corresponding to the instantaneous speed at the moment when the instantaneous speed of the user at the moment and the acceleration corresponding to the instantaneous speed at the moment are collected in a predetermined period of time before the user viewpoint switches to the location of the viewpoint video to which attention is currently paid;
calculate an average value of instantaneous speeds of the user at a plurality of moments and an average value of accelerations corresponding to the instantaneous speeds at the moments, and determine the first speed according to a second rule and based on the average value of the instantaneous speeds at the moments and the average value of the accelerations when the instantaneous speeds of the user at the moments and an acceleration corresponding to an instantaneous speed at each moment are collected in the predetermined period of time before the user viewpoint switches to the location of the viewpoint video to which attention is currently paid; and
calculate the average value of the instantaneous speeds of the user at the moments, select an acceleration corresponding to an instantaneous speed from the accelerations corresponding to the instantaneous speeds at the moments, and determine the first speed according to a third rule and based on the average value of the instantaneous speeds at the moments and the selected acceleration corresponding to the instantaneous speed when instantaneous speeds of the user at the moments and the acceleration corresponding to the instantaneous speed at each moment are collected in the predetermined period of time before the user viewpoint switches to the location of the viewpoint video to which attention is currently paid.

18. The apparatus according to claim 15, wherein when determining, for a one-dimensional viewpoint video, the locations of the predictive viewpoint videos in the multi-view video, the program code further causes the processor to be configured to:
allocate
$$\frac{NNV}{2}$$
viewpoint videos at each of two sides neighboring to the location of the viewpoint video to which attention is currently paid, and set NNV viewpoint videos allocated at the two sides of the location neighboring to the viewpoint video to which attention is currently paid as the predictive viewpoint videos when the first speed is less than a predetermined speed threshold and the NNV comprising an even number;
set
$$\frac{NNV + 1}{2}$$
viewpoint videos neighboring to a first direction side of the viewpoint video to which attention is currently paid and
$$\frac{NNV - 1}{2}$$
viewpoint videos neighboring to a second direction side of the viewpoint video to which attention is currently paid as the predictive viewpoint videos when the first speed is less than the predetermined speed threshold and the NNV comprising an odd number, the first direction side being the same as a vector direction of the first speed and the second direction side being opposite to the vector direction of the first speed;
set
$$\frac{NNV - 1}{2}$$
viewpoint videos neighboring to the first direction side of the viewpoint video to which attention is currently paid and
$$\frac{NNV + 1}{2}$$
viewpoint videos neighboring to the second direction side of the viewpoint video to which attention is currently paid as the predictive viewpoint videos when the first speed is less than the predetermined speed threshold and the NNV comprising an odd number;
set the NNV viewpoint videos neighboring to the first direction side of the viewpoint video to which attention is currently paid as the predictive viewpoint videos when the user switching speed is not less than the predetermined speed threshold; and
set a quantity of all viewpoint videos at a side neighboring to the location of the viewpoint video to which attention is currently paid as a quantity of allocated viewpoint videos when the quantity of all the viewpoint videos at the side neighboring to the location of the viewpoint video to which attention is currently paid is less than the quantity of the allocated viewpoint videos.

19. The apparatus according to claim 15, wherein when determining, for a two-dimensional viewpoint video, the NNV that need to be downloaded before the user switches to the other viewpoint, the program code further causes the processor to be configured to:
decompose the first speed into a second speed in a horizontal direction and a third speed in a vertical direction;
predict a horizontal quantity of predictive viewpoint videos (NNVₓ) in the horizontal direction based on the second speed and according to a first algorithm comprised in the preset algorithm;
predict a vertical quantity of predictive viewpoint videos (NNV_{y}) in the vertical direction based on the third speed and according to the first algorithm; and
determine the NNV based on a quantity of fused viewpoint videos, the NNVₓ, and the NNV_{y} and according to a second algorithm comprised in the preset algorithm.
